(19) United States
(12) Patent Application Publication
(10) Pub. No.: US 2017/0005972 A1
(43) Pub. Date: Jan. 5, 2017

(54) GEOTAG

(71) Applicant: PROXIMITY GRID, INC., San Jose, CA (US)

(72) Inventor: JOHN H. REIMER, San Jose, CA (US)

(73) Assignee: PROXIMITY GRID, INC.

(21) Appl. No.: 15/265,821

(22) Filed: Sep. 14, 2016

Related U.S. Application Data
(63) Continuation-in-part of application No. 13/663,318, filed on Oct. 29, 2012.
Application No. 13/663,318 is a continuation-in-part of application No. 12/803,766, filed on Jul. 6, 2010, now Pat. No. 8,356,005.
Application No. 12/803,766 is a continuation of application No. 11/490,905, filed on Jul. 21, 2006, now Pat. No. 7,761,400.
(60) Provisional application No. 60/701,551, filed on Jul. 22, 2005.

(51) Int. Cl. H04L 12/58; H04W 4/02

(52) U.S. Cl. CPC H04L 51/20; H04L 51/10; H04W 4/023

(57) ABSTRACT

Events may be identified by storing information in response to activating an event stamp function. As a result of activating the event function, the information collected may immediately be compared to event information in a database. Alternatively, the information collected may later be compared to event information in a database. One or more candidates for the event of interest may be automatically or manually retrieved, and the user may decide whether a candidate event of the one or more candidates correspond to the event of interest.

### CROSS-REFERENCE TO RELATED APPLICATIONS

This application is a continuation-in-part of U.S. patent application Ser. No. 13/663,318, filed Oct. 29, 2012, by John Reimer, entitled, “Identifying Events,” (22-6) which is a continuation-in-part of U.S. patent application Ser. No. 12/803,766, filed Jul. 6, 2010, by John Reimer, entitled, “Identifying Events,” which is a continuation of U.S. patent application Ser. No. 11/490,905, filed Jul. 21, 2006, by John Reimer, entitled, “Identifying Events,” which claims priority benefit of U.S. Provisional Patent Application No. 60/701,551, filed Jul. 22, 2005, by John Reimer, entitled, “Identifying Events,” and which are all incorporated herein by reference, in their entirety.

### FIELD

The invention relates generally to finding information.

### BACKGROUND OF THE DISCLOSURE

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

An individual may listen to a radio and hear a song or see something that catches the individual's interest. The individual may, at later time, search the web to find the song or information about the item seen, and may intend to purchase the song or something related to the item seen, but may not have enough information or forget some of the information needed for finding the song or the item seen.

To address this problem, US Patent Application, Publication Number 2004/0002938, discloses a marker for marking pieces of music and a dedicated timestamp. However, the use of the marker and timestamp are somewhat limited and could be improved.

### SUMMARY OF INVENTION

In an embodiment, an event stamp or grid stamp function is provided that records multiple pieces of information, such as the time of day, the date, and the location. In an embodiment, the location is identified via GPS coordinates. In this specification, the phrases “event stamp” and “grid stamp” are used interchangeably—either term may be substituted for the other where ever either occurs to obtain a different embodiment. Thus, similarly, the phrases “event stamp function” and “grid stamp function” and “event stamp button” and “grid stamp button” are used interchangeably—either term may be substituted for the other where ever either occurs to obtain a different embodiment. In an embodiment, when performing a search in addition to returning the event information that has the closest correspondence to the event stamp, information about other events that have some partially corresponding information is also returned.

In an embodiment, activating the event function automatically launches an immediate search for the type of information sought. In an embodiment, the event stamp button includes a cylindrical component that rotates, and rotating the cylindrical component causes a scrolling through the search results found. In an embodiment, the user can configure different modes of operation, such as whether the event function causes just the storage of information for later use, launches an immediate search, or immediately causes a purchase of a product. In an embodiment, the event function has different modes (and optionally multiple mode buttons that invoke the different modes) in which in each of these modes different types of information are sought.

In an embodiment, the event stamp information may be used for determining which bus, plane, train, or other mode of transportation passed a certain location. In an embodiment, the activating the event stamp function causes a comparison of radio waves received to sound received or a comparison of sounds or clips from a song or other broadcast received and stored to sounds and/or images stored in a database to identify the broadcast of interest. In an embodiment, the event stamp information may be used for determining the location of a particular vendor and initiating a transaction, such as locating the nearest available taxi and ordering a taxi pickup. In an embodiment, the event stamp information may be used to immediately locate a restaurant or other vendor that is nearby, view the menu, and the restaurant owner may return special offers, possibly dependent upon the user visiting the restaurant within a certain time frame. In an embodiment, the event stamp information may be used to immediately locate a barber, hairstylist, dentist, doctor, or other shop that is nearby and schedule an appointment.

In an embodiment, the event stamp information may be used for establishing a journal of times and locations visited. In an embodiment, the event stamp may allow entry of a verbal annotation. In an embodiment, the event stamp may include a picture, and optionally the event stamp function may activate a camera (e.g., on a mobile phone).

Any of the above embodiments may be used alone, or with or without any combination of any of the other embodiments. Additionally, the invention is not limited to the embodiments listed above. Other embodiments of the invention may exist that do not include any of the above embodiments and/or that include other features not listed above.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 shows a representation of an example of an event identification system.

FIG. 2 shows a block diagram of an embodiment of the keychain of FIG. 1.

FIG. 3 shows a block diagram of an embodiment of the mobile phone of FIG. 1.

FIG. 4 shows a representation of an embodiment of the mobile phone of FIG. 1, which may be an embodiment of the mobile phone of FIG. 3 or another embodiment.

FIG. 5 shows a block diagram of an example of a machine that may be used in the event identification system of FIG. 1.

FIG. 6 shows an example of a screenshot of a webpage that may be presented by a website host.

FIG. 7 shows a block diagram of an example of an attachment that may be attached to another device to thereby add an event button.

FIG. 8 shows a flowchart of an example of a method of using an event stamp.

FIG. 9 is a flowchart of an example of a method for establishing event identification system of FIG. 1.

FIG. 10A shows a block diagram of an embodiment of a software for an event identification system.

FIG. 10B shows a representation of an entity relationship diagram of an embodiment of an event identification system of FIG. 10A.

FIG. 10C shows a flowchart of an embodiment of a method of device communication for establishing the event identification system of FIG. 10A.

FIG. 11 shows a flowchart of an embodiment of a method of activating a mash guide account.

FIG. 12 shows a flowchart of an embodiment of a method of using a mash guide.

FIG. 13 shows a flowchart of an embodiment of a method of creating a meeting/greeting event.

FIG. 14 shows a flowchart of an embodiment of a method of using a send it once page.

FIG. 15 shows a flowchart of an embodiment of a method of using a mobcast system.

FIG. 16 shows a representation of an example of communication between devices in an embodiment of an event identification system.

FIG. 17 shows a block diagram of an embodiment of the watch of FIG. 16.

FIG. 18 shows a representation of an embodiment of a mash guide used in the event identification system.

FIG. 19 shows a representation of an embodiment of how the information in the mash guide can be formatted as a card.

FIG. 20 shows a representation of an embodiment of a smartwatch, which may be an embodiment of the watch of FIG. 16.

FIG. 21 shows a representation of an embodiment of the smartphone, which may be an embodiment of the mobile phone of FIG. 1 or FIG. 16.

FIG. 22 shows a block diagram of an embodiment of the mobile phone of either FIG. 1 or FIG. 16, which may be an embodiment of the smartphone representation of FIG. 21.

FIG. 23 shows a block diagram of an embodiment of the watch of FIG. 16, which may be an embodiment of the smartwatch representation of FIG. 20.

FIG. 24 shows a representation of an example of pairing between a smartwatch and a smartphone to be used in an event identification system and may be an embodiment of FIGS. 21-23.

### DETAILED DESCRIPTION OF THE DRAWINGS

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

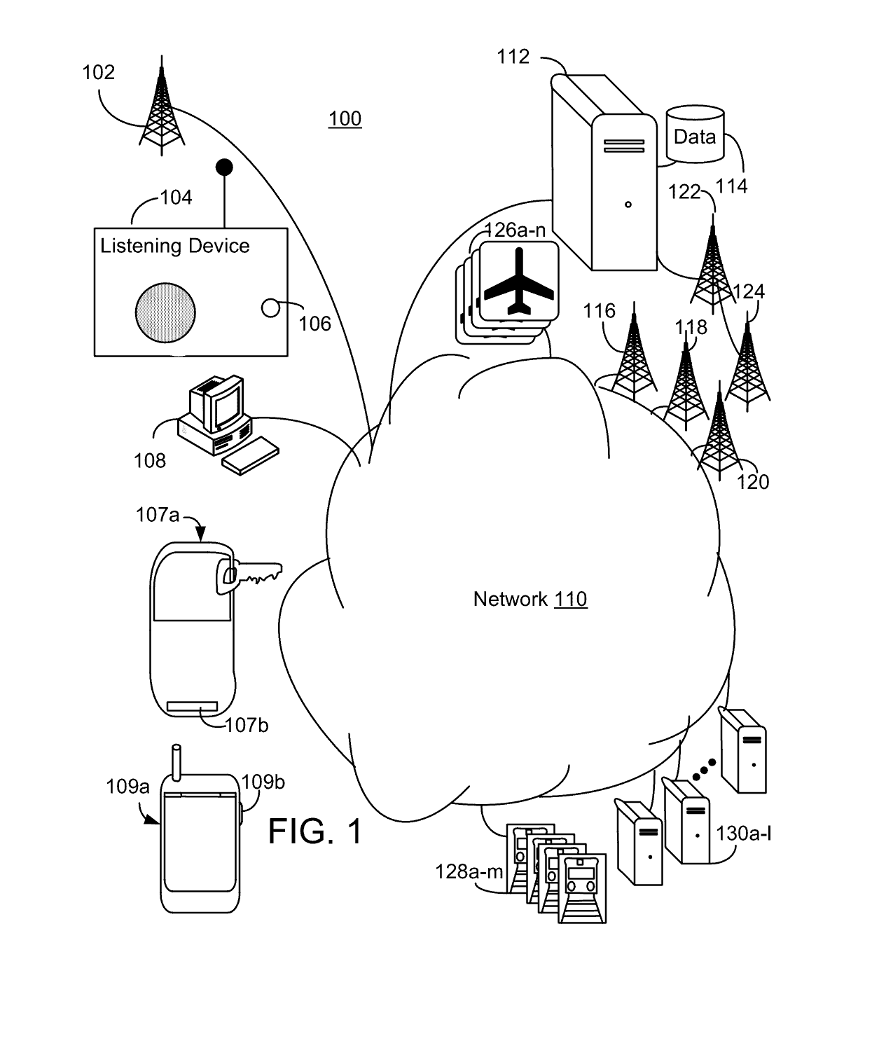

In general, at the beginning of the discussion of each of FIGS. 1-7, 10A, 10B, and 16-24 is a brief description of each element, which may have no more than the name of each of the elements in the one of FIGS. 1-7, 10A, 10B, and 16-24 that is being discussed. After the brief description of each element, each element is further discussed in numerical order. In general, each of FIGS. 1-24 is discussed in numerical order, and the elements within FIGS. 1-24 are also usually discussed in numerical order to facilitate easily locating the discussion of a particular element. Nonetheless, there is no one location where all of the information of any element of FIGS. 1-24 is necessarily located. Unique information about any particular element or any other aspect of any of FIGS. 1-24 may be found in, or implied by, any part of the specification.

In various places in discussing the drawings a range of letters, such as a-l, a-m, and a-n are used to refer to individual elements of various series of elements that are the same. In each of these series, the ending letters are integer variables that can be any number. Unless indicated otherwise, the number of elements in each of these series is unrelated to the number of elements in others of these series. Specifically, even though one letter (e.g. “1”) comes earlier in the alphabet than another letter (e.g., “n”), the order of these letters in the alphabet does not mean that the earlier letter represents a smaller number. The value of the earlier letter is unrelated to the later letter, and may represent a value that is greater than, the same as, or less than the later letter.

FIG. 1 shows an event identification system 100. Event identification system 100 includes broadcast source 102, listening device 104 having event stamp button 106, keychain 107a having event stamp button 107b, network appliance 108, mobile phone 109a optionally having event stamp button 109b, network 110, website host 112, database 114, broadcast sources 116-124, airports 126a-n, train stations 128a-m, and vendor website hosts 130a-l. In other embodiments, event identifying system 100 may not have all of the components associated with FIG. 1 or may have other components in addition to or instead of those components associated with FIG. 1.

Event identification system 100 may be used for identifying one or more different types of events. Event identification system 100 identifies at least some identifying information associated with at least certain events, such as a name or another identifier of the event. In this context, event information encompasses a broad range of types of occurrences, such as songs being played on the radio, information about the environment at a particular time, an occurrence of an action, or other forms of events. Similarly, a company that broadcast the sound and/or video segments, a company that shows a movie or play, a company that hosts a sporting event, a company that runs a store (such as a barber shop or restaurant), or company that runs a mode of transportation, such as a taxi, train, bus, airplane, may be referred to as event sponsors. In this specification, any place the word “time” is mentioned, such as in conjunction with an event time associated with an event stamp, it is generic to the time of day, the calendar date, and the combination of the time of day and the calendar date. Consequently, any place the word “time” appears at least three specific embodiments may be obtained by substituting, the time of day, the calendar date, and the combination of the time of day and the calendar date for the word “time.” As an example of a type of event that may be identified, in one embodiment, event identification system 100 is capable of identifying songs played on a radio station. In another embodiment, event identification system 100 is additionally, or alternatively, capable of identifying information about other types of events, such as which radio program was played at a particular time, information that was in an advertisement at a particular location, or which airplane or train passed by a particular location at a particular time or used a particular travel way (e.g., a particular train track, road, shipping lane and/or air passageway).

Broadcast source 102 may broadcast a wide variety of types of information, such as sound, text, and/or images. For example, broadcast source 102 may be a radio station that broadcasts sound segments, such as songs and/or radio programs. In another embodiment, broadcast source 102 may be a television station that broadcasts both image and sound information. Broadcast source 102 is discussed further in conjunction with broadcast sources 116-124.

Listening device 104 outputs the information being broadcast. For example, listening device 104 may include a radio. Listening device 104 may be capable of outputting sound or other information from other sources, such as a Compact Disc (CD), flash memory, and/or hard drive. For example, listening device 104 may include a radio, a television, and/or a media player, such as a Moving Pictures Expert Group 3 (MPEG 3—a compression standard—or more commonly referred to as MP3) player with a radio attached, or a cassette player with a radio attached. Optionally, listening device 104 may include a system that determines a current location, such as a Global Positioning System (GPS) or a receiver for receiving GPS coordinates from a GPS system. There are many embodiments of the event identification device. Listening device 104 is just one example of a device that may be used as and/or included in an event identification device. If the event identification device is capable of receiving broadcasts, it may be referred to as a receiving device. Other non-limiting examples are given below.

Event stamp button 106 is button that activates an event stamp function, which is a function that causes the recording of event stamp information, which may be identifying information. An event stamp function is generic to a timestamp but may include other information in addition to and/or instead of the time. For example, the event stamp may record time, location, image information (e.g. photographs, audio and/or video of a location and/or event), and/or a broadcast source being received. Any of the functions discussed in association with any of the event stamp buttons or event stamp functions in this specification may be associated with any event stamp function that may be initiated by any event stamp button. In this specification, the term identifying information refers to information that is used for identifying an event and the term event stamp information refers to information recorded as a result of activating an event stamp function. The event stamp function may be activated by one or two actions, for example. The event stamp information may be event identifying information. Event stamp button 106 is an example of an implementation of an event stamp function that may be included in any event identification device. For example, the event stamp information recorded by event stamp button 106 may include information related to when and where the event occurred and/or the type of event.

Event stamp button 106 may be a mechanical button, a heat sensitive pad, or other touch sensitive pad. Although in one embodiment, the event stamp function may be activated by pressing on a button in other embodiments the event stamp function is activated in any of a variety of other ways. For example, instead of event stamp button 106, the event stamp function may be activated by a switch, an icon on a display, a roller, a function of another button.

In one embodiment, event stamp button 106 is a timestamp that records the time of the event. In an embodiment, event stamp 106 may record a location associated with the pressing of event stamp 106. The location information may be useful for many different types of events in a variety of different ways. In the case of a radio broadcast, event stamp button 106 may record the time of day at which event stamp button 106 was activated, the radio station being played by listening device 104, and optionally may record location information (e.g., GPS coordinates). The location information may be useful in identifying a broadcast source such as a radio station, because the same radio station number may be used by different radio stations having different locations, for example. In other words, situations in which there are multiple radio or television stations having the same name but having different locations, the location information may be useful in differentiating between the two radios or television stations. Event stamp button 106 does not need to be placed on listening device 104.

The event stamp function may be associated with a multiplicity of different functions. Similarly, event identifying system 100 may be used for identifying any of a number of types of information. For example, the event stamp function may be used for creating a journal of locations and times that the locations were visited. The event stamp function may cause a search for a place, a song, a television program, a movie, a play, a form of transportation, and/or an advertisement. The event stamp function may cause a recording of an excerpt of a broadcast (including images and/or sound), sounds and/or images of the location at which the event function is implemented, and/or a voice annotation (e.g., explaining why the event stamp function was implemented and/or other information associated with an event). As another example, a user may be able to manually enter a time and a location along a railroad line, or a search may be automatically launched in response to activating an event stamp function, to find out which train passed by a particular location at a certain time. The user may be able to determine the train's origin and regular schedule. As another example, event identification system 100 may be used to find out information that was in an advertisement, such as on a billboard, in a bus or along a roadside and/or to find out information that was in an advertisement on television or radio.

Instead of, or in addition to, placing event stamp button 106 on listening device 104, an event stamp function may be placed on any mobile device to get information while traveling. The event stamp function may be placed on a viewing device, such as a television, on the dashboard of a car. The event stamp function may be placed elsewhere in a car, in a purse, in a wallet, on a briefcase, on a bicycle, and/or on a keychain (some examples are discussed below). Similarly, event stamp button 106 may be included on a cell phone, a media player, a computer, a web appliance, a MP3 player, a radio, a television, a vehicle, a handheld computer, a keychain or a memorandum device, for example. Each time the user activates the event stamp function, an immediate search launched for a particular type of information. Additionally, or alternatively, the time and optionally other information, such as a radio station being played may be recorded in a memory system in a machine readable medium. Optionally or alternatively, the device also collects GPS or other location information that is included in the event stamp to facilitate identifying the station. At a later time or immediately after collecting the event information, the user causes the event stamps to be uploaded to the website or the event stamp is automatically sent to the website in response to activating the event stamp function, and for each event stamp, the website displays corresponding event information, such as songs. Alternatively, the user enters the event stamp information into the website manually. Event information related to events that occurred before and after the time of the event may be returned in addition to events associated with the same time as the event stamp. In an embodiment in which the events are songs being played, for each event stamp, the song played at that time of the event stamp is displayed and one or two songs before and after the song corresponding to the time of the event stamp may also be displayed. Then the user may select a link for purchasing one or more songs desired.

In an embodiment, the time, location, and/or other data could be recorded by hand for use in determining an event. Alternatively, the user may carry a device that has an event stamp function on it. If included on a radio, upon hearing the broadcast segment, the event stamp button is pressed, and the time and radio station are automatically recorded. If the device has GPS capability, the GPS coordinates may be automatically recorded as part of the event stamp. In an embodiment, broadcasts may be sent with profile information, which may appear at the head of a broadcast message or elsewhere. Circuitry (e.g., a programmed processor) associated with the event stamp may be configured for reading the profile information of a broadcast from the circuitry associated with a media player or other device that is designed to read the profile information from the broadcast segment.

The event stamp function may be associated with a continuous recording of events (e.g., a continuous recording of all broadcast segments played on a radio or media player). The event stamp may be just a marking on the recording to identify the segment stamped. Optionally, part of the recording is discarded and part is retained. The part retained includes at least the segment marked and may optionally also include one or more segments preceding the one marked and/or one or more segments following the one marked. The user may hear a segment, and after the segment is finished, the user may decide that to purchase the segment. Retaining the one or more segments prior to and/or after the one marked facilitates finding the segment that is desired, even after the segment is no longer being broadcasted.

Specifically, returning several segments associated with times or other information other than the time and event information associated with the event stamp may facilitate finding the event (e.g., the broadcast segment) of interest despite potential inaccuracies in the time information or other information associated with the event. Regarding broadcast sources, even if the time associated with the event stamp is accurate, the broadcast source may not have a schedule of which segment was played at any particular time. Even if the broadcast source initially had a schedule of when the broadcast source planned to broadcast each segment, the broadcast source may deviate from its plans. For example, the broadcast source may play the segments at different times, play the segments in a different order, play segments not planned to be played, or not play all of the segments planned to play. As another example, if the events are taxis that are currently available and nearby, several available taxis may be returned in addition to the closest taxi, because the user may prefer to wait a longer time to get a taxi that is less expensive and/or that provides more courteous service.

Thus, after pressing the event function, the user may retrieve the information recorded and use the information to determine the event (e.g., the segment such as a song that was broadcast) by visiting the website and entering at least some of the information recorded. The information recorded may be uploaded to the website or entered by hand. Optionally, the event stamp function may automatically connect to a web address and initiate a purchase of the segment (e.g., by actually purchasing the segment or giving the user an option to purchase the segment). The event function may have different settings that control whether to immediately start a purchasing process or just record the event information without initiating a purchasing procedure. The event stamp function may send a communication, such as an e-mail or other communication, to a purchasing site (e.g., the website) that is answered at a later time. Alternatively, the event stamp function may initiate a direct link to the purchasing site.

As an example of listening device 104, listening device 104 may include at least a tuner having a read out of the station being played, a time source (e.g., a clock), and event stamp button 106. The event stamp function may be associated with a memory for recording the event stamp information. In an embodiment, instead of or in addition to using a time to identify a song, a fingerprint of the song is used. In other words, identifying characteristics of the song are recorded, such as a segment of the song, the tone, and/or the pitch. The identifying characteristics may then be used to identify and/or purchase the desired song. As another example in which time may or may not be included, the identification of a billboard may be performed by using the location to identify the advertisement. In an embodiment, the time is included in the event stamp even when not necessary for identifying the event.

Keychain 107a is another example of an event identification device, and keychain 107a may be for car keys and/or other keys. Event stamp button 107b is similar to event stamp button 106 in that it may be used for recording event identifying information, such as a time, a location, a radio station identifier, and/or other information that may be used for identifying an event. Event stamp button 107b is another example of a location where an event stamp function may be placed. Keychain 107a may include circuitry capable of locating a radio station based on sounds being emitted from a listening device (such as listening device 104) in response to activating event stamp button 107b. For example, keychain 107a may include a receiver for receiving audio signals. Upon pressing event stamp button 107b, the keychain scans radio stations using a tuner in the keychain. The audio signals for a radio external to the keychain are matched to songs found while scanning radio stations. Once a match is found, information identifying the song and/or the radio station playing the song is recorded. This information can be used later or immediately to purchase the song.

Network appliance 108 may be any of a number of types of appliances that are capable of accessing a network, such as a computer, a terminal, a web television, and/or a mobile phone. The user enters event identification information recorded by an event stamp function (e.g., event stamp button 106 or 107b) into network appliance 108, and in response network appliance 108 sends the event identifying information to another location for identifying the event associated with the information recorded by the event stamp function. The information may be entered manually, uploaded, and/or transferred wirelessly into network appliance 108. Network appliance 108 may itself have a hardware and/or software version of an event stamp function, and this embodiment is another example of an event identification device. In addition to, or instead of, the information recorded by event stamp functions 106 or 107b, an event stamp function associated with network appliance 108. In addition to or instead of the event stamp functions discussed in conjunction with event stamp buttons 106, 107b, and 109b, the event function of appliance 108 may record the URL link associated with a webcast and optionally other information about the webcast to facilitate identifying the webcast.

Mobile phone 109a is another example of an event identification device, and is an example of a network appliance. Mobile phone 109a may link via a phone network to a computer network to retrieve information associated with an event function stamp. Mobile phone 109a may include an event stamp button 109b. Although event stamp button 109b is depicted as a button, event stamp button 109b may be a menu item that is selected using cursor control buttons, such as the cursor control buttons that are often associated with the keypad of a mobile phone.

Network 110 may be any one of, or any combination of one or more Local Area Networks (LANs), Wide Area Networks (WANs) (e.g., an Internet or intranet), phone networks, wireless networks, and/or other networks. Event identifying information is sent from one of the devices having an event function via network 110 to a database, where more information about the event may be obtained.

Website host 112 hosts a website that may be accessed by one of the network appliances. The event stamp information (which may include event identifying information) is sent from one of the network appliances, via network 110, to website host 112. Website host 112 uses the event stamp information (and/or other information) to retrieve other event information, which may include an event identifier (e.g., a name of an event) and/or to retrieve information about vendors, stores, service providers, and/or professional within a given proximity of a particular location. The other event information may include download information and/or purchase information, which may be used to download and/or purchase a recording or other information about the event. For example, if the event is one or more songs or other segments of a radio program or one or more segments of a television show, the information downloaded may include information about where to download and/or purchase the one or more segments, songs, programs and/or shows. In an embodiment, the website may return several segments that are before and after the one corresponding to the timeslot chosen. The reasons for returning events corresponding to times before and after the time of interest are explained above.

In one embodiment, website host 112 may host a website in which a user enters the time, location, and broadcast source (e.g., radio station or television station) and the website returns the segment (e.g., song title and artist, radio program, or television program) that was being broadcasted at that time, for example. The website may have links to one or more vendors that sell the segments (e.g., songs) that were broadcasted. In one embodiment, the selection of the link causes the segment to be purchased. Alternatively, by selecting the link the user may be brought to web pages associated with the vendor for making the purchase. In another embodiment, any segment may be downloaded for free. In an embodiment, downloading segments for free may be limited to certain conditions, only at certain times, and/or only certain segments. Thus, in embodiments having a website, the user can hear a segment of a broadcast, write down the time, place, and/or other event information (or record the event information using an event function), and then the user can go to the website to obtain the segment. In another embodiment, in response to activating the event function, an identification device (such as listening device 104, key chain 107a, network appliance 108, and/or mobile phone 109a) may automatically initiate a search or make a purchase via website host 112, which then automatically returns the search results and/or a purchase receipt to the identification device. In an embodiment, website host 112 may include an application which in response to determining that a professional that provides a particular type of service (that is being searched for) is within a given proximity (e.g., 1 mile) of the searcher, sends a message (e.g., including the searcher's phone number, e-mail address, or instant messenger address) to the professional to contact the searcher.

Database 114 may store information that is used by website host 112 in conjunction with the event stamp information sent from one of the web appliances or another identifying device to identify the event. Additionally, database 114 may store information related to where to obtain and/or purchase commodities related to the event, such as songs, radio programs, airline tickets, train tickets, and/or tickets to shows. For example, database 114 may store information, such as links to websites where a broadcast may be purchased, playlists, programming schedules, and/or contact information for various broadcast sources. Website host 112 may maintain database 114 (in which event information, such as broadcast segments and information about the broadcast segments are stored). Database 114 may maintain a correlation of event information. For example, database 114 may maintain a correlation of the segments actually broadcasted with the times the segments were broadcasted and optionally with the other information such as the broadcaster, and the broadcast area of the broadcaster. Database 114 may maintain a correlation of routes, schedules, and bus numbers and/or train identifiers. Database 114 may maintain a correlation of taxi identifiers and current locations of the taxis. Database 114 may maintain a correlation of restaurants, locations, menus, and/or special offers. Database 114 may maintain a correlation of times, locations, temperature, pressure, humidity, and/or whether it was sunny, cloudy, or raining. Database 114 may maintain a list of professionals, vendors, stores, and/or services correlated with the locations, an availability indication, and/or hours of operations of the professionals, vendors, stores, and/or services. The availability indication may indicate whether a store is currently open or closed and/or whether a professional is currently willing to accept requests for service. The locations of the professionals may include the current GPS coordinates (or other location identifiers) of the professional. For example, if the professional is a doctor currently attending a baseball game, the location of the professional may include the GPS coordinates of the doctor at the baseball game and the availability indication may indicate whether the doctor is available for providing general medical services, emergency services, or not available. Thus, if user is not feeling well while at the baseball game, the user can perform a search for doctors, and the doctor may receive a message that there is someone in the baseball stadium that needs the doctor's services.

To keep database 114 up to date, website host 112 may monitor one or more (possibly a very large number of) broadcast sources (e.g., radio stations) and/or other sponsors. Further, based on the monitoring database 114 may record the date, time of day, event sponsor (e.g., broadcast source), and/or the event occurrence (e.g., the segment being broadcast). In an embodiment, the various broadcast sources may be monitored by human monitors, associated with website host 112 and/or database 114, that enter the data about the broadcast segment into database 114. In an embodiment, the broadcast source (e.g., a radio station) or other event sponsor may send an event schedule (e.g., a playlist, a schedule of entertainment events, or schedule associated with a mode of transportation) to database 114, a record of the times when the events actually occurred (e.g., when the segments were actually broadcasted, the entertainment event actually occurred, or the times when a transportation vehicle actually arrived at locations on its schedule), and/or other information associated with the events. Web site host 112 may provide the radio station or other event sponsors with tools for submitting a record to database 114 of when events occurred. Alternatively, the website host 112 may automatically monitor the event sources (e.g., broadcast sources or radio transmissions of dispatchers) and figure out which events occurred and when the events occurred.

In the case of broadcasts, the broadcast coming from the event source may include (e.g., come with) a profile from which event information may be extracted. For example, the profile may include the time of the segment, an identifier of the segment (e.g., the name of the song or program), and the location of the broadcast source of the segment. The event information may be extracted and stored in database 114 in correlation with the event, and/or may be extracted by the event identification device (e.g., listening device 104) of the user.

In the case of professionals, the professional may sign up for a service, which downloads an application onto the professional's cell phone or other mobile device, and the application may periodically send an update to database 114 of the current location of the professional. The application may include an option for indicating the professional current availability.

Broadcast sources 116-124 are a set of broadcast sources, such as radio or television stations. Broadcast sources 102 and 116-124 are one of many examples of types of event sponsors or event sources. Website host 112 collects information from broadcast sources 102 and 116-124 related to the time and content of broadcasts that were delivered, which may be stored in database 114. Thus, when information from an event stamp is received by website host 112, the information gathered from broadcast sources 102 and 116-124 may be used to determine the corresponding broadcast, the broadcast source from which the broadcast originated, and a link to a vendor that sells the broadcast. In some cases, the broadcast source may also be the vendor that sells the broadcast. Although only six broadcast sources are depicted, there may be any number of broadcast sources.

Broadcast sources 102 and 116-124 may be communicatively linked to website host 112 in a variety of different ways. For example, broadcast sources 102, 116, 118 and 120 may be linked to website host 112 via network 110. Thus, broadcast sources 102, 116, 118, 120 may be linked to website host 112 via WAN, LAN, and/or just ordinary phone lines, for example. Obtaining information from broadcast sources 102, 116, 118, and 120 may be automated or may involve a person telephoning, or listening to, broadcast sources 102, 116, 118, and 120, and then recording the information. Broadcast source 122 is an example of a broadcast source being directly connected to website host 112, and broadcast source 124 is an example of a broadcast source linked via another broadcast source, to website host 112. In an embodiment, an event source (e.g., one of broadcast sources 102 and 116-124 or other event source) and/or other sponsors of events may receive a monetary compensation each time a user purchases and/or accesses information related to a product based on an event (e.g., a broadcast or another event) that originated from (e.g., was sponsored by or broadcasted by) that event source. The broadcast source, such as one of broadcast sources 102 and 116-124, that hosted the event (e.g., that broadcasted the segment) may be compensated for purchases associated with the event, such as the purchase of the segment, every time a user makes a purchase that is based on information that is expected to have been obtained during the event, such as information indicating hearing the segment at the radio station or seeing an advertisement.

Airplane sources 126a-n and train sources 128a-m are examples of other sources of information about events and/or event sponsors that may provide information about events to website host 112. Airplane sources 126a-n represent one or more airports and/or airlines, and train sources 128a-m represent one or more train stations and/or transit services. For example, a user may hear a plane flying overhead, or a train passing by, at a particular time and location. The user then enters the information into one of the devices having an event stamp, such as network appliance 108 or mobile phone 109a. The event information is then forwarded to website host 112. Network host 112 then retrieves information from database 114, which was gathered from airplane sources 126a-n or train sources 128a-m, and then determines the airline and flight information or the train and train schedule, respectively. Network host 112 may also provide one or more links where an airline ticket or a train ticket (e.g., related to the event stamp information) may be purchased.

Vendor website hosts 130a-l represent one or more host of websites of vendors that sell songs, movies, radio programs, television programs, tickets to shows, tickets to movies, train tickets, airline tickets, taxis, barbers, restaurants, products associated with an advertisement and/or other products related to event identifying information provided. Website host 112 may send a link such as a URL to a web appliance or cause a web appliance to link to one of vendor website hosts 130a-l, in response to receiving a request to purchase items associated with an event form website host 112 and/or form a web appliance. Website host 112 may refer a web appliance to one of vendor website hosts 130a-l for buying a product and/or for finding out more information about the product.

Event identification system 100 may be used for identifying other types of events by including other types of organizations that are responsible for generating those events. For example, event identification system 100 may be used for identifying the contents of ads on buses or billboards by having website host 112 linked to the advertising agencies that produce the ads on the buses or bill boards, respectively.

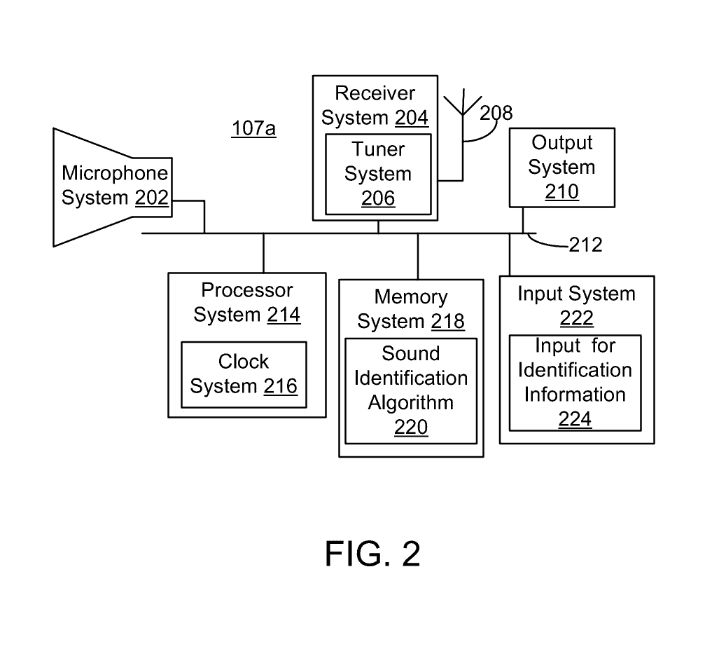

FIG. 2 shows a block diagram of an embodiment of keychain 107a. Keychain 107a may include microphone system 202 and receiver system 204, which may include tuner system 206. Keychain 107a may also include antenna system 208, output system 210, bus system 212, and processor system 214, which may include clock system 216. Keychain 107a may also include memory system 218, which may store sound identification algorithm 220. Also, keychain 107a may include input system 222, which may include input for identification information 224. In other embodiments, keychain 107a may include or may not include all of the components and/or may include other components, in addition to, and/or instead of the components listed above.

Microphone system 202 may include one or more microphones and may receive sound waves that are used for identifying a broadcast segment. Receiver system 204 may include one or more receivers that may receive radio waves, which may be compared to the broadcast segment in order to identify a television and/or radio station associated with the sound waves being emitted by the television or radio. Receiver system 204 may also be capable of receiving Global Positioning Satellite (GPS) signals for determining a current location.

Tuner system 206 may automatically tune the frequency of the radio waves that is received by receiver system 204 or otherwise change the channel or station being received by receiver system 204. By automatically tuning tuner system 206, a set of several stations and/or channels may be scanned in order to determine whether there is a match between the broadcast segment received by the microphone and the radio waves received by the receiver. In some cases, the time that it takes to match the sound waves received with a radio station may be longer than the time of play of the radio broadcast of interest, but nonetheless the radio station may be identified, which in combination with the time may identify the broadcast segment of interest.

Antenna system 208 is attached to receiver system 204 and picks up an electromagnetic signal from the environment, which is sent to receiver system 204. The electromagnetic signal picked up by antenna system 208 is determined by the current settings of tuner system 206. Antenna system 208 may be located within the key fob of the keychain and/or exterior to the key fob. In an embodiment, the keychain attached to the key fob is part of the antenna, and consequently any metal keys attached hanging on the keychain may also act as part of antenna system 208.

Output system 210 is for outputting identifying information associated with the broadcast segment. For example, output system 210 may include a port that can be communicatively coupled to a computer via which the event stamp information may be transferred to a computer so that the broadcast segment may be identified via a website on network 110. The communicative coupling may be accomplished by an electrical and/or optical connection, for example. In addition to, or instead of a port, output system 210 may include a display for displaying the event stamp information so that the event stamp information may be manually input to a web appliance attached to network 110. If output system 210 includes a display, the display may show information input by a user, so that the user can verify that the information that is currently being input is the information that was intended to be input. Depending on the embodiment, the display may be capable of displaying both input information and displaying automatically generated event stamp information. Alternatively, the display may only be capable of displaying one of the input information or the automatically generated event stamp information.

Bus system 212 carries signals between the components of keychain 107a. For example, bus system 212 communicatively couples microphone system 202, receiver system 204, and processor system 214 (processor system 214 is discussed in the next paragraph). In other embodiments, the components of keychain 107a communicate in other ways instead of using bus system 212.

Processor system 214 may compare signals generated by microphone system 202 (generated as a result of the microphone receiving sound waves) and signals generated by receiver system 204 (generated as a result of receiver system 204 receiving radio waves) to determine whether the broadcast segment matches the radio waves or matches a broadcast segment stored on database 114. Processor system 214 may also automatically change the settings of tuner system 206 in order to cause receiver system 204 to scan a set of radio and/or television stations. Processor system 214 may also process GPS signals to determine a location.

Clock system 216 may have many uses that facilitate the operations of processor system 214, for example. Additionally, clock system 216 may be used for recording a time associated with the broadcast segment received via microphone system 202. For example, if a user presses on an event stamp button, processor system 214 may read clock system 216 and record the time in association with other identifying information that may be recorded as event stamp information and may be used to identify the broadcast segment. In an alternative embodiment, processor system 214 may be replaced with a specialized circuit that is configured for comparing the broadcast segment with the radio waves received and thereby determine the radio or television station being listened to and/or configured for recording the time associated with a broadcast segment of interest.

Memory system 218 may store the event stamp information. For example, memory system 218 may store a time associated with activating the event stamp function and a radio or television station that processor system 214 identified as matching the broadcast segment. Memory system 218 may also store a location where the timestamp was pressed, which may have been determined by processor system 214 based on GPS signals. Memory system 218 may also store a part of the broadcast segment, which may be used to help identify the broadcast segment at a later time with the aid of a computer and/or a website.

Sound identification algorithm 220 may also be stored in memory system 218. Sound identification algorithm 220 may be the machine instructions implemented by processor system 214 to determine whether the broadcast segment received and stored in memory system 218 matches radio waves received or a broadcast segment in database 214.

Input system 222 may include a button that activates the event stamp function and causes event stamp information to be recorded in memory system 218 and/or may cause other identification information to be collected and/or stored as part of the event stamp information. Input for identification information 224 may include a keypad or other input mechanism via which identification information can be entered manually via the user, which may be used as event stamp information.

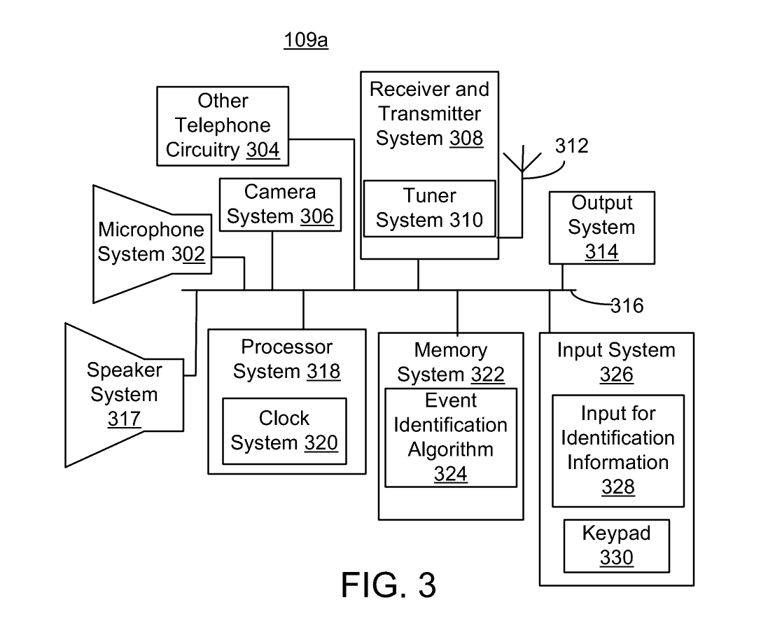

FIG. 3 shows a block diagram of an embodiment of mobile phone 109a. Mobile 109a may include microphone system 302, other telephone circuitry 304, camera system 306, and receiver and transmitter system 308, which may include tuner system 310. Mobile phone 109a may also include antenna system 312, output system 314, bus system 316, speaker system 317, and processor system 318, which may include clock system 320. Mobile phone 109a may also include memory system 322, which may store event identification algorithm 324. Also, mobile phone 109a may include input system 326, which may include input for identification information 328 and keypad 330. In other embodiments, mobile phone 109a may not include all of the components and/or may include other components, in addition to, and/or instead of the components listed above.

Microphone system 302 is for the user to speak into when making a telephone call. Other telephone circuitry 304 is the circuitry that allows mobile phone 109a to function as a telephone, which may include functions for dialing, connecting to a telephone network, storing messages, storing phone numbers, and voice mail, for example.

Camera system 306 is for taking pictures and is optional. The user may choose to take any picture desired upload the picture and send the picture to a friend, for example. Camera system 306 may also take a picture in response to activating the event stamp button 109a. The picture taken by camera system 306 in response to operating may be stored in association with the time and other identifying information.

Receiver and transmitter system 308 receives and transmits messages from and to, respectively, a wireless network. Receiver and transmitter system 308 may receive and transmit phone messages. Optionally, receiver and transmitter system 308 may also receive radio waves. Receiver and transmitter system 308 may also be capable of receiving GPS signals for determining a current location. Receiver and transmitter system 308 may be used for communicatively coupling to a web server, such as website host 112, that stores information, such as playlists of radio stations (that may be used for determining a song, program, or other broadcast segment), menus of restaurants, price lists, taxi locations, or other event information based on event stamp information stored in order to identify the broadcast segment or other event.

Tuner system 310 is optional, and (if present) may tune the frequency of the radio waves that is received by receiver and transmitter system 308 to allow the user to choose which radio station to listen to. Antenna system 312 is attached to receiver and transmitter system 308 and picks up an electromagnetic signal from the environment, which is sent to receiver system 204. The electromagnetic signal picked up by antenna system 312 is determined by the current settings of tuner 312.

Output system 314 is for outputting menu information, search results (which may have been produced as a result of activating an event function), viewing phone numbers being dialed, viewing phone numbers stored, viewing television programs, and optionally viewing information related to a radio station being listened to, for example. Output system 314 may be used for surfing a WAN, such as the Internet, sending and viewing text messages, and viewing web pages. For example, output system 314 may be used for viewing candidates for a broadcast segment or other event information that corresponds to event stamp information stored. Output system 314 may also be used to view the event stamp information being stored. Output system 314 may include a port that can be communicatively coupled to a computer via which the identification information may be transferred to a computer so that the event information may be identified via a website on network 110.

Bus system 316 carries signals between all of the components of mobile 109a. For example, bus system 316 communicatively couples microphone system 302, other telephone circuitry 304, camera system 306, receiver and transmitter system 308, output system 314, and processor system 318 (processor system 318 is discussed in the next paragraph). Speaker system 317 may be used for listening to phone calls, radio stations, television programs, and/or web pages, for example.

Processor system 318 may be configured for automatically or manually locating a website and sending event stamp information to a server for determining an identity of a broadcast segment associated with event stamp information stored on mobile phone 109a in response to pressing event stamp button 109b. Processor system 318 may also be configured for automatically making a purchase base on event stamp information (for example, based on information identifying the broadcast segment). Processor system 318 may also process GPS signals to determine a location. Processor 318 may be configured for reading profile information in a broadcast segment.

Clock system 320 may facilitate the operations of processor system 318. Clock system 320 may also be used for determining a time associated with an event stamp. For example, if a user presses on an event stamp button, processor system 316 may read clock system 320 and record the time in association with other identifying information that may be used included in the event stamp information. In an alternative embodiment, processor system 318 may be replaced with a specialized circuit that is configured for recording event stamps, locating a website, sending the event stamp information to the appropriate host, receiving search results that are based on the event stamp information sent, initiating a purchase based on the event stamp information, and/or completing the purchase initialized.

Memory system 322 may store the identification information. For example, memory system 322 may store a time associated with pressing an event stamp button and a radio or television station that processor system 318 determined as being associated with a broadcast segment that was being played at the time the event stamp was pressed. Memory system 322 may also store a picture taken by camera system 306, which may have been taken in conjunction with pressing the event stamp button. Similarly, memory system 322 may store a location where the timestamp was pressed, which may have been determined by processor system 318 based on GPS signals. Memory system 322 may also store a part of the broadcast segment, which may be used to help identify the broadcast segment at a later time with the aid of a computer and/or a website. As explained above, storing a portion of a broadcast segment may facilitate automatically identifying the correct broadcast segment so that a purchase may also be automatically made without the user reviewing the item being purchased, because the likelihood of purchasing the wrong item is reasonably low.

Event identification algorithm 324 may also be stored in memory system 322. Event identification algorithm 324 may be the machine instructions implemented by processor system 318 that determines the station to which tuner system 310 is tuned. Event identification algorithm 324 may include instructions that cause processor system 318 to take measurements of the frequency to which tuner 310 is tuned. Event identification algorithm 324 may contain instructions that cause processor system 318 to automatically (and/or manually) access a remote database, send event stamp information to the database, and in response receive such results, such as information from the database further identifying the event. For example, the further information may be a name of a song, a name of a radio program, a name of a television program, a name of a movie, the number of a bus or train and a name of the company operating the bus or the train, a connection to a taxi dispatcher, the name of a product and an advertiser that makes the product such as the name of a restaurant, club, or hotel.

Input system 326 may include any of a variety of input mechanisms, such as keys, buttons, touch pads, ports for optically or electronically downloading information from other machines (e.g., computers or other mobile phones). In an embodiment, input for identification information 328 may include one or more buttons that initiate an event stamp function, which may include the collection of event identifying information. For example, input for identification information 328 may include a button that may cause processor system 318 to read and record the time from clock system 320. Additionally, the button may cause a picture to be taken and stored in association with the time. Alternatively, the button may cause processor 318 to collect GPS or other location information, which is then stored in association with the time. The button may also cause processor 318 to access a database containing more information related to the identifying information stored. Input identifying information 328 may include two buttons—one button may be for collecting and recording the event identifying information, and the other button may be for accessing one or more remote databases that are expected to contain more information related to event identifying information. Additionally, or alternatively, input for identifying information 328 may include a button for causing identifying information collected to be displayed via output system 314.

In an embodiment, input for identifying information 328 may include one or more mode buttons, which change the mode of an event stamp button. In one mode, the event stamp button may collect information related to a radio or television program being received, which is recorded as the event identifying information. In another mode, the event identifying information collected and recorded may be related to available transportation, such as commuter buses, trains, and planes. In yet another mode, the information collected and recorded may be related to forms of entertainment that are in a particular area, such as restaurants, clubs, gyms, theaters, parks, and museums. In still another mode, information related to advertisements, such as advertisements on public billboards or in public commuter facilities (e.g., trains, train stations, buses, bus stations, airports, and airplanes) and/or local shops, such as barbers, bookstores, grocery stores, clothing stores, and/or shoe stores may be collected and recorded. Some modes may collect and record the same information, but differ as to which database or which portion of a database is accessed when retrieving further information about the event. For example, a mode for collecting information related to advertisements and a mode for collecting information related to modes of transportation may both record the time, GPS information, and a picture, but the transportation mode may access a database of transportation schedules (e.g., bus, train, and/or plain schedules), while the advertisement mode may access a database storing names of advertisers, products advertised, and the locations where the advertisements are displayed. In a mode for transportation, current locations of available taxis may be included along with an option for automatically ordering a taxi to come and/or for automatically dialing a phone number to contact the taxi or the taxi dispatcher. In a mode for seeing information about places for entertainment, an advertisement may be generated in real time that give special offers if the user uses the service within a particular time frame. For example, if the user is standing outside of the door of a restaurant, and the user activates the event stamp function, in addition to receiving information ordinarily provided by the restaurant, the user may receive a discount if the use orders within a given period of time. In a mode for searching advertisements and local shops, the user may be able to automatically reserve a time for a haircut.

The modes may be configurable. For example, event identification algorithm 324 may include instructions that allow the user to configure a transportation mode to only collect information about trains. Event identification algorithm 324 may contain instructions that allow the user to establish a new mode.

Keypad 330 may be a standard keypad provided with a standard mobile phone. Alternatively, one or more of the keys of keypad 330 may act as one or more event buttons and/or as one or more mode buttons for the one or more event buttons. Keypad 330 may include keys and/or modes that allow the user to view event identifying information that was recorded, retrieve information from one or more databases related to the event stamp information initially recorded, and/or to purchase products based on the information retrieved from one or more databases. Additionally, or alternatively, keypad 330 may allow the user to configure one or more mode buttons of input for identification information 328.

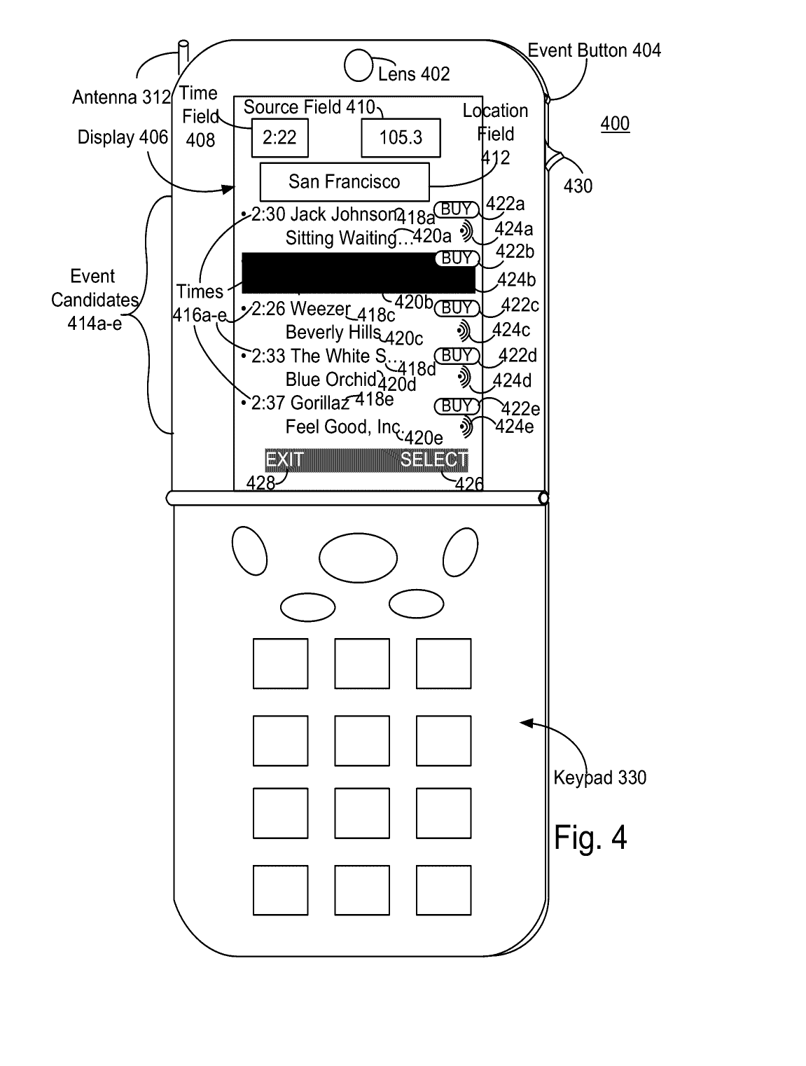

FIG. 4 shows an embodiment 400 of mobile phone 109a, which may be an embodiment of in FIG. 3 or another embodiment. Mobile phone 400 may include antenna system 312, keypad 330, lens 402, event button 404, display 406, time field 408, source field 410, location field 412, candidates 414a-e, which may include times 416a-e, event names 418a-e, event sponsors 420a-e, links 422a-e, and sampler links 424a-e. Mobile phone 400 may also include exit 426, select 428, and switch 430. In other embodiments, mobile phone 400 may include may not include all of the components and/or may include other components, in addition to, and/or instead of the components listed above.

Antenna system 312 and keypad 330 were described in conjunction with FIG. 3, above. However, antenna system 312 and keypad 330 may be used with different circuits than the one of FIG. 3. Lens 402 may be a lens for (forming an image to be recorded) or a view finder for a camera, such as camera system 306 (FIG. 3).

Event button 404 may be part of input for identification information 328 (FIG. 3). Although only one event button is illustrated in FIG. 4, mobile phone 400 may have multiple event buttons and/or mode buttons associated with event button 404, as discussed in conjunction with input for identification information 328. In the example of FIG. 4, event button 404 is illustrated as having a cylindrical component protruding from the housing of mobile phone 400. In an embodiment, the cylindrical component of event button 404 rotates. By pressing event button 404 inwards, the collection of event stamp information may be initiated. In this embodiment, rotating event button 404 may cause scrolling through information displayed in association with event button 404. For example, after associating the event stamp information collected with other event information in a remote database and after retrieving the information (e.g., search results) from the remote database, the information retrieved may be displayed on a display of mobile phone 400 and scrolled through by rotating the cylindrical component of event button 404. Similarly, event button 404 may be used for scrolling through event identifying information collected prior to retrieving information from any database. In other embodiment, event button 404 may have other features that facilitate navigation through information associated with events. In other embodiments, event button 404 may be another sort of switch or button, and scrolling and/or other navigation functions may be implemented by pressing navigation buttons on keypad 330 instead of, or in addition to, event button 404 having navigation features.

Display 406 is the display of mobile phone 400, which may be part of output system 314 (FIG. 3). In FIG. 4, mobile phone 400 is in a mode in which display 406 displays information (about an event) that was retrieved from a remote database. However, mobile phone 400 may have many other modes for displaying many other types of information, such as the information discussed in conjunction with output system 314.

Time field 408 displays a time that was recorded as a result of activating event button 404. In an embodiment, first the user presses event button 404, and event stamp information (e.g., one or more event identifying pieces of information) are collected and stored. Then, immediately or at a later time, a search is automatically launched or the user manually retrieves the event stamp information, and causes the event stamp information to be matched with more information in a remote database, which is returned to mobile phone 400. The information returned may be displayed on display 406. Time field 408 displays the time that the event stamp information was collected as a result of pressing event button 404. In other modes and/or in other embodiments, the time in time field 408 may be entered manually in addition to, or instead of, by selecting an entry stored in the memory of mobile phone 400 (which was stored as a result of pressing event button 402) as an event stamp.

Similarly, source field 410 shows the source of the event associated with the time in time field 408. In the example illustrated in FIG. 4, the event is the playing of a song, and source of the event is the radio station indicated in source field 410. However, in other embodiments and/or in other modes the source of the event displayed in source field 410 may be any of a variety of sources of events such as television stations, current locations of taxis, menu information for restaurants, a bus having an advertisement, an airport where a plane landed, or a train station where a train arrived. In some modes, the source of the event may be assumed to be unknown, and another type of information may be displayed in source field 410 or source field 410 may be left blank or not present on display 406.

Location field 412 may be a location where the event was observed, which was collected as a result of activating event button 404. In the example of FIG. 4, location field 412 illustrates the location where the song was heard. However, in other embodiments and/or modes the location may be a location where an advertisement, a plane, a train, a bus was seen, for example. Although in the example of FIG. 4, the location is a city, which is stationary and of a certain general size, in other embodiments and/or modes the location may be of a smaller or larger size and/or may be mobile. For example, the location may be designated by GPS coordinates, a longitude and latitude, a street, a county, a state, a country, a particular bus, a particular train, and/or a particular plane. In an embodiment, time field 408, source field 410, and/or location field 412 are filled in automatically in response to pushing event button 109b.

Event candidates 414a-e are candidates for the event of interest to the user. In an embodiment, the event candidate that is expected to be the one of interest to the user is at least initially displayed as highlighted (e.g., selected). In an embodiment, other candidates that occurred before or after the time associated with the event stamp are also displayed so that the user can decide which event (if any) is the one of interest. Although in the example of FIG. 4, five event candidates are displayed in other embodiments and/or other modes, more candidates or fewer candidates may be displayed. In an embodiment, the user can configure mobile phone 400 to display the number of candidates desired and/or can select criterion for deciding which candidates are most likely to be of interest.

Times 416a-e are the times at which each of candidate events 414a-e occurred. Names 418a-e are names of candidate events 414a-e, respectively, which in the example of FIG. 4 are names of songs. Sponsors 420a-e are the names of creators or producers or of candidate events 414a-e.

Links 422a-e are links where each of event candidates 414a-e or items related to each of event candidates 414a-e can be found, purchased, and/or downloaded. In the example of FIG. 4, links 422a-e may link the user to a webpage where the user can buy and download the song. In other embodiments and/or modes, the user may be brought to a site where the user can download the song for free, purchase tickets for a theater, make reservations for a restaurant, call a dispatcher of a nearby cab, and/or purchase tickets for a train, plane, and/or bus.

Sampler links 424a-e may allow the user to see and/or hear at least a portion of event candidates 414a-e, respectively. Thus in the example of a song the user can hear the song to determine if the event candidate is the song they want to purchase. In the example of a television program or movie, sampler links 424a-e may allow the user to see some of the movie or television program. In the case of a restaurant, sampler links 424a-e may allow the user to see the menu or a picture of the restaurant. In the case of a form of transportation, sampler links 424a-e may allow the user the see the fair, the schedule, and/or route that the particular public transportation vehicle follows.

Select 426 is for selecting one of links 422a-e or sampler links 424a-e. Exit 428 exits the mode for viewing candidates 414a-e, allowing the user to select other functions of mobile phone 400. Switch 430 is for turning mobile phone 400 on and/or off.

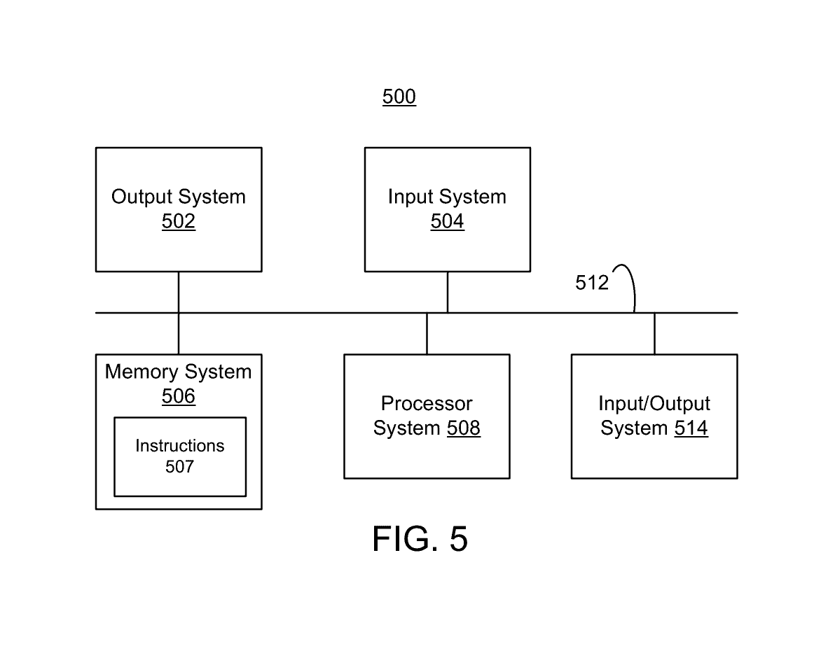

FIG. 5 shows a block diagram of a machine 500 used in event identification system 100. Machine 500 may include output system 502, input system 504, memory system 506, instructions 507, processor system 508, communications system 512, and input/output system 514. In other embodiments, machine 500 may include may not include all of the components and/or may include other components, in addition to, and/or instead of the components listed above.

Machine 500 is an example of a computer or other machine that may be used for any of network appliance 108, website host 112, database 114, and vendor website hosts 130a-l may have the structure of machine 500.

Output system 502 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example.

Input system 504 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for example.

Memory system 506 may include, for example, any one of, some of, any combination of, or all of a long term storage system, such as a hard drive; a short term storage system, such as random access memory; a removable storage system, such as a floppy drive or a removable drive; and/or flash memory. Memory system 506 may include one or more machine-readable mediums that may store a variety of different types of information. The term machine-readable medium is used to refer to any non-transient medium capable carrying information that is readable by a machine. One example of a machine-readable medium is a computer-readable medium. Another example of a machine-readable medium is paper having holes that are detected that trigger different mechanical, electrical, and/or logic responses.

Instructions 507 allow machine 500 to perform the tasks for which it was configured. If system 500 is used for network appliance 108, instruction 505 may include an event identification algorithm similar to that of keychain 107a and/or mobile phone 109a. If machine 500 is website host 112, instructions 507 may cause one or more processors to present a webpage presenting event candidates. If machine 500 is website host 112, instructions 507 may allow machine 500 to receive event identifying information from a network appliance, and to send representations of event candidates to website host 112. If machine 500 is website host 112, instructions 507 may forward the user to a website for purchasing items related to one of the event candidates. Instructions 507 may cause website host 112 to submit a query to database 114 and retrieve information from database 114. If machine 500 is any of network appliance 108, website host 112, database 114, and vendor website hosts 130a-l, instructions 507 may also include an algorithm for matching images and/or sound segments.

If machine 500 is used for database 114 or website host 112, instructions 507 may include a database server, which in turn may include instructions for finding and retrieving information from database 114. If machine 500 is used for database 114, memory system 506 may store information and/or representations of events, such as playlists, transportation schedules, television schedules, current movie showings, play bills, restaurant menus, and/or other information. If machine 500 is any of vendor website hosts 130a-l, instructions 507 may allow the vendor website host to receive a request to present a webpage for purchasing various products, such as songs, movies, tickets, and/or other products.

Processor system 508 may include any one of, some of, any combination of, or all of multiple parallel processors, a single processor, a system of processors having one or more central processors and/or one or more specialized processors dedicated to specific tasks. Processor 508 may implement instructions 507 and/or cause an event function to be performed in response to pressing an event stamp button or otherwise activating an event stamp function.

Communications system 512 communicatively links output system 502, input system 504, memory system 506, processor system 508, and/or input/output system 514 to each other. Communications system 512 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

Input/output system 514 may include devices that have the dual function as input and output devices. For example, input/output system 514 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 514 is optional, and may be used in addition to or in place of output system 502 and/or input system 504. If machine 500 is network appliance 108, input/output system 514 may include an event stamp button or other mechanism for activating an event stamp function.

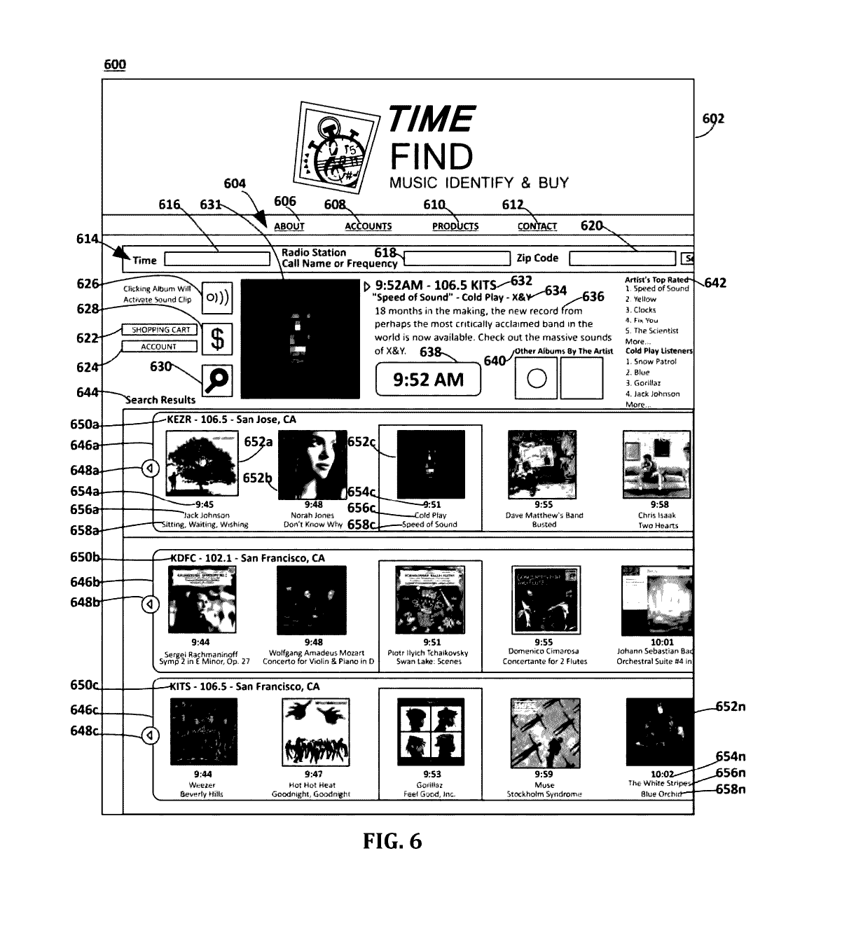

FIG. 6 shows an example of a screenshot of a webpage 600 that may be presented by website host 112. Webpage 600 may include header 602 and navigation links 604, which may include about link 606, accounts link 608, products link 610, and contact link 612. Webpage 600 may also include search field bar 614, which may include time field 616, source field 618, and location field 620. Webpage 600 may include shopping cart link 622, account link 624, sampler link 626, price link 628, details link 630, selected candidate image 631, selected candidate source 632, selected candidate sponsor 634, selected candidate information 636, selected candidate time 638, same sponsor products 640, other related products 642, search results 644, event candidate sources 646a-c, navigation icons 648a-c, source identifiers 650a-c, event candidate images 652a-n, event candidate times 654a-n, event candidate sponsors 656a-n, and event candidate names 658a-n. In other embodiments, webpage 600 may not include all of the features listed above and/or may include additional features instead of, or in addition to, those listed above.

FIG. 6 displays an example of a webpage in which the events are broadcasts of songs. The respective titles and artists of the songs correspond to event stamps for songs. FIG. 6 has three rows of icons at the bottom, and each row includes five icons. Each row corresponds to a single event stamp. In each row, the icon that has been grayed indicates the song played precisely at the timeslot corresponding to a time associated with the event stamp. The user may select one of the icons corresponding to songs played before and after the grayed icon instead of selecting the grayed icon.

Specifically, header 602 may provide information identifying the purpose and/or owners of the website. Although not illustrated, the webpage shown in display 406 of FIG. 4 may have a similar header. However, webpage 600 has more room for a header, and consequently, header 602 may provide more information than a header for the Short Message Service (SMS) webpage of FIG. 4 or the header may be absent. In an embodiment, mobile phone 107a views a SMS version of webpage 600. Navigation links 604 are links to other web pages associated with the same website as webpage 600. About link 606 is a link to one or more webpages describing various aspects of the organization that sponsors and/or maintains the webpage 600. Accounts link 608 is a link to one or more webpages that assist an individual in setting up an account. Products link 610 links the user to one or more webpages that describe other products provided by the same organization that sponsors and/or maintains webpage 600. Contact link 612 links the user to one or more webpages that give information related to contacting the organization that sponsors and/or maintains webpage 600. In other embodiments, navigation links 605 may not include all of the links of the example of FIG. 4 or may include other links in addition to, or instead of, the navigation links of FIG. 4.

Search field bar 614 includes one or more different fields via which the user may search for the event of interest. Time field 616, source field 618, and location field 620 are essentially the same as time field 408, source field 410, and location field 412, respectively, which were described above in conjunction with FIG. 4. Although in the example of FIG. 4 location field 410 has a city name identifying the location and in the example of FIG. 6 the zip code is used for identifying the location in other embodiments location field 620 may use a city name or other location identifier and/or mobile phone 107a may use a zip code or other location identifier to identify the location associated with the event. In an embodiment, time field 616, source field 618, and location field 620 are filled in automatically. If the user of the webpage 600 or mobile phone 107a is accessing webpage 600 via a device without an event stamp or with an event stamp, but without a means of automatically transmitting the information to website host 112, the user is likely to enter the information manually.

Shopping cart link 622 links a user to one or more webpages where the user may view the items the user selected for purchasing, but has not yet purchased and/or the prices associated with the items selected for purchase. Account link 624 link the user to one or more webpages where the user can view information about their account. In an embodiment, accounts link 608 and account link 624 access the same information. In an embodiment, only one of account links 602 and account link 624 appear on webpage 600.

Sampler link 626 is the same as sampler links 424a-e, which are described in conjunction with FIG. 4, above. Although in the example of FIG. 4 each of event candidates 414a-e has a sampler link, while in the example of FIG. 6 only the selected candidate has a sampler link, in other embodiments and/or modes mobile phone 107a may only offer a sampler link for the selected candidate and webpage 600 may offer a sampler link for each event candidate. In other embodiments, sampler links do not appear for all event candidates displayed, but still appear for other event candidates in addition to the selected event candidate. For example, in another embodiment, in mobile phone 107a and/or on webpage 600, sampler links only appear for the three event candidates that are expected to have the highest likelihood of being the event candidate of interest.

Price link 628 may link the user to one or more webpages that show the price of the selected candidate. For example, price link 628 may link the user to a list of vendors or to links to vendors that sell items related to the event, and the prices that each vendor charges. Alternatively, selecting or moving a cursor over and/or near price link 628 may cause a balloon to appear displaying the price. In another embodiment, the price may be displayed instead of price link 628 and/or another price links may be displayed elsewhere.

Details link 630 may allow a user to view more details and/or see a larger version of an image displayed for the purposes of representing the selected candidate. Selected candidate image 631 may an image of an item associated with the selected candidate. For example, if the selected candidate is a song, candidate image 631 may be the image on a cover of an album and/or CD where the song can be found. Selected candidate source 632 is the source of the selected event candidate. Sources were described in conjunction with sources 418a-e of FIG. 4. Selected candidate sponsor 634 is the sponsor of the selected event sponsor. Event sponsor were described in conjunction with sponsor 420a-e of FIG. 4. Selected candidate information 636 gives more information related to the selected event candidate. Selected candidate time 638 is the time associated with the selected event candidate. The times associated with event candidates was described in conjunction with times 416a-e of FIG. 4.

Same sponsor products 640 is a list of products (e.g., events or other products) having the same sponsor (e.g., that were made by the same artist and/or that are sold by the same company). Other related products 642 is a list of other products related to the selected event. Search results 644 lists the results of one or more searches for events corresponding to one or more event stamps.

Event candidate sources 646a-c are the event sources that correspond to the information associated with each event stamp entered as a search query. Navigation icons 648a-c allow the user to navigate (e.g., scroll through) the candidate events associated with a particular event source. Source identifiers 650a-c identify the event sources. In the example of FIG. 6 in which the event sources are radio stations, the source identifiers 650a-c are the location, name, and/or frequency associated with each radio station. Event candidate images 652a-n are images (e.g. icons image of covers of CDs having the candidate song) associated with each of the event candidates, respectively. Event candidate times 654a-n, event candidate sponsors 656a-n, and event candidate names 658a-n are essentially the same as times 416a-e, sponsors 420a-e, and names 418a-e, respectively, which were described in conjunction with FIG. 4.

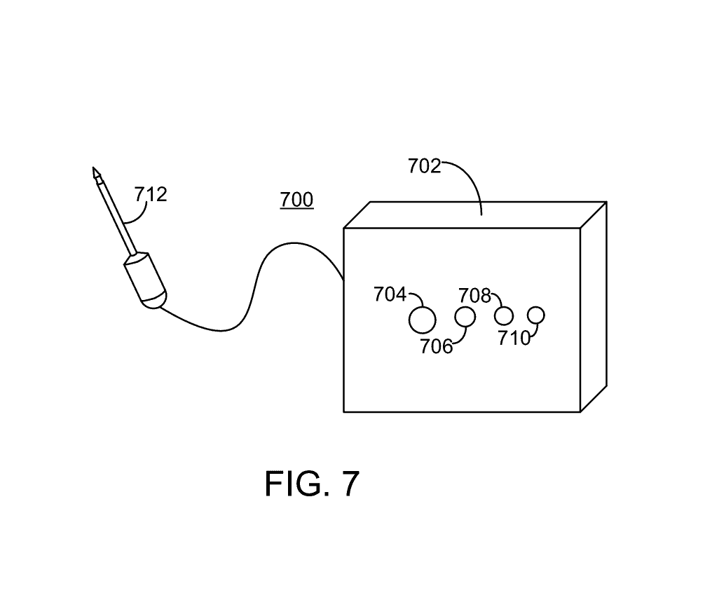

FIG. 7 shows an attachment 700 that may be attached to another device to thereby add an event button. Attachment 700 includes housing 702, event stamp button 704, first mode button 706, second mode button 708, third mode button 710, and connector 712. In other embodiments, attachment 700 may not include all of the components listed above and/or may include other components instead of, or in addition to, those listed above.

Attachment 700 may include a circuit similar to machine 500 housed within housing 702. Event stamp button 704 may have the same functions as event button 404 of FIG. 4. The machine to which attachment 700 is attached will be referred to as the primary appliance. Pressing event stamp button 704 may cause the device to which attachment 700 is attached (the primary appliance) to collect event stamp information. In another embodiment, pressing event stamp button 704 may cause attachment 700 to collect event information. For example, attachment 700 may include a clock whose time is read and recorded as a result of pressing event stamp button 704. Similarly, pressing event stamp button 704 may cause attachment 700 to determine a radio station to which the primary device is tuned. First mode button 706, second mode button 708, and third mode button 710 may change the mode of event stamp button 704. For example, first mode button 706 may place event stamp button 704 in a mode in which event information related to broadcasts is collected, second mode button 708 may place event stamp button 704 in a mode in which event information related to transportation is collected, and third mode button 710 may place event stamp button 704 in a mode in which event information related to entertainment (e.g., restaurants and theaters) is collected. There may be a third mode button for collecting information related to advertisements. Connector 712 connects to the primary appliance, such as a cell phone, computer, or another primary appliance. Connector 712 is not limited to the specific type of connector illustrated. Any of a number of connectors may be used instead, such as a USB connector or another connector. In one embodiment, attachment 700 stores the event information in the memory of attachment 700. In another embodiment, attachment 700 stores the event information collected in the memory of the primary appliance to which it is attached.

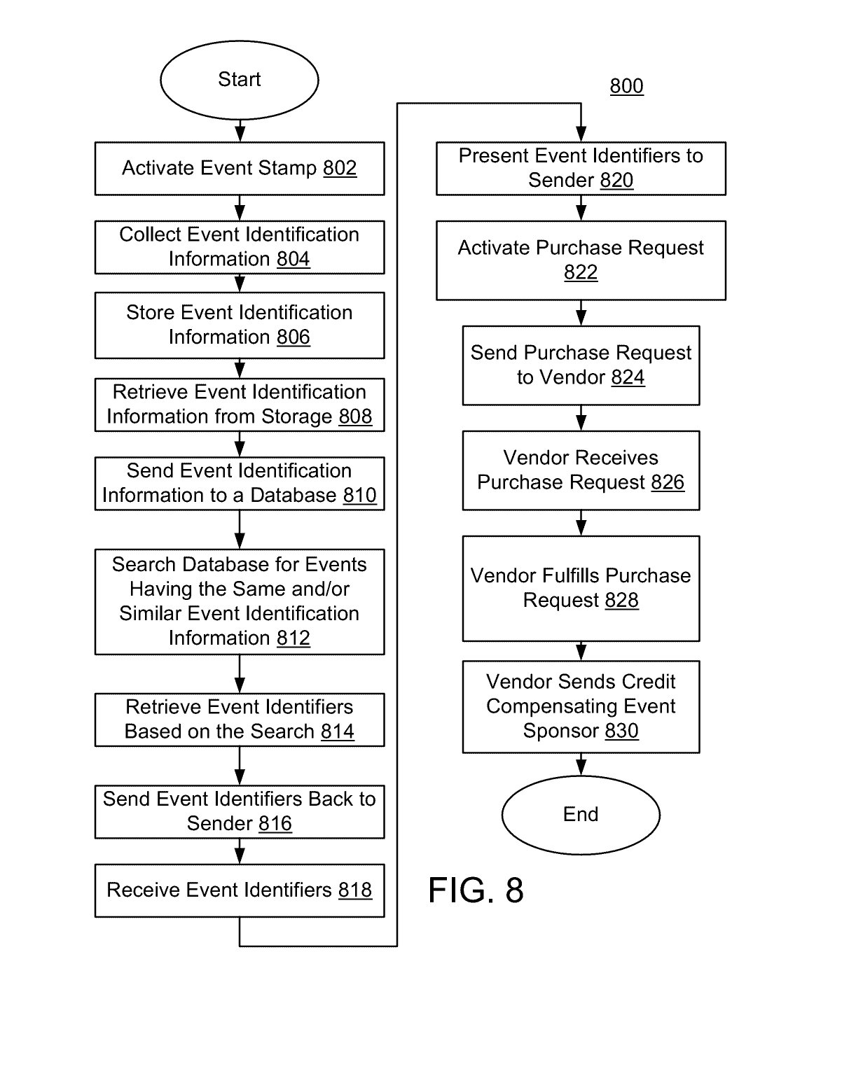

FIG. 8 shows a flowchart of an example of a method 800 of using an event stamp. In step 802, an event function is activated. Step 802 may involve activating event functions associated with input for identification information 224, input for identification information 328, input system 504, and/or activating event stamp buttons 106, 107b, 109b, 404, and/or 704.

In step 804, event stamp information is collected, which may involve retrieving the time from a clock, retrieving GPS information, retrieving profile information from a broadcast of a radio, television or other broadcast segment, recording a portion of a broadcast segment, measuring and recording a frequency and/or station to which a tuner is set, taking a picture, recording a voice message, measuring and recording a temperature, measuring and recording an altitude, and/or measuring and recording a pressure. In an alternative embodiment, all or part of the event stamp information is entered manually in addition, or instead of, performing steps 802 and 804. In step 806, the event stamp information is stored, which may involve storing the event stamp information in memory system 218, 322, and/or 506.

In step 808, the event stamp information is retrieved from storage. For example, while the user is involved in some activity, the user merely activates the event stamp, and then at a later time when the user is not involved in any particular activity, the user retrieves candidate event information based on the event stamp information. Alternatively, step 806 may be performed automatically or manually immediately after collecting the candidate event information (for example is step 804), in which case the event stamp information may never be stored in long term storage. If the event stamp information is not stored in long term storage, step 806 may only involve storing the event stamp information is short term storage (e.g., in the cache of the processor) or step 806 and 808 may be skipped.

In step 810, the event stamp information is sent to a database. Step 810 may involve sending the event stamp information from listening device 104, network appliance 106, keychain 107a, and/or mobile phone 109a to website host 112, which may then be forwarded to an appropriate database, such as database 114, and/or to one or more other databases associated with broadcast sources 116-124, airports 126a-n, train stations 128a-n, taxis, restaurants, hair cutteries (or barbers or beauty parlors), other shops and/or forms of entertainment, and/or vendors associated with advertisements. Alternatively, the event stamp information may be manually or automatically transferred from listening device 104, keychain 107a, and/or mobile phone 109a to network appliance 106 (which may be a computer or mobile phone, for example) prior to sending the event stamp information to the appropriate database (the transfer may also be from a first mobile phone that has an event function, but that is not capable of accessing website host 112 or database 114, to a second mobile phone that does have access).

In step 812, the appropriate one or more databases are searched, which may involve automatically formulating and sending a database query to the appropriate database and searching the appropriate database via a database server based on the query. In step 814, candidate event information is retrieved based on the search of step 812. In step 816, the candidate event information is sent back to listening device 104, network appliance 106, keychain 107a, and/or mobile phone 109a. In the case of network appliance 106, mobile phone 109a or any other network appliance having a display, a webpage including candidate event information may be sent (the webpage may also include advertisements related to the event stamp information and/or the candidate event information and/or the current location of the event identification device with respect to the advertiser). Some examples of the candidate event information are found and discussed in conjunction with FIGS. 4 and 6. In step 818, the candidate event information (and possibly an associated webpage) are received by listening device 104, network appliance 106, keychain 107a, and/or mobile phone 109a. In step 820, the candidate event information (and possibly an associated webpage) is presented to the user on the display of the user's network appliance.

In step 822, the user initializes a purchase, which may be based on the candidate event information. Step 822 may involve the user reviewing the candidate information presented, deciding which candidate event information corresponds to the event of interest. Deciding which candidate event information corresponds to the event of interest may involve a significant amount of interaction between the user, the network appliance being used, website host 112 and/or the appropriate database. For example, the user may hear and/or view sample clips associated the candidate event information before deciding which candidate event information is of interest. As a further example, the user may be presented with the candidate event information for three candidate events having the closest time to the time associated with the event stamp information. However, the user may decide that none of the three candidate events are the events of interest, and request candidate event information for candidate event that are associated with other times that are not as close as to the time associated with the event stamp as the candidate event information originally presented. At the end of step 822, the user selects a purchase icon, such as links 422-a-e, therein initiating a purchase.

In step 824, in response to the user selecting the purchase icon, the request is sent to the vendor. In step 826, the vendor receives the request. In response, in step 828, the vendor determines the product requested and sends the product to the user, therein fulfilling the user's request. In step 830, the vendor determines through which source the user became interested in the product sold. For example, the vendor determines which radio station the user heard the song or on which television stations the user saw a program, and the vendor sends the source a payment. Alternatively, a portion of the purchase price may go to website host 112, which may in turn send a payment to the source of the event, or the source of the event is compensated in another fashion. In yet another embodiment, no payment is sent to the source of the event. In an alternative embodiment and/or mode, all or part of steps 820-826 may be performed automatically without user intervention.

In an embodiment, each of the steps of method 800 is a distinct step. In another embodiment, although depicted as distinct steps in FIG. 8, step 802-830 may not be distinct steps. In other embodiments, method 800 may not have all of the above steps and/or may have other steps in addition to or instead of those listed above. The steps of method 800 may be performed in another order. Subsets of the steps listed above as part of method 800 may be used to form their own method.

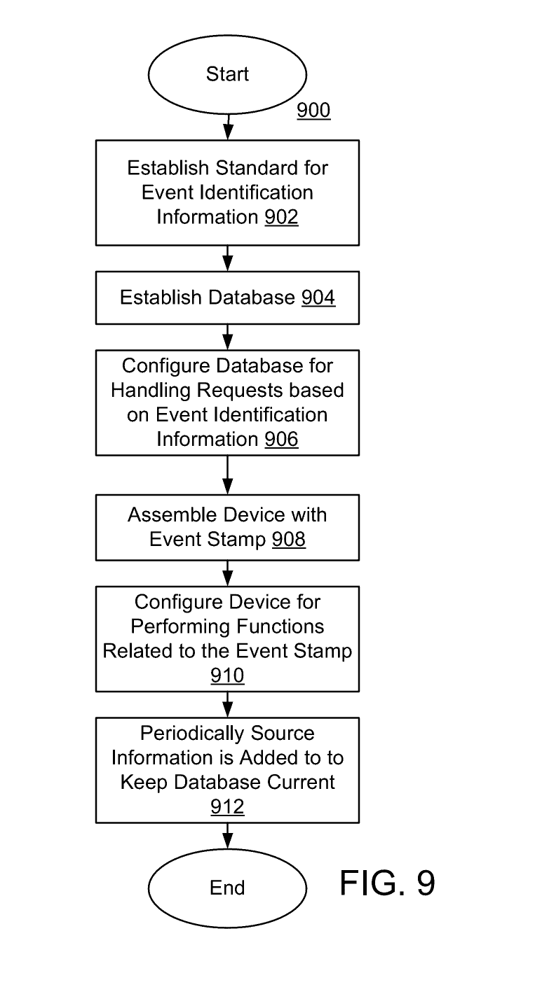

FIG. 9 is a flowchart of an example of a method 900 for establishing event identification system 100. In step 902, a standard may be established for event stamps. Having a standard for event stamps facilitates allowing a larger variety of participants than were no standard being used. By having a standard, each perspective participant may be reasonably sure of being capable of participating by conforming to the standard. The standard may include a minimal set of identifying pieces of information, an order in which the identifying pieces of information are stored in an event stamp, a location within a file or group of messages where the event stamp is stored and/or communicated. Different types of event stamps may have different standards. For example, event stamps for songs and programs may require a time, followed by a location, followed by a source of the event (e.g., a radio station or a television station). In contrast, the standard for a mode of transportation may include a time, followed by a location, where the location is a city or a street, followed by the type of transportation. Similarly, the standard for an advertisement may include a time, followed by where the advertisement was seen, heard, or otherwise observed (which may be a street, a form of transportation, a radio station, or a television station, followed by the type of transportation). Step 902 is optional, because event identification system 100 may be established without a standard for event stamps. For example, a proprietor may prefer not to have a publicly useable standard so that it is more difficult for competitors to compete. In step 904, a database is established (e.g., constructed or purchased) that for stores event data, such as database 114.

In step 906, the database is configured for handling requests for event information. For example, database 114 may be configured to automatically lookup retrieve and return event information in response to a request for information about an event. During step 906, database 114 may also be configured to automatically receive and/or request updates of information from a variety of vendors.

In step 908, identification devices, which may have event stamps, such as key chain 107a, mobile phone 109a, network appliance 106, and/or attachment 700 are constructed. If the identification device has an event stamp constructing the identification device includes installing and constructing the event stamp. In step 910, the identification devices are configured (e.g., programmed) for collecting the event stamp information, storing the event stamp information, retrieving the event stamp information, sending the event stamp information to a website host, receiving event information in reply, displaying the event information, sending a request to purchase items associated with the event, and/or receiving the purchased item.

In an embodiment, each of the steps of method 900 is a distinct step. In another embodiment, although depicted as distinct steps in FIG. 9, step 902-910 may not be distinct steps. In other embodiments, method 900 may not have all of the above steps and/or may have other steps in addition to or instead of those listed above. The steps of method 900 may be performed in another order. Subsets of the steps listed above as part of method 900 may be used to form their own method.

### Block Diagram of Mash Guide

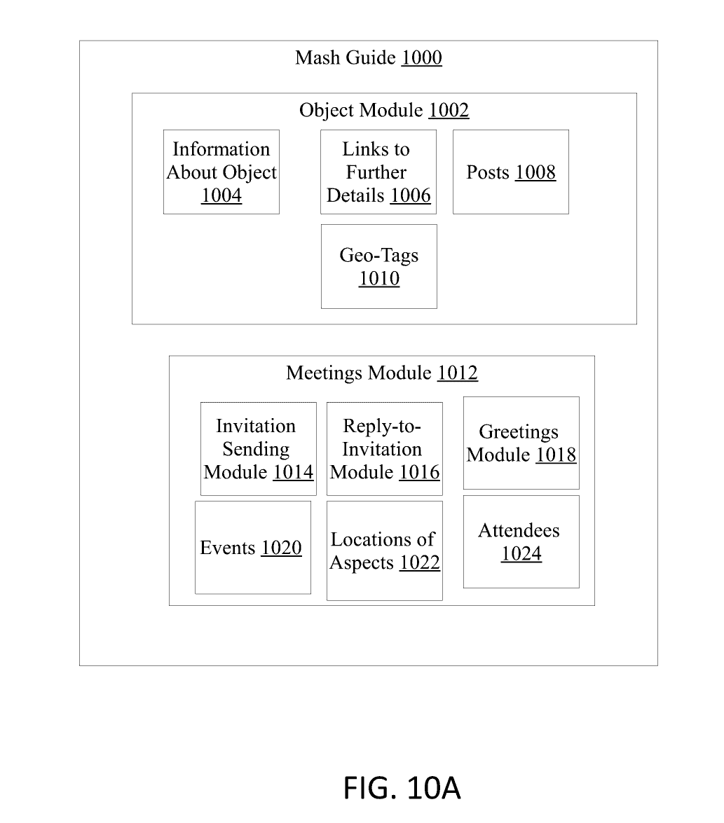

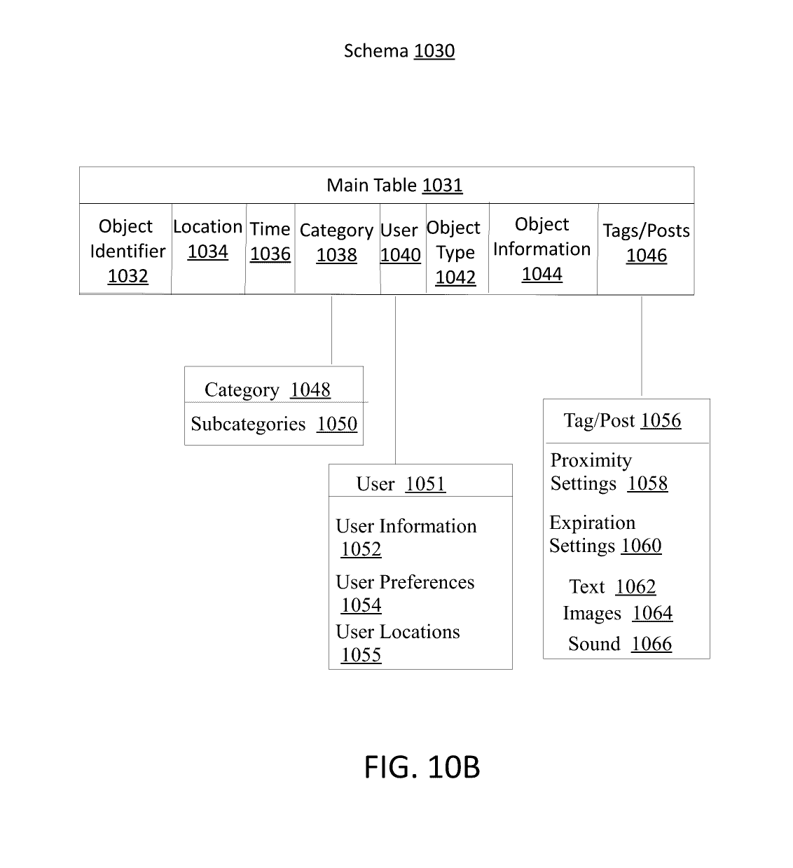

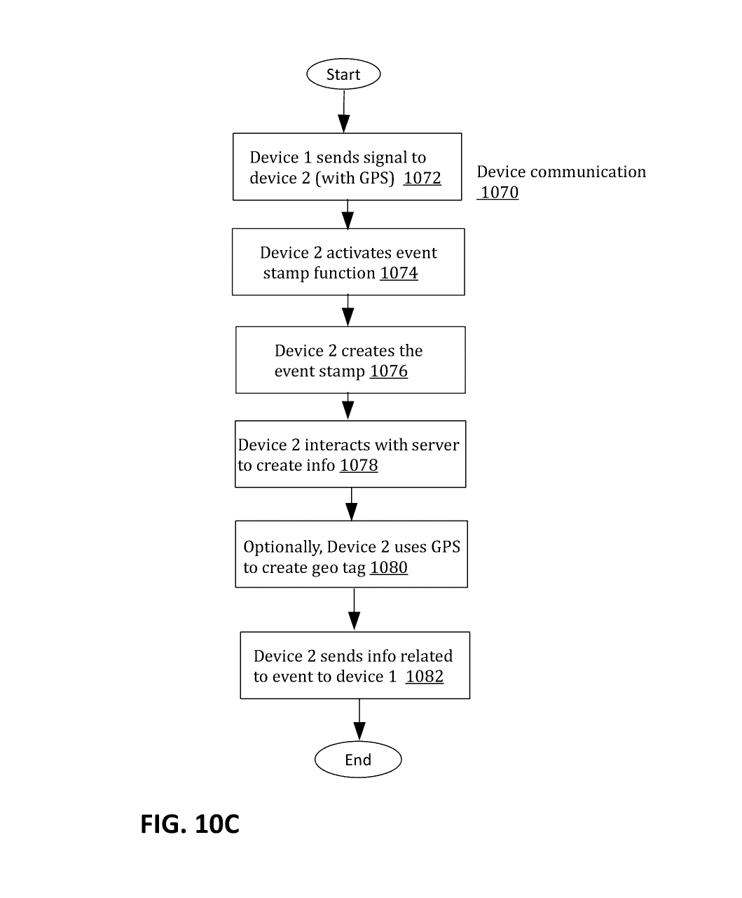

FIG. 10A shows a block diagram of an embodiment of a mash guide 1000 for an event identification system. Mash guide 1000 may include object modules 1002 having information about object 1004, links to further detail 1006, posts 1008, and geo-tags 1010. Mash guide 1000 may also include meetings modules 1012, which may include invitation sending module 1014, reply-to-invitation module 1016, greeting module 1018, events 1020, locations of aspects 1022, and attendees 1024.

### Hardware Configuration

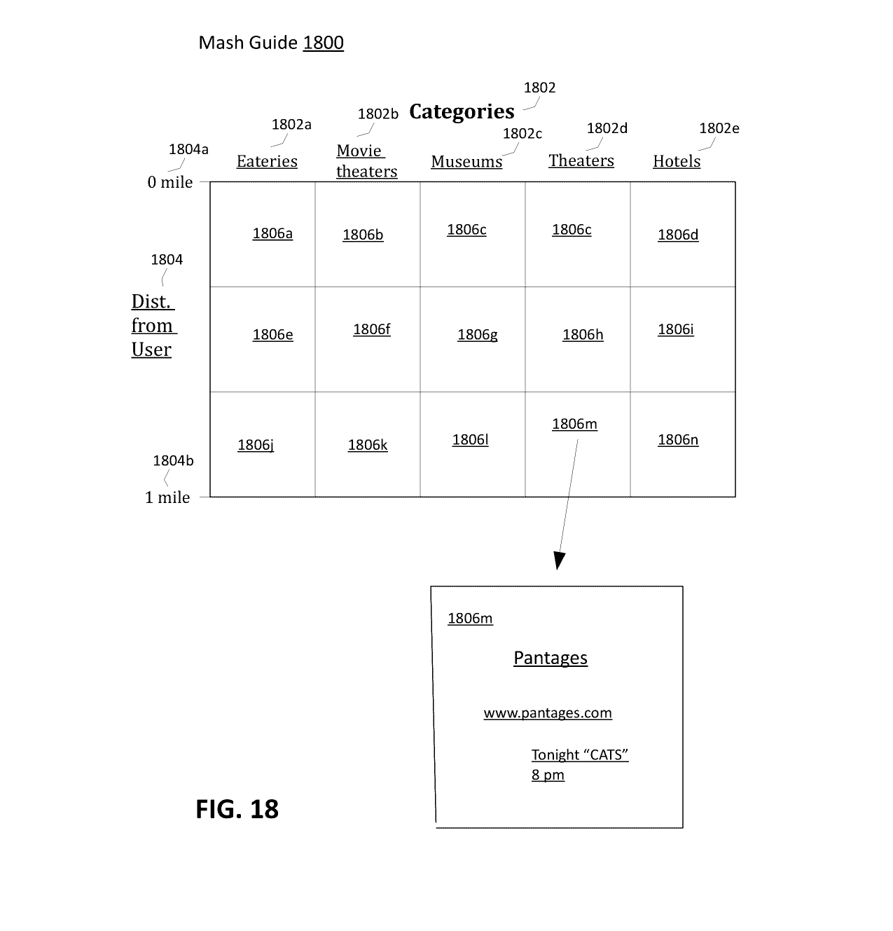

An embodiment of hardware used for implementing mash guide 1000 is discussed in conjunction with FIGS. 10C and 18, for example. However, as background to the discussion of mash guide 1000, that hardware is also briefly discussed here, leaving the further details that are not needed for the discussion of the mash guide to FIGS. 10C and 18. In an embodiment there may be system including a wearable device, a network appliance, and a server. In one embodiment, a GPS module is in the network appliance. In another embodiment, the GPS is in the wearable device in addition to, or instead of, being in the network appliance. The network appliance may be a mobile device, for example. The network appliance may provide a connection to the Internet for the wearable device. Page views, based on information provided by a server, may be sent from the network appliance to the wearable device. An event stamp button and/or event stamp function may be on and/or incorporated into the wearable device, but is not necessarily on the wearable device. Throughout this specification, it should be understood that whenever an event stamp button is mentioned, it could be a physical event stamp button or a virtual event stamp button.

For example, upon activating an event stamp button on the wearable device, the wearable device may communicate some or all of the event stamp information to the network appliance and/or the wearable device may request the network appliance to prepare event stamp information. For example, the event stamp function (and geo tagging, which is discussed below) may be triggered by a stand-alone event stamp button that is not on the wearable device and/or that is on the wearable device, and the wearable device may be used for viewing the results of activating the event stamp function. The result of activating the event stamp button may be: displaying to the user the event stamp information, allowing the user to add more event stamp information (e.g., a sound recording, additional descriptive text, still images, and/or a video) in addition to the event stamp information collected automatically, and/or performing a search for events that match the event stamp information. For example, the network appliance may be a phone (or other mobile device) and the wearable device may be a watch, where the mobile device provides the connection to the Internet for the watch, which may have an event stamp button. The phone sends the pages to the watch. The watch sends a signal that the event stamp button was pressed, and in response, the mobile device creates the event stamp, using GPS facilities on the mobile device for adding location information to the event stamp information and/or other search information.

### Mash Guide/Proximity Grid

Returning to the discussion of mash guide 1000, billboards and ads, such as those posted on buildings, at the side of roads, at bus stops, in train stations, in trains, in buses, and in taxis, have only a very limited amount of information. There are a lot of specialized applications for finding different types of location sensitive information, such as for movies, restaurants, and theaters, that are dedicated to finding a specific type of information or information that is associated with a particular company. However, there is no one place to find all of the location based information. The closest type of service that is available for uniting all of the different types of location based information are general purpose search engines (e.g., Google®), which search essentially static web pages.

Additionally, the search engines do not provide any information that is directly connected to specific billboards and ads. If one remembers enough of the information that is in the ad, when the user is in a location and situation that is amenable for formulating a search, the user may be able to do a search to find more information about the event, service or product in the advertisement. Although there is not a lot of resistance to performing a search or to opening one particular app related to one specific type of service, while traveling there is a lot of resistance to finding the one app that provides the desired type of information and/or for performing a search to get more information. Also, identifying multiple apps to get a variety of information related to a particular location can be cumbersome and time-consuming.

The proximity server provides information based on location regardless of the type of content, but the information is organized according to type of subject matter, so that the user may easily sort through and receive only the information of interest. Since the information is proximity based, the total amount of information is also limited. This further increases the ease of finding the desired information. This specification recognizes that a user is highly motivated to find certain types of information (which may be in an ad, for example), and the provider or a corresponding service, product, or event is highly motivated to provide the information regardless of how the user finds the information (whether or not the information is provided by the provider's specialized application or otherwise). Consequently, the providers are likely to be willing to provide information that populates the proximity grid. The proximity grid provides information from many different types of sources and of many different types discoverable in one location.

In an embodiment, the wearable device and/or network appliance retrieves from the proximity server and displays different objects that are grouped together and organized into guides, where each guide may include a different category of objects (each located at a different node of the mesh that form the mash guide) that are categorized by the subject-matter of the objects. In an embodiment, each guide is presented in a column (alternatively each guide is presented in a row) and each row (or alternatively each column) corresponds to a different distance and/or proximity. The guides may include links to multiple objects that are related to each other and that the user may scroll through.

In an embodiment, the user may combine guides, if desired. In other words, in an embodiment, a user may combine multiple guides together to return (e.g., in one column or row) objects that are at least related to all of the guides combined. For example, a user may be interested in seeing a movie and has not yet determined whether to see the movie at home or to see the movie at a theater, and consequently the user may want to search both nearby theaters and search services that rent movies simultaneously.

Note that the proximity grid is the grid of information that is posted in the system, whereas the mash guide 1000 is a specific manner in which the information is organized and presented to the user. In other words, the proximity grid is a network of places, establishments, people, businesses, public facilities (e.g., museums and parks), landmarks, etc. that have a grid card, via which users of the grid may locate entities and provide location-related information (as well as other information to others via the network. Mash guide is a guide to geo-tagged establishments and/or other entities that are available, via grid cards, to users. However, in this specification, the terms proximity grid and mash guide 1000 may be substituted one of the other to obtain different embodiments. Although the mash guide and proximity grid are not the same thing, one may substitute one term for the other where ever one of the two terms occur and obtain different embodiments.

In an embodiment, some or all of the objects in the mash guide 1000 may be based on event information, such as from event stamps, that are entered by individual users (which may later be searched for using event stamp information). In an embodiment, the user may select a particular object and be directed to additional information to learn more about the object. In an embodiment, in response to the user selecting a particular object and being directed to additional information to learn about the objects, the user may also be provided with an option to upload a user response about the object.

Optionally, the user posted information may be temporary and disappear after a period of time. Whether the posting is permanent or temporary and/or the duration of time of the posting may be based on user choices, event-provider input, and/or the choices of an administrator of a proximity server. In an embodiment, the user may set the user response to disappear after a period of time. The user may or may not be able to set the specific amount of time. In an embodiment, a user associated with an establishment related to an object may leave a user response that may include at least promotional offers and/or time sensitive information that relates to the object.

In an embodiment, the user provided information includes various user ratings, user comments, user provided sound recordings, user provided images (e.g., still images and/or video images), and/or other user provided information about the object that the user may optionally be able to listen to, read, and/or view. In this specification, the term image is generic to both still images and videos images. Whenever the term image is used, a video and/or still image may be substituted to obtain specific embodiments. In other words, the user response may include at least a rating based on a set scale, a text message left by the user, user provided images and/or a voice message left by the user.

In an embodiment, one may push a button and receive a grid or mesh having an arrangement of grid cards, which the user may navigate through, where the particular cards that are displayed are based on a user's preferences, the current time, and/or location.

In an embodiment, the mash guide 1000 may be used and searched without usage of any event stamp function or event stamp information, without usage of a smart phone and/or wearable device. For example, when the user accesses the mash guide 1000, the server may choose which objects to present to the user based on prior chosen preferences and/or the user's current location. Alternatively, or additionally, the user may have an option of inputting various parameters manually to perform a search and/or of having a search automatically performed based on information in an event stamp.

In an embodiment, event information (e.g., related to a physical object at a location) may be stored in response to activating an event stamp function. In response to activating an event stamp function, multiple types of event information are collected from a user. Event information that may be collected may include location information including GPS coordinates, time, user inputs including voice and images, and contextual information. In response to collecting the event information, the device displays multiple objects, which may be based at least in part on the event information. Based on the object displayed, the user may decide which of the objects corresponds to the event information collected as part of the event stamp. The physical object may be tagged with comments from the user collecting the event stamp information and/or from others that access the mash guide 1000.

An object module 1002 may be a module representing objects that are stored and presented to users viewing the mash guide 1000. The object represented by object modules 1002 may be any location based entity. There may be any number of object and type of objects in the mash guide 1000. For example, there may be objects representing landmarks, billboards, stores, museums, parks, historic sites, transportation stations (e.g., airports, airline terminals, bus stations, bus routes, buses, airline routes, airplanes, airlines, trains, train companies, train routes, and railroad tracks), professional service, professionals, individual people, entertainment, theaters, movies, movie theaters, eateries, barbers, hair stylists, stores, and/or circuses.

### Geo-Cards and Geo-Ramps

Objects modules 1002 may include geo-cards and/or geo-on ramps that may be visible to the user when the user first views the object in the mash guide, which may include basic information about the object and links to further information about the object. The geo-card may be referred to as a card, grid card, proximity card, or proximity grid card. Wherever the phrase card, geo-card, grid card, proximity card, or proximity grid card occur one can be substituted for the other to obtain another embodiment. In an embodiment, those posting information, such as by creating a node, grid card, or mesh point of the mash guide 1000, provide at least a card (e.g., the grid card), which may be an object in objects modules 1002. The card may be returned to a user in response to performing a location based search (which may also be referred to as a geo search), which is a search for an item of interest (e.g., an event, person, and/or place) that is within a particular vicinity of interest. Further, data may also be available by clicking on links provided with the card.

In an embodiment, each posting has a geo-ramp (which is one of the objects of object modules 1002). The geo-ramp is the initial information provided about the item of interest, which is intended to induce the user to ask for more data. A program is provided, via which an individual user can quickly create a card. The card could be sent to people anywhere, but some of the information on the card may only be available when within a certain distance of a location (e.g., as a security check). The card has a geo tag, which in an embodiment must be created while at the location that is associated with the geo tag, but the geo-tag could be associated with the card at another location and/or time.

In an embodiment, each block or node of the mesh of the mash guide 1000 is a geo-card or grid card. For example, each store, vendor, theater, museum, eatery, landmark or other establishment in a particular vicinity (e.g., a village square) may have a separate geo-card and/or geo ramp that is visible to the user while the user is within a certain proximity of the location of that establishment. The number of geo-cards that are presented to the user and/or that are presented on the same page may depend on the user-determined proximity settings. In another embodiment, the mash guide 1000 may be a mixture of geo-cards and other objects. In yet another embodiment, a collection of geo-cards may be stored in a database in a searchable format that is unrelated to the mash guide 1000. Some of the information and/or geo-tags may only be available during certain times of the day. For example, a user may run a hot dog stand that is only open during certain hours of the day and the corresponding geo-tag is only discoverable during those times of the day that the hot dog stand is open.

In an embodiment, geo-tags may be placed on a social media site, which limits the visibility of the comments on the social media site to users within a predetermined vicinity of a location associated with the geo-tag. In an embodiment, the geo-tag may be used to prioritize search results according to location. For example, the content on the social media site may appear as a node of a mesh or grid (such as a mash guide 1000) in which the nodes of the mesh are that are further from the top and/or left sides of the page are associated with locations that are further from a particular location of interest, such as the user's current location or a location that the user plans on visiting. In an embodiment, one geo-tag may be an entire social media site, so that the entire site is only visible when the location of interest is within a predetermined vicinity of the location associated with the geo-tag. Additionally, or alternatively, individual portions of the social media site have separate geo-tags. For example, individual comments, individual posts, individual pages, and/or individual users may have different geo-tags each associated with a location that is allowed to be different from the other locations of the other geo tags. In an embodiment in which the social media site, as a whole, has a geo location, the geo-tags of the individual parts of the geo-site may be restricted to be within a certain vicinity of the location of the geo-tag for the site as-a-whole, which may be the vicinity that is associated with a location of an event, a store, an establishment, and/or a site of interest associated with the site, for example. Similarly, in an embodiment in which an element social media site has a geo-tag (or geo-location), the geo-tags of the individual sub-elements of that element may be restricted to be within a certain vicinity of the location associated with the geo-tag for the element as-a-whole, which may be the vicinity that is associated with a portion of a location of an event, a portion of a store, a portion of an establishment, and/or a portion of a site of interest associated with the element, for example.

Information about object 1004 is descriptive information about the entity represented by the object. For example, the information may include times of availability, contact information, phone number, e-mail address, website, a description of the services and/or products provided by the entity, and/or promotional offers. Links to further detail 1006 may include links that provide further information about the entity represented by the object. For example, the links to further information may include a link to another page that is part of the mash guide that provides more detailed information, or a link to a webpage and/or website that provides further information about the entity.

Posts 1008 may include objects that were posted by someone that is associated with the entity and/or objects posted by other users, such as comments critiquing the entity and/or helpful information about the entity.

Geo-tags 1010 may be location based tags that are associated with the object, with comments posted by users about the object, with different aspects and information about those aspects of the object. For example, the object may have one geo tag associated with the object as a whole, which determines the vicinity associated with the object in the mash guide. Various rooms and/or exhibits within an establishment represented by the object may have different geo tags that associate a vicinity with those rooms and/or exhibits, which may determine when that information appears in the mash guide in association with the object.

Meetings module 1012 is one specific type of object that represents meetings. Meetings 1012 may include all of the features of one of the object modules of object modules 1002. Meetings module 1012 may include tools for setting up a meeting, tools for adding descriptive information about the meeting, tools for associating the meeting with a location, and tools for associating the meeting with a time. Meetings 1012 may include tools for entering an agenda to the meeting, and entering sessions, session times, session locations, session topics, and/or session speakers.

Invitation sending module 1014 may include tools for preparing and sending invitations and/or other announcements to interested parties. The invitation may include the time, place, agenda, schedule, sessions, activities, and/or speakers of the meeting.

Reply-to-invitation module 1016 may include software that the attendees can download and use to indicate whether the user is attending the meeting. Reply-to-invitation module 1016 may also include a module that automatically sends multiple messages with updates about the attendees estimated time of arrival, progress in traveling to the meeting, and/or current location.

Greeting module 1018 may include tools for the organizer of the meeting to post greeting messages that are presented and/or visible to the attendee upon arrival at the meeting. The messages may also include information about updates to the meeting, the current happenings at the meeting, and changes in locations of the meeting or of events associated with the meeting. Whether or not the greeting messages of the greetings module 1018 are visible to the attendees may be determined by a geo tag associated with the greeting messages, the location of the attendee and the current time. Different events within the meeting may have their own greeting messages that have their own geo tags associated with the greeting messages, and whose visibility may also be determined by the event specific geo-tag, the location of the attendee, and the current time.

Events 1020 may include a list of events associated with the activities and information about the events. Optionally, some or all of the information about the event may include geo tags that determine whether the user can view the information about the event depending on the user's location. Locations of aspects 1022 may include the locations of the meeting, the location of different events of the meeting and/or the location of different sessions of the meeting. Locations in the locations of aspects 1022 may include GPS coordinates and/or other coordinates for determining the locations of interest. Locations of aspects 1022 may include geo tags associated with the meeting. Attendees 1024 may include information about attendees of the meeting. Each attendee may be given a page on which others may post messages and/or the attendee may post messages. Attendees 1024 may include information about the attendee that other attendees and/or the host of the meeting may view. Attendees 1024 may include public and/or private location information about the attendees, which other attendees and/or the host may use to locate the attendee and/or meet with the attendee.

### Schema

FIG. 10B shows a representation of an entity relationship diagram of an embodiment of a schema 1030 for an event identification system of FIG. 10A. Schema 1030 may include main table 1031 having object identifiers 1032, locations 1034, times 1036, categories 1038, users 1040, object types 1042, object information 1044, and tags/posts 1046. Schema 1030 may also include category 1048 having subcategories 1050 and user 1051 having user information 1052, user preferences 1054, and user location 1055. Schema 1030 may also include tags/posts 1056, having proximity settings 1058, expiration settings 1060, text 1062, images 1064, and/or sound 1066.

Schema 1030 is just one example of a manner of storing and organizing the data in the mash guide. In an embodiment, schema 1030 is a relational database. However, other types of databases may be used instead.

Main table 1031 is a table representation of a database object that represents the content of the mash guide. In the embodiment of FIG. 10B, a star schema is used (although in other embodiments another schema may be used) in which the keys of the main table 1031 link to other tables that provide more information about the information associated with that key of the main table 1031. The columns of the main table 1031 represent the attributes of main table 1031. Each column of main table 1031 may be a key in one or more other tables that contain more information about the attribute represented by that column.

Object identifiers 1032 are a list of identifiers that identify the individual object of the mash guide. In an embodiment, each object identifier of object identifiers 1032 may be just a numerical or alpha numerical value that the database uses to identify the object. In an embodiment, each object identifier 1032 is a unique value that is used to only identify one object. In an embodiment, the column for object identifies 1032 is a primary key for main table 1031. Each object identifier uniquely identifies a record of the database, which contains more information about the object identified by the object identifier. There may be other tables that include more information about the objects associated with object identifier 1032.

Locations 1034 are locations associated with the objects of object identifiers 1032. Each object may be associated with multiple locations. For example, if the object is a franchise (e.g., a chain of movie theaters) or an establishment with many branches (e.g., a library system) each branch or franchise may have a different location associated with the object. Similarly, an establishment having many rooms and/or exhibits in different locations may have multiple locations associated with the object representing the establishment, one location for each room and/or exhibit. Some objects may have multiple locations for multiple branches and each branch may have multiple locations associated with different rooms and/or exhibits (e.g., a system of museums). Also, sometimes two object may have the same location, if the two objects are close enough to one another, or if the resolution of the location coordinates available is too low to distinguish between the two locations. The location determines the vicinity within which the object is visible within the mash guide and/or the ranking/position of the object within a guide of the mash guide.

Times 1036 are the times associated with the objects of object identifiers 1032. Times 1036 may determine the times at which the information about objects associated with object identifiers 1032 is visible to users. Each object may be associated with multiple times 1032. For example, if the establishment associated with the object has a complicated schedule of when the establishment is open and closed. The times may include an hour of the day, the day of the week, the day of the month, and/or the day of the year to account for different days having different schedules. Similarly, an establishment with many locations (e.g., many franchises) or an establishment with many branches (e.g., a library system) may have different times associated with the object as a result of having different schedules. Also, an establishment having many rooms and/or exhibits with different schedules, may have multiple times associated with the object representing the establishment, including a different set of times for each room and/or exhibit. Some objects may have multiple times for multiple branches and each branch may have multiple times associated with different rooms and/or exhibits (e.g., a system of museums). Also, two object may have some of the same times and/or the same set of times if the two objects have similar or the same schedules. The times 1036 may determine the times within which the object is visible within the mash guide and/or the ranking/position of the object within a guide of the mash guide.

Categories 1038 are the categories associated with the objects. Categories 1038 may include sub-categories of the categories. Some categories may be entertainment, theater, movies, sports arenas, ice skating rinks, ski resorts, museums, food, grocery stores, restaurants, fast food stores, coffee shops, pubs, bagel places, diners, ice cream parlors, education, schools, colleges, universities, high schools, elementary schools, preschools, after school care and/or enrichment centers, day care centers, household goods, furniture stores, hardware stores, computer stores, office supply stores, sporting goods stores, gyms, banks, restrooms, urgent care hospitals, clothing stores, and/or toys.

Users 1040 may include the users that are registered with the system. Each user may have a separate column, which may indicate which objects and/or categories of objects the user is interested in seeing. Users 1040 may indicate which categories the user wants grouped together as one category. For example, the categories and/or objects that a given user is not interested in seeing may be marked with a zero. Each category that the user is interested in seeing may be marked with a different number, and those categories that the user wants grouped together may be given the same number. The number used may indicate a hierarchy based on the interest of the user.

Object types 1042 may indicate something about the type of establishment represented by the object. For example, a person and a store may have different object types 1042. Some examples of object types 1042 may include entertainment, food, educational, commercial, and/or free.

Object information 1044 may include descriptive information about the establishment represented by the object. For example, object information 1044 may include a description the type and quality of the services and/or products offered by the establishment, upcoming events, sales, and a schedule of times that the establishment is open. Object information may be included as sound, text, and/or image information.

Tags/posts 1046 may include tags and/or posts that were posted by various users, who may be members of the general public and/or individuals that represent the establishment, such as a manager, officer, host, and/or owner of the establishment.

Category 1048 is a table of categories that includes further information about the categories. In an embodiment, the information in key categories 1038 is a primary key of the table categories 1048. Each category of categories 1048 may represent a different category listed in categories 1038. For example, category 1038 may just include a list of numerical identifiers of the categories, and the rest of the information about the category may be in table category 1048. The category represented by category 1048 may be a subcategory listed in categories 1038. Subcategories 1050 are the subcategories of category 1048 (which in turn may be a subcategory listed in categories 1038 as a subcategory of one of the categories of categories 1038).

User 1051 may be a table of users that includes further information about each user (e.g., user table 1051). Each user in the user table 1051 may correspond to one of the users of users 1040. For example, user 1040 may just include a list of numerical identifiers of the users, and the rest of the information about the users may be in user table 1051. An organization may be one of the users of users 1040, and may have several individuals associated with the organization that are users as a result of being members of the organization. In which case, the corresponding record of user table 1051 may include a list of individuals of that organization that are users as a result of the organization being a user.

User information 1052 may include information about user 1051, which may include the user's name, profession, marital status, hobbies, likes, and dislikes, and/or contact information. Alternatively, if the user is an organization, the information may be about the organization.

User preferences 1054 may include user chosen preferences, such as which guides to combine together, which guides to show the user, and/or expiration time of the user's comments, for example.

User location 1055 may be the current location coordinates of the user. User location 1055 may be used to determine whether the user is within a predetermined vicinity of an establishment represented by an object. User location 1055 may be used in combination with locations 1034 to determine whether to show an object to the user and/or the order in which to present the object to the user.

Tags/posts 1056 is a table of tags and posts that users add to the object and/or elements of objects of the mash guide, which provide further information about the tags and/or posts than tags/posts 1046. In an embodiment, the key tags/posts 1046 of table 1031 may be the primary key of the table tags/posts 1046. For example, tags/posts 1056 may just include a list of numerical identifiers of the tags/posts, and the rest of the information about the tags/posts may be in table tags/posts 1046.

Proximity settings 1058 are the settings that determine the vicinity within which the tag or post becomes visible to the user. For example, when the difference between the location coordinates associated with the tag and/or post is less than a specific magnitude set by proximity settings 1058, the tag and/or post is made visible to the user. In an embodiment the proximity setting 1058 may allow the user to set a proximity that corresponds to any of a variety of shapes (e.g., circle, oval, rectangle, polygon, trapezoid, and/or rhombus), and if the user's coordinates are within that vicinity having the specified shape, the tag and/or post becomes visible to the user.

Expiration settings 1060 are settings that determine when the tag and/or post expires and is no longer visible to any user no matter where that user is located. The expiration settings may be set by the provider of the event and/or establishment and/or by the user posting the post and/or tag.

Text 1062 is the text that is included in the tag or post, which expresses the thought that the user wishes to convey. Images 1064 are any pictures, still of video images, or any other images that the user wishes to upload and include in the tag and/or post. The images may help clarify the message in the text and/or may convey another message. Sound 1066 is the sound that the user wishes to associate with the tag and/or post. Sound 1066 may be any sound that is intended to accompany text 1062 and/or images 1064. Optionally sound 1066 may carry its own message unrelated to and/or unaccompanied by any text and/or images. For example, sound 1066 may be a voice recording. In an embodiment, if sound 1066 includes a voice recording, sound 1066 is converted to text automatically or at the user's request.

In an alternative embodiment, each category of category 1038 may have its own table category 1048 having the information provided by the table category 1048, each user of users 1040 may have their own table having the information provided by the table user 1051, and/or each tag/post of tag/post 1046 has its own table tag/post 1056 having the information provided by the table tag/post 1056.

### Device Communications

FIG. 10C shows a flowchart of an example of method 1070, which is a method of device communication. Method 1070 may be used in an embodiment of a method for establishing the event identification system of FIG. 10C (which may be an embodiment of the system of FIG. 1) in which a mobile device communicates with a second device. The device communication may be implemented on any network appliance, including a smart watch, a cellular phone (e.g., smart phone), tablet computer, laptop, or desktop, for example. Method 1070 allows a user possessing a watch or smart watch that does not have all of the functions of a smart phone to still be able to use the event identification system. In an embodiment, the smart watch performs some of the functions related to the event stamp function while the smart phone performs other functions related to the event stamp function. In an embodiment, the smart watch includes an event stamp button. In an embodiment, the smart watch includes an interface having virtual and/or hardwired input buttons and a display.

In this specification, the term item of interest may refer to an event, person, place, and/or any item of interest.

In step 1072, the user presses a physical or a virtual event stamp button device 1, and in response device 1 sends a signal to device 2. In an embodiment, only one of devices 1 and 2 contain GPS, which is device 2. In an embodiment, device 1 is a watch. In an embodiment, device 2 is a smart telephone with GPS. In the embodiment in which device 1 is a watch and device 2 is smart phone, the watch may not necessarily have any connection to any network, but can only communicate with the smart phone. In an embodiment, the watch has an event stamp button on it. The event stamp function may be located on device 1 or device 2 or another device. In an embodiment, the user activates an event stamp button. As a result, device 1 activates an event stamp function. Optionally, device 1 may request GPS information from device 2 to include in the event stamp information. Then device 1 may send a signal to the device 2 to perform a search based on the event stamp information. Alternatively, device 1 may send a signal to device 2, requesting device 2 to active the event stamp function. In an embodiment, device 1 (e.g., the smart watch) sends signals via a local communication channel and/or local network to device 2 (smart phone). In an embodiment, device 1 (e.g., a smart watch) may send the time of the event to device 2 as part of the activation signal which device 2 incorporates into the event stamp. The time of the event stamp may be the time at which the event stamp button was activated.

In step 1074, device 2 activates the event stamp function based on the signal from device 1. In an embodiment, event stamp information (e.g., related to a physical object at a location) may be stored in response to activating an event stamp function. The event stamp has been discussed in reference to the event identification system 100 of FIG. 1. In response to activating an event stamp function, multiple types of event stamp information may be collected from a user. The event stamp information that may be collected may include location information including GPS coordinates, time, user inputs, including voice and images, and contextual information, for example. The location information can be input by the User. Optionally, the device 2 contains GPS, and in response to activating the event stamp function, device 2 automatically determines the location of the user at the time of the activation of the event stamp button. As part of the activation, the user may also indicate more information about the event, including but not limited to, a photo, a voice description, a sound description, etc. In an alternative embodiment, device 1 may implement the event stamp function and just obtain the location information from device 2, if device 1 does not have GPS or another mechanism of automatically determining the current location.

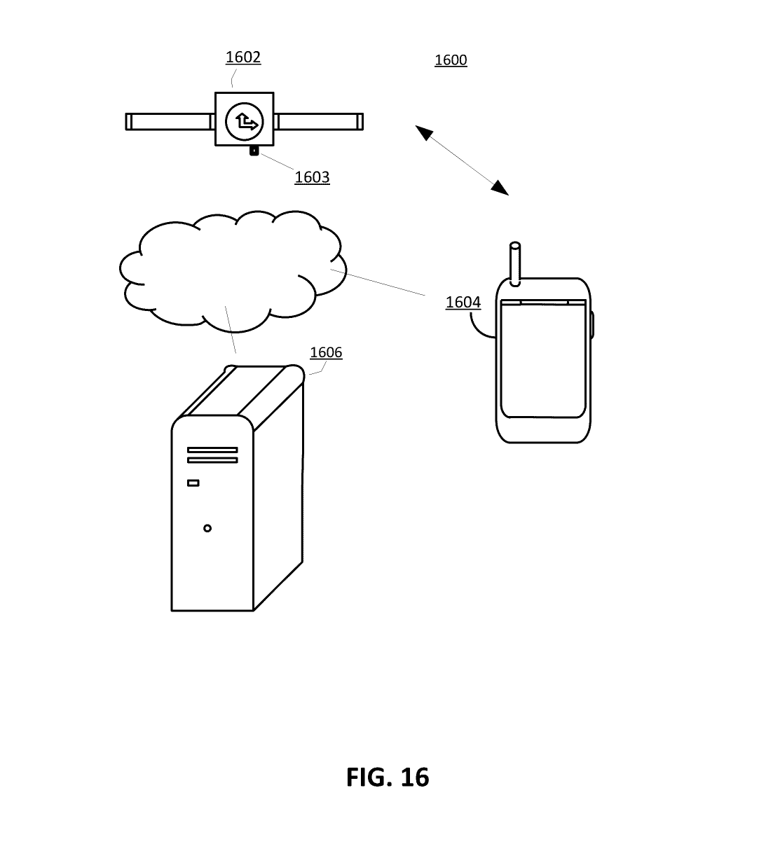

In step 1076, device 2 creates the event stamp. Device 2 places the information of the event stamp into the event stamp format. The event stamp has been discussed with reference to FIG. 1 in the event identification system 100. An example of communications between device 1, device 2 and a proximity server will be discussed in conjunction with FIG. 16, below. In step 1077(a), in an embodiment, the event stamp information is sent to a proximity server to perform a search, based on the event stamp information. In step 1077(b), device 2 receives the results of the search in which the information returned (which is based on the event stamp function) is organized in a mesh. The details of the mesh were discussed in conjunction FIGS. 10A and 10B and are discussed further in conjunction with FIG. 18, for example. If one is interested in a particular type of event, one can likely find it on the internet. However, there is no single location where one can go to find all the types of things that one is interested in, and that will also return information of interest that was not specifically requested and that is related to the user's immediate environment. The mash guide, by default, shows the user topics of interest organized according to location. If the user wants to perform a search, a search can be performed on the database of the mash guide, which will return information about the content searched that is organized according to location.

There may be a metadata structure that is added to each object to help categorize the objects/events. There may also be member posted events, which could be personal parties that are open to mash guide members. The database may include a media layer, which may include voice and image. By allowing the user to post voice reviews, there is less resistance to posting reviews, and the user may be more likely to post good reviews. Also, if there is less resistance to posting information, the owner of an establishment may be more likely to post promotional offers. In an embodiment, posts that are more recent may be highlighted, such as by having the post flash or be in a particular color or labeled as recent. There may be a tag on an object that indicates that there is a geo tag with more information about the object, and the user could go to their mash guide search for the geo tag and/or object having the geo tag and listen to the recording. For example, in places where a phone number is provided for providing more information, there could also be a geo tag. In step 1078, device 2 sends information related to the event to device 1. Device 2 then transmits the results of the event stamp function to device 1 for the user to analyze. The user may choose to find out more information about one or more of the objects. In an embodiment, the page views based on the event may be sent to the watch. Data can include data about objects, data from individual users, data from special services (e.g., Fandango), and data associated with items of fixed location, such as historical landmarks or billboards (the billboard advertiser and/or owner may provide the proximity server with information about the location and content of each billboard and ad).

In optional step 1080, the user is presented with an option to post a geo tag related to the location associated with the event stamp. The geo tag is created using device 1 and/or device 2, by posting information related to a location in association with that location. Posting a geotag may involve the following steps. First device 1 and/or 2 presents the option to post a geo tag to the user and the user enters the information. Then a message having the information for the geo tag is sent from device 1 to device 2 and then to the server. The server then posts the information and associates the information with the location. In an embodiment, the information in the geo tag is only made available to users that are within a certain vicinity of the location associated with the geo-tag. Geo-tagging organizes information based on the location of the device (device 1) so that different data is available depending on the user's proximity to various locations.

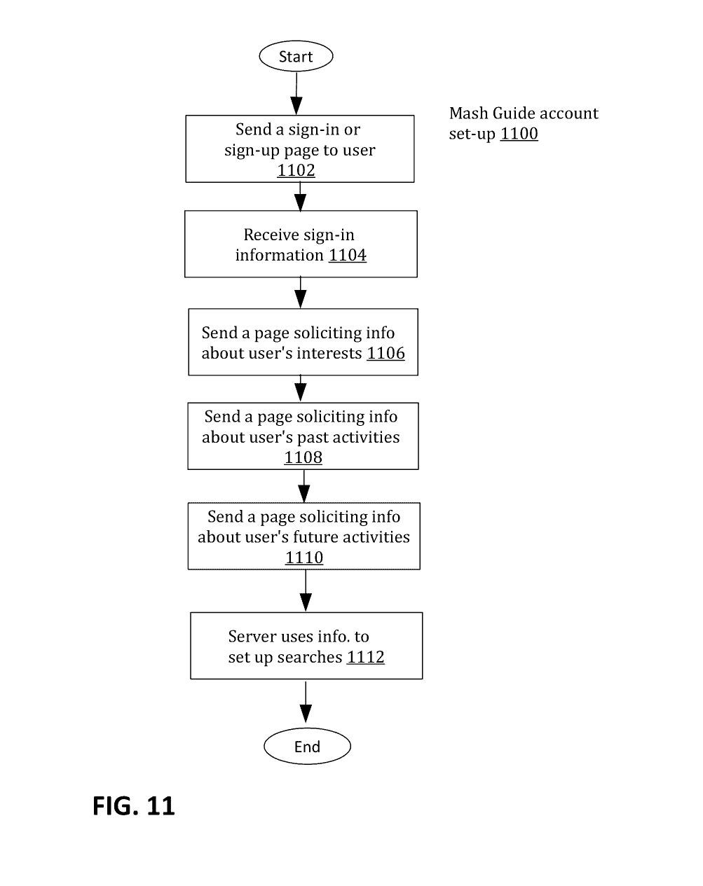

In step 1082, device 2 sends the information related to an event from the server to device 1. The information from the server is based on an event stamp function, a mash guide, a meeting, a mob cast, etc. The event identification system allows a user to learn about the user's immediate environment in real-time on any type of device. The mash guide is a mesh of blocks of information about different events (in other words the blocks may be arranged in a mesh). The blocks in the mesh may be arranged according to category, location, and/or time of event to aid the user in sifting through the information in the mash guide. Mash guides will be discussed further in conjunction with FIG. 11 (in the introduction to flowchart 1100) and FIG. 16.

In an embodiment, each of the steps of method 1070 is a distinct step. In another embodiment, although depicted as distinct steps in FIG. 10C, step 1072-1082 may not be distinct steps. In other embodiments, method 1070 may not have all of the above steps and/or may have other steps in addition to or instead of those listed above. The steps of method 1070 may be performed in another order. Subsets of the steps listed above as part of method 1070 may be used to form their own method.

### Meet Ups (Meeting Greeting Cloud)

A user, such as the host of a meeting, other person responsible for organizing the meeting or other interested party, may post a piece of information about a meeting that is updatable in real time. The meetings may be added to the mash guide or may be stored in a separate database for meetings. In an embodiment, the home page representing a meeting could is a geo card. In another embodiment, the home page representing a meeting is not necessarily a geo card.

There may be a downloadable app and/or a node in a mesh (e.g., in a mash guide or proximity grid), to help one find a location, and the node may have posts. When one arrives within a vicinity of the location, the user may receive a welcome message (e.g., “Welcome John! Thank you for coming.”), updates about the meeting, information about what is currently happening at the meeting (e.g., the wedding ceremony will start in ten minutes), and/or instructions about where to go and how to find the room or group of rooms where the meeting is currently being held. As another example, as a user Sam is pulling in to the location associated with the event, such as the driveway of a house that is hosting a meeting, the system may send a message “Hey, Sam welcome! Everyone is in the backyard.”

The system may include options for a host to send invitations, invites, and/or e-mails announcing an event and optionally requesting an RSVP. Once the user arrives at the meeting, information is available that can be accessed via a mobile device, and can be updated in real time to accommodate last minute changes in the details of the meeting. There may be two or more levels of being present, such as nearby and checked in. The user may be also able to post and update an expected time of arrival. Although twitter can be used for posting comments about an event, the comments are not organized in any manner. People attending an event can post what is happening and a user could track what just their friends have to say about the event. After the event ended, possibly nothing can be posted to the event.

### Send it Once

Optionally, as part of the meeting greeting feature (or as a stand-alone feature), when a user activates an invitation to an event, the invitation or a reply to an invitation may create an object or add an element to an object that shows whether the user is nearby and/or checked-in. the object may be visible to the host (or other interested party) and may show a list of expected attendees the status of each attendee, such as where the attendee is currently (how far the attendee is from the meeting and/or whether the attendee has arrived). The user may choose to allow others to see the estimated time and location for the user's approach. There may be a one-time tracker arrival object, which automatically announces when the user is within a certain predetermined time and/or distance from the user's destination. For example, after the user sends a message that the user is on the way, a message may be automatically sent when the user is ten minutes away and/or five minutes away etc. In other words, the user sends an RSVP or an indication that the user is about to come to the meeting, just once, and automatically multiple updates of the user's progress to the meeting is tracked and updated periodically and/or at predetermined distance intervals.

For example, a first user may select a first object (e.g., an RSVP to a meeting or an I-am-on-my-way indicator) from a guide (e.g., a mash guide). In response, automatically, the selection of the first object triggers the sending of a second object (e.g., a message saying I am only 5 miles away) to other users, where the second object is based at least in part on the first object. In an embodiment, in response to sending the first object, other users will receive multiple subsequent objects that may be based at least in part on the first object. In an embodiment, the multiple subsequent objects are sent to the other users at predetermined times and/or distances (e.g., I am 5 miles away and I am 1 mile away or I am a half an hour away and I am 5 minutes away), where the predetermined times and/or distances may relate to the first user's estimated time of arrival, an interval of time, and/or a distance of travel. In an embodiment, the multiple subsequent objects provide location information of the first user, which may at least include the GPS location (a street location, or other indication of location) of the user.

More about Meeting-Greetings

In an embodiment, the category of a mash guide may relate to an interaction between one or more users, where the objects contained within the mash guide may include objects that at least relate to the interaction. In an embodiment, the interaction between one or more users may relate to a meeting between one or more users. In an embodiment, the objects related to a meeting may provide real-time updates of information about the meeting that is of interest to a user. In an embodiment, the real-time updates about the meeting may include information relating to the location of other users that are currently at the meeting. In an embodiment, the information relating to the location of the users at the meeting may include the GPS coordinates of the user at the meeting, GPS coordinates of users on the way to the meeting, and/or an estimated time of arrival of users to the meeting.

In an embodiment, in response to a user selecting a particular object related to a meeting and being directed to additional information to learn about the objects related to the meeting, the user may be given the ability to update the additional information about the meeting. In an embodiment, the updates to the additional information about the meeting may include text messages and/or voice messages to other users (e.g., that are at the meeting), reminders to other users (reminders related to the meeting), and/or changes to the object related to the meeting. In an embodiment, a user can create an object related to the meeting that may be displayed in the mash guide.

### Add Your Event

In an embodiment, a user may be presented with options for tagging a location and have the tag show up in the mash guides as something going on within a particular vicinity. To look ahead and send an expiring tracking option, the user may create or post greeting objects that publicize start and finish times and/or other real-time information relevant to the meeting. Once at meeting, one may establish social connections and send posts to checked-in people.

Preferences for notification about an event may include proximity and geo tag info information that may be posted by visitors and/or friends. Using the system users may be able to see what various people (e.g., lecturers and/or people engaged in individual conversations) are saying now at the meeting.

If the site (e.g., a mash guide) is launched with primarily the meetings options, then as meetings occur and more information is posted about different sites related to the meetings, the site may be expanded to include other location based information. As a result, the site may be initially populated with only information that is easier to post, information that users organically, and/or a minimum of information about the event, without need to populate the site.

### Mobcast

A mobcast is a group of one or more pages on which users post information about an event and which is dedicated to the event. A mobcast may occur when many people attend an event (or location) and post information and/or other media content about the event. From the posted information, one can get an idea of what the event is like, and, if enough information is posted, one can virtually attend the event. The mobcast may be applied to provide information about a meeting or another event. Optionally, the posts about the event may expire based on a predetermined time after the event begins and/or ends (e.g., elimination). Or, in an embodiment, after the posts of an event expire, the event can still be found, but the event is not live (e.g., the event is in hibernation).

As an example of a mob cast, there may be a data base for national parks in which users can add their own comments, photos, and recordings about the parks as the users visit. Potential visitors (or scientists) may view those photos to determine whether to visit the park and/or to see how the park is changing due to changes in nature. As another example of a mobcast many people may post information about a meeting as the meeting is occurring, allowing those that are not able to attend to get an idea of the events that occurred during the meeting. Similarly, attendees that are at one part of the meeting may be able to later (or simultaneously) get an idea of what happened (or is happening) at other parts of the meeting that occurred (or are currently occurring) at the same time (when the user was elsewhere in the meeting). For example, attendees that are at one part of the same room may be able to later (or simultaneously) get an idea of what happened (or is currently happening) at other parts of the same room at the same time. Likewise, attendees that are at one event or session of the meeting may be able to later (or simultaneously) get an idea of what happened (or is happening) at other events or sessions of the meeting that occurred (or are currently occurring) at the same time as the event the user attended (or is currently attending) a different session or event.

Mash guide, meeting-greeting, send-it once, and mobcast may be implemented on any server and accessed on any device having computer readable medium, including a cellular phone, tablet computer, or laptop/desktop computer.

### Further General Comments

In general, in an embodiment, to implement, the mash guide, geo-cards, geo-ramps, meeting greeting, or mob-cast, for example, a first user may send a message (e.g., about an event or locations) that may be seen by other users, which may or may not be associated with the first user, and may be viewed as objects by the other users. In an embodiment, the selection of other users may be based at least in part on the message of the user and/or the location of the other users (e.g., the selection may be a selection of an event or location that the first user posted information about). In an embodiment, the other users may provide a user response which may include voice messages, text messages, and/or picture messages (e.g., which may provide more information about the event or location). In response, the first user (e.g. a provider of the event) may receive an object that is based at least in part on the user response of the other users.

In an embodiment, in response to a user selecting a particular object and being directed to additional information to learn about the objects, the user may be given the ability to update the additional information. In an embodiment, the update to the additional information may include text messages and/or voice messages to other users, reminders to other users, and/or changes to the object. In an embodiment, a user can create an object that may be displayed in the guide. There may be a rules-based lifetime for objects. For example, after a set period of time (e.g., 2 hours, 2 days, years for example) past the start time of event, end of an event, and/or other significant time associated with the event, the object expires. There may be multiple expiration times associated with an event. There may be a time after which, no new posts about what is currently happening at the meeting can be posted, there may be a time after which no new comments about the meeting can be posted. There may be a time after which certain geo tags expire. There may be a time after which one group of people (e.g., the public) can see only certain information, while another group of people (e.g., members of an organization) can still see all of the information. There may be a time after which no information about the event can be seen.

There may be events or places that allow tags in which some or all of the tags have a short term voice review that disappears after a short amount of time (e.g., a review of a particular item that is only available for a short period of time). The owner (e.g., the person that originally established the post) can post time sensitive information and time sensitive posts about his own place. People may add pictures. In an embodiment, an indication is provided, such as an icon flashing, which indicates when a post is current.

In an embodiment, the system may translate voice tags to text (where the voice tags and/or text are associated with the meeting, geo-tag, geo-card, send-it-once reply, geo-on-ramp, and/or mash guide, for example).

### Account Setup and Discovery Engine

FIG. 11 shows a flowchart of an embodiment of method 1100 in which a mash guide account is set-up and/or activated in an embodiment of a method for establishing the event identification system from the perspective of the server. In the embodiment in FIG. 11, the information received at the server may be received from a smart watch via a smart phone and the results may be sent from the server to the phone to the watch.

Regarding method 1100, a discovery engine may be stored on the proximity server, which finds things that user may not have necessarily been looking for, per se, but that the user is likely to be interested in, based on the user's past, past interests and current interests.

In embodiment, the server sends a sign-up or sign-in page to the user. Upon sign-up, the user may fill out a questionnaire asking not only the user's likes and dislikes, but the user's past activities (from which additional interests may be gleaned) and the things that the user may have wished that they did (whether or not the user actually did those things). In an embodiment, a user may provide information about his/her interests by answering questions/prompts from the device. The answers to the questions may determine (at least in-part) which objects are returned to the user. In an embodiment, the questions/prompts may relate to various topics that can be used to help determine relevant objects that the user is likely to be interested in.

When a user logs in, the user may see every nearby event that may be of interest (mash guide). In the setup, there is an attempt to find key words and/or other triggers that are likely to aid in discovering information the user is seeking and information that the user is likely to find interesting (whether or not that information was requested by the user). In other words, the discovery engine searches for information that is not related to the user's search, but that is nonetheless expected to be of interest to the user.

In embodiment upon sign-up to the mash guide, the user may fill out a questionnaire asking not only the user's likes and dislikes, but the user's past activities (from which additional interests may be gleaned) and activities that the user may have wished to have done, but did not do. The user may be asked questions about what the user did in the past (e.g., as a child) and what the user would have liked to have done as a child, in addition to being asked about what the user likes and does not like.

Although in FIG. 11 the mash guide was discussed with reference to a smart watch, a smart phone and a server, the mash guide may be implemented on any computer readable medium device, including a cellular phone, tablet computer, laptop, or desktop. The mash guide may include a media layer—voice and images (still or moving images). In an embodiment, the mash guide may have a filter and/or sort button to filter out unwanted objects, events or images according to subject matter, distance, and/or time. The user may use a “hands free” method to navigate through the columns and/or rows of the mash guide system (e.g., by voice commands). In an embodiment, in response to pushing a physical or virtual button, a mash guide opens up and an event stamp can be created. Using the information about the user, information input by the user (e.g., as a result of creating an event stamp), the location, the time, etc. the system can produce a mash guide giving the user real-time information based on the search and the location.

In step 1102, the server sends a sign-in or sign-up page to the user. When signing up, a user sets up the username and password. The name and password may include any of a variety of security processes. The user may set up an account when the user wishes to receive information in the mash guide or when the user wants to post information in the mash guide. The mash guide may aid the user in matching the event stamp information with a specific event. The mash guide may include a collection of locations or objects based on information arranged by topic and location and/or time.

In step 1104, after receiving the user's choice for a username and password, the server sets up the account having the user's chosen password and username.

In steps 1106-1110, the server sends further pages requesting more information about the user that will be used in the future to create user-specific search results (e.g., the mash guide). The mash guide is tailored for the user based on the user's interests (past and present interests). For example, the user may be asked about courses taken, professions, hobbies, place of residence, fantasy places of residence, about what their past and present fantasy careers would be, past and present fantasy hobbies would be, past and present fantasy academic course of study, past and present fantasy extracurricular activities, and/or what courses or activities the user would have liked to participate in, but did not. Thus, for example, if the user indicates that the user had a fantasy career as a child of being an astronaut, the system may present places and events related to space exploration to the user in the mash guide even though the user did not ask for those events, because there is reason to believe that space exploration is of interest to the user, based on the user's former fantasy career. The mash guide is interactive in that the mash guide is based on the user inputs, geo tags, and other comments the user may have input previously.

In step 1106, the server presents to the user one or more pages for entering information about the user's interests. The user may provide information about interests by answering questions/prompts from the server, via device 1 and/or 2. The organization of the mash guide and/or the objects presented to the user in the mash guide may be based, at least in part, on the user's input during the setup process. In an embodiment, the questions/prompts may relate to various topics that can be used to help determine relevant objects and/or types of objects that the user is likely to be interested in. In an embodiment, the one or more pages presented to the user may include a questionnaire asking not only about the person's likes and dislikes, but about the person's activities from which additional interests may be gleaned. The information collected about the user may include clubs, topics of interest, the user's volunteer activities, political activities and preferences, religion, hobbies, books read and/or favorite books, movies viewed watched and/or favorite movies, television programs viewed and/or favorite television programs, information about the user's pets, the sports that the user is interested in and participates in, the teams that the user follows, the user's expertise, the places that the user has traveled to or is interested in traveling to, food preferences, music interests, the user's languages, make and model of the user's car, other modes of transportation used by the user, the user's health and the user's interests in health, the user's favorite brands and the brands used by the user, the user's favorite shops and the shops used by the user, the user's favorite people and the people the user knows, dislikes, motivations, type of computer, type of cell phone, type of tablet computer, etc.

In step 1108, the server presents, via device 1 and/or 2, to the user one or more pages for entering information about the user's past activities. From the user's past activities, more information about the user's interests may be inferred and/or identified. The user may be asked questions about what they did at different times of their life (as a child, as a teenager, as a college student, as an adult, etc.). Statistical correlations may be made between the user's past activities, and interests of people sharing those past activities, in order to predict the user's current interests to determine which objects to present to the user in the mash guide and/or to determine a priority in which to present certain objects to the user in the mash guide.

In step 1110, the server sends a page soliciting information about the user's future. The user provides information about the user's future or hoped-for activities and/or long-term goals (e.g., to buy a summer home in Lake Tahoe, to go to law school, to learn a language, to learn to scuba dive) or bucket list. From this, more information about the user's interests may be identified and used in searches.

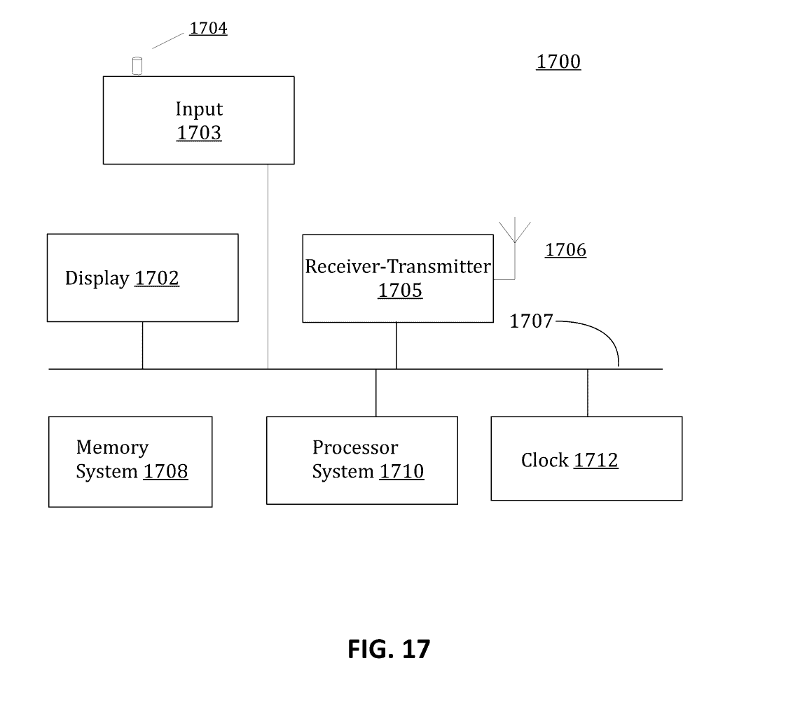

In step 1112, the server uses the information to configure the view of the mash guide presented to the user to be user-specific. When the user activates an event stamp function, results of a search based on the event stamp information may be presented in the form of a mash guide, which may be configured according to the information the user enters about the event, the information the user included about the user's interests and experiences, the location, the time, etc. in addition to including the search results (an example of a mesh of the mash guide will discussed in conjunction with FIG. 17). The user may also open the mash guide without specifically doing a search, and when the user initially opens the mash guide, the mash guide may be populated with the user's favorites (e.g., the topics the user likes to browse). If the user activates an event stamp function, the mash guide will automatically use the information the user input, the location, and the time to determine the configuration and the priority of the results returned by the search.

In an embodiment, although depicted as distinct steps in FIG. 11, step 1102-1112 may not be distinct steps. In other embodiments, method 1100 may not have all of the above steps and/or may have other steps in addition to or instead of those listed above. The steps of method 1100 may be performed in another order. Subsets of the steps listed above as part of method 1100 may be used to form their own method.

### Using the Mash Guide

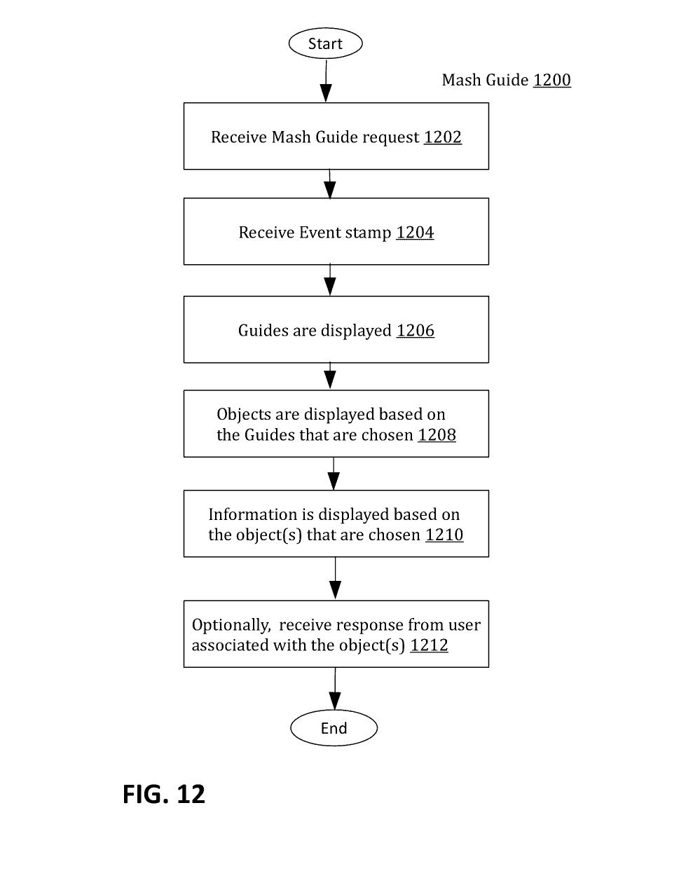

FIG. 12 shows a flowchart of an embodiment of method 1200 for using a mash guide. As discussed above, in conjunction with FIG. 11, the view of the mash guide presented to the user may be tailored for the individual user based on the user's interests. Additionally, or alternatively, the mash guide may display results according to the user's location and the time of day, but the contents displayed are not specifically tailored for any one user. In the embodiment in FIG. 12, the information received at the server may be received from a smart watch via a smart phone and the results may be sent from the server to the phone to the watch.

In step 1202, a mash guide request is received from a user because an event stamp function is activated on a device. Event stamp information (e.g., related to a physical object at a location) may be stored in response to activating an event stamp function. In response to activating an event stamp function, information may be collected including location information (such as GPS coordinates), time, user inputs, including voice and images, and/or other contextual information (e.g., meta data). In response to collecting the event stamp information, the device sends the event stamp information to perform a search.

In step 1204, after a search is submitted, based on the event stamp information, the proximity server performs a search. If there is a voice message, the voice message may be parsed. If the event stamp information includes an image, a pattern matching algorithm may attempt to match the image with images of objects in that area and/or an algorithm may attempt to recognize characters in the image (if there are any) and search for the characters in association with objects associated with the locations within a vicinity of the location of the event stamp. In an embodiment, as part of the search, there may be an attempt to find key words that are associated with objects that are likely to be of interest to the user. In an embodiment, the server also searches for objects that are related to things that are not being expressly sought, but are expected to be of interest (based on the user's interests). The discovery engine may find things that the user may not have necessarily been looking for, but that the user is likely to be interested in. The information entered by the user in the initiation process (see FIG. 11) may be used.

In an embodiment, the proximity server may organize data from multiple other sites of similar content to allow the user to search the content together. The format that the data is presented in and the meta data may be standardized. Data can be presented in a mesh with columns for categories and rows for distance from the user. Alternatively, the rows and columns could be interchanged. In an embodiment, in searching the event stamp information, a proximity search is performed, and the proximity automatically filters out data that would not be of interest to the user based on user interests and history (see FIG. 11).

In an alternate embodiment, if the results are viewed on a phone or watch, the user may be able to swipe a finger to get to the next piece of data, the next card in a category, and/or the next category, and the server returns multiple objects which may be based at least in part on the event stamp information.

In step 1206, the guides that are found by the server in doing the search are returned to the device for display to the user. The guides may include links to multiple objects that are related to each other and that the user may scroll through. In an embodiment, the guides are based on event stamp information and comments from other users. The guides may be the columns in the mesh. For example, the guides may be eateries, theaters, museums, hotels, etc.

In step 1206, objects are displayed based on the guides that are chosen. After receiving the results, the user may combine multiple guides together to return objects that are at least related to two or more guides. For example, if a user likes the Stanford college calendar and the MIT college calendar, these two guides may be mixed together to create a generic college calendar.

In step 1210, information is displayed based on the object(s) that are chosen. In an embodiment, the user may select a particular object and be directed to additional information to learn more about the object. In an embodiment, the additional information may include various user ratings about the object that the user may optionally be able to listen to, read, or view.

In optional step 1212, a response from the user is uploaded and associated with the object(s), as chosen by the user. In an embodiment, in response to the user selecting a particular object and being directed to additional information to learn about the object, the user may upload a user response about the object which optionally may be temporary and disappear after a period of time. The user response may include at least a rating based on a set scale, a text message, left by the user, and/or a voice message left by the user. In an embodiment, the user and/or host of the event may set the user response to disappear after a period of time, which the user and/or host may or may not be able to set. In an embodiment, a user that establishes an object, may include promotional offers and/or time sensitive information that relate to the object, for example.

The mash guide creates a single place for the user to go for location based information instead of going to multiple places to find the same information.

Optionally, if the objects returned do not include any that correspond to the event stamp information sent, the user may add an entry to the mash guide. For example, if the user is walking down the street and finds a monument, the user may create an event stamp with a photograph and/or verbal description of the monument, and have a search performed for the monument. The mash guide is returned, but there is no monument at the locations of interest in the mash guide. If the mash guide has an entry for the object of interest, a tag with comments may be added from the one collecting the event stamp information and/or from others that access and view the event stamp information. The comments may or may not include reviews. In an embodiment, the reviews may have an expiration. Optionally, the tag may only be viewed by other users that are within a predetermined proximity of that site and/or that are performing a search based on an earlier created event stamp.

The results returned may be a view of the mash guide in which the information is grouped into guides based on the user's interests (see FIG. 11 and/or the location of the user, based on GPS). Guides may include different objects that are categorized by the subject-matter of the objects.

In an embodiment, each of the steps of method 1200 is a distinct step. In another embodiment, although depicted as distinct steps in FIG. 12, step 1202-1212 may not be distinct steps. In other embodiments, method 1200 may not have all of the above steps and/or may have other steps in addition to or instead of those listed above. The steps of method 1200 may be performed in another order. Subsets of the steps listed above as part of method 1200 may be used to form their own method.

### Creating Meetings

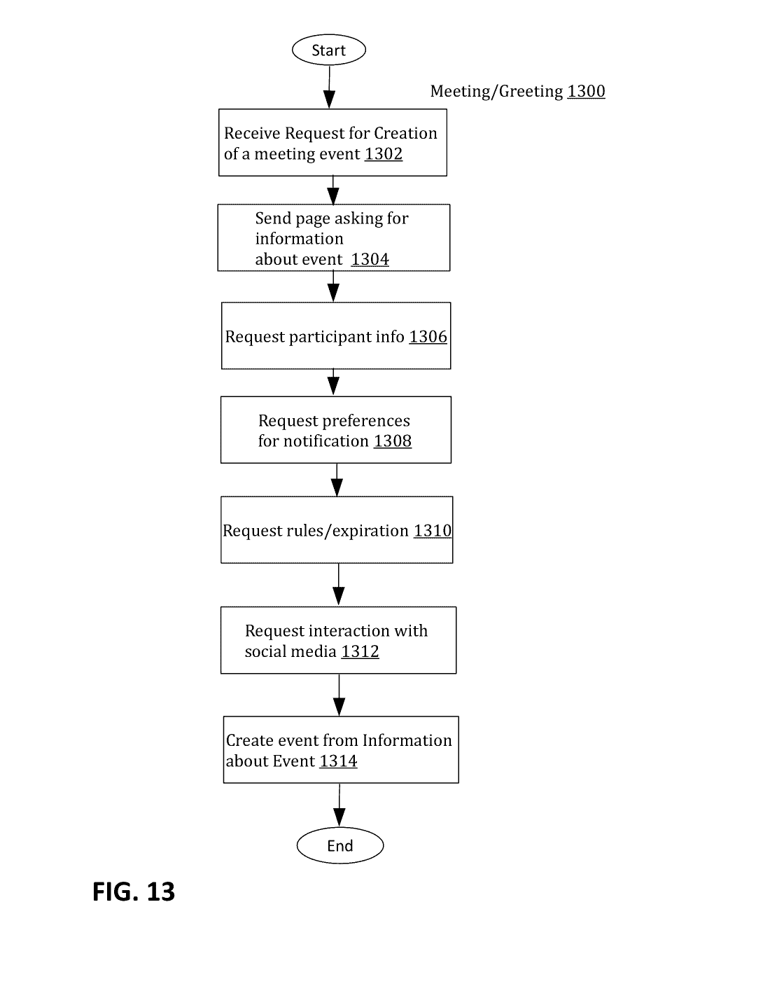

FIG. 13 shows a flowchart of an embodiment of method 1300 of creating a meeting/greeting event. The meeting/greeting allows a host to set up a meeting, send out invitations, identify when attendees arrive, and send greeting messages to the arriving attendees as the attendees arrive. In the embodiment in FIG. 13, the information received at the server may have been received from a smart watch via a smart phone and the results may be sent from the server to the phone to the watch.

In step 1302, the server receives a request from a user to initiate the creation of a meeting event. The meeting may be a consumer meeting (a non-business meeting, such as a party, of users that is not focused on any business goal) or a business meeting. The host may set up a meeting and input information about the meeting (e.g., as detailed in the remaining steps of method 1300), such as times, information, location, attendees, methods of notification, and comments. The meeting may be posted or parts of the meeting may be posted. Optionally, the host may electronically send invitations via emails, for example. In an embodiment, the site allows the host (or a representative of the host) to create an object and assign a URL to the object. The host/user may tag the location and have it show up in the mash guides as an event.

In step 1304, time information is requested from the user. For example, a public start time, and public finish time can be set up and posted. Optionally, observation of the times of arrival of attendees may be set up. As part of the observations of time of arrivals of attendees, when the attendees arrive for the meeting, the attendee may receive a hospitality greeting. The host may choose a setting that causes a message to be sent to a particular attendee, such as “Hey Sam, welcome” as hospitality for those just arriving.

In step 1306, a request for participants is sent to the meeting creator/user. The participants may be entered into the meeting so that the participants' arrivals at the meeting may be tracked, greetings may be sent to the attendees as the attendees arrive, so that attendees may post messages about the meeting during the meeting, and so that attendees of the meeting may send messages to one another using the meeting greeter. The host/user can choose which participants are allowed at the meeting/event or may allow all of the public to be participants (e.g., a political town hall). Alternatively, the host may choose the participants to be anyone within a particular location (e.g., anyone within a chosen diameter around a particular GPS coordinates).

In step 1308, preferences are requested for notification. Preferences for notification may include proximity and geo tag information of and/or from visitors and/or friends. Using the system, a visitor to the meeting may be able to see who else is present at the meeting and where particular people are currently located. Also, users may be able to see the current posts of the people who are currently at the meeting. The system may translate voice tags to text, and allow users to post talks and/or conversation with others at the meeting in association with the meeting.

In step 1310, information about rules/expiration of the event is requested. The meeting can be set up with an expiring tracking option. There may be rules-based lifetimes for objects. For example, after 2 hours from the start of the event/meeting, the item expires. The expiration may be associated with the meeting as an object. In other words, the expiration may determine how long the meeting object remains in the system. Alternatively, the expiration may decide how long the meeting object is modifiable. After the expiration, the meeting may still exist as a historical object, but no longer be modifiable (e.g., and after the expiration, comments may not be allowed).

In step 1312, optionally, an interaction with social media can be set up. The server sends a request to the user/meeting creator to choose whether to include interaction with social media. If the user decides to include interaction with social media, interactions such as Meetup meetings, Facebook, and Twitter feeds with geo tags can be set up. Depending on whether the meeting is public, the meeting may be returned when a user causes a search to be performed based on an event identification stamp. The meeting may be visible, in the mash guide, for example, when someone is in an area near the meeting.

In an embodiment, the site, initially populated with the meeting, may later also include more information posted about different sites related to the meeting (e.g., informational, future meetings, etc.). The server may request the further information or the meeting creator, or other users may include the information by sending it to the server.

In step 1314, the server uses the information to set up the meeting, interactively before the meeting, during the meeting, to set up the rules and notifications (times), to set up the start and end, invitations, check ins, rule-based lifetimes, comments, etc.

Once at the meeting, user may have the ability to individually post messages, after the user checks in. The user may be able to post the information to specific individuals, e.g., on a page of the meeting for that individual. Alternatively, posts that go to all participants can be set up. The posts can be set up in a rule-based manner. Other information may be posted including updated agendas, a Wi-Fi password, if the location changes, who is attending, who checked in, future meeting information, etc. In an embodiment, all of the steps of the meeting/greeting can occur via voice commands (including comments). Accepting voice commands for setting up and conducting the meeting allows the user to use the systems in a “hands free” mode.

In an embodiment, each of the steps of method 1300 is a distinct step. In another embodiment, although depicted as distinct steps in FIG. 13, step 1302-1314 may not be distinct steps. In other embodiments, method 1300 may not have all of the above steps and/or may have other steps in addition to or instead of those listed above. The steps of method 1300 may be performed in another order. Subsets of the steps listed above as part of method 1300 may be used to form their own method.

### Send it Once

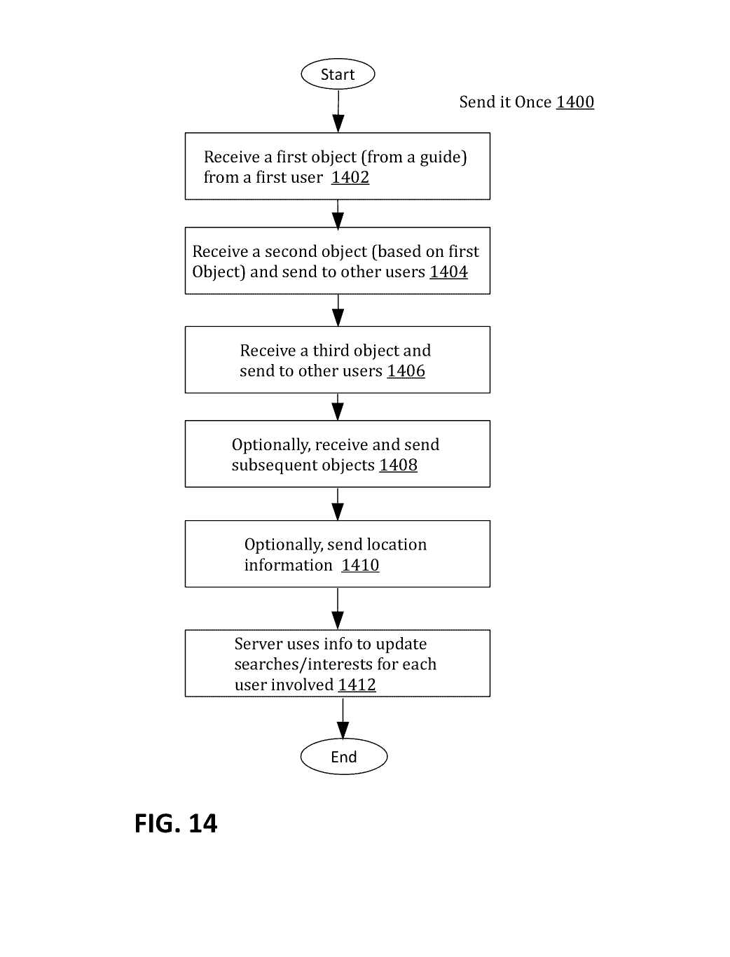

FIG. 14 shows a flowchart of an embodiment of method 1400 a “send it once” event in an embodiment of a method for establishing an event identification system. Send it once may be used by a host to track the arrivals of attendees at meetings or parties. The host can send out invitations. Those that reply to the invitation only need to send a reply indicating that the user is coming and/or on their way, and when the attendee is on the way to the meeting, the host may automatically receive updates of the attendee's progress. When someone arrives at the event, the host may be notified. Attendees may use the system to contact the host about arrival times. Send it once can be used in conjunction with any embodiments that include meetings, parties, seminars, and events in which people are invited to or are attending. In the embodiment in FIG. 14, the information received at the server may have been received from a smart watch via a smart phone and the results may be sent from the server to the phone to the watch.

In step 1402, the server receives a first object from a first user. The first user selects a first object from a guide (Guides were discussed, above, with respect to FIGS. 11 and 12. For example, the guide may be for parties. The host may set up a party as an object within the party categories (guides).

In step 1404, the server receives a second object (based on the first object) and sends it to other users. The second object may be based at least in part on the first object. Attendees may use the system to find meetings and/or parties and to RSVP. The second object may be a comment (e.g., “We're on our way! . . . Here is our estimated time of arrival.” In an embodiment, the comment(s) can be posted via an audio message (e.g., the person can push a button and speak into the device to send an immediate comment).

In step 1406, the server receives a third object and sends the third object to other users. The third object may be sent to other users based on a predetermined time. For example, the third objects may be updates about the user's progress in arriving at a destination. The second object may be based at least in part on the first object. Optionally, one or more of the objects (first object, second object, or third object, etc.) may be sent to the other users at predetermined times. The predetermined times that the objects are sent may relate to the first user's estimated time of arrival or an interval of time. The location may be monitored by the system via GPS. Thus, accepted users may be within 1 mile, 0.5 mile, 100 feet, or 20 feet of the GPS location, or 10 feet, 5 feet, or 1 foot of the event.

In an embodiment, the times may relate to an event start time, various times during the event, an event end time, etc. In an embodiment, the times may relate to the usefulness of the objects at a time of day (e.g., a coupon or a start-time for a sale). For example, attendees may send comments to the host about when the attendees will arrive and/or where the attendees are prior to arrival.

In step 1408, optionally, the server receives subsequent objects and the subsequent objects are sent to other users. The subsequent objects may be sent based on a predetermined time. The number of objects sent and the predetermined time may be chosen by the first user. For example, when someone arrives at a party, everyone at the party may receive a notification that someone has arrived. The host may use this function to know when an important person arrives.

In step 1410, optionally, the server may send location information to other users based on a request from one or more users. One or more of the objects may include information about the location of the first user, the GPS location of the first user, maps, directions, etc.

In step 1412, the server uses any of the information related to the event to update searches/interests for each user involved.

In an embodiment, each of the steps of method 1400 is a distinct step. In another embodiment, although depicted as distinct steps in FIG. 14, step 1402-1410 may not be distinct steps. In other embodiments, method 1400 may not have all of the above steps and/or may have other steps in addition to or instead of those listed above. The steps of method 1400 may be performed in another order. Subsets of the steps listed above as part of method 1400 may be used to form their own method.

### Mobcast

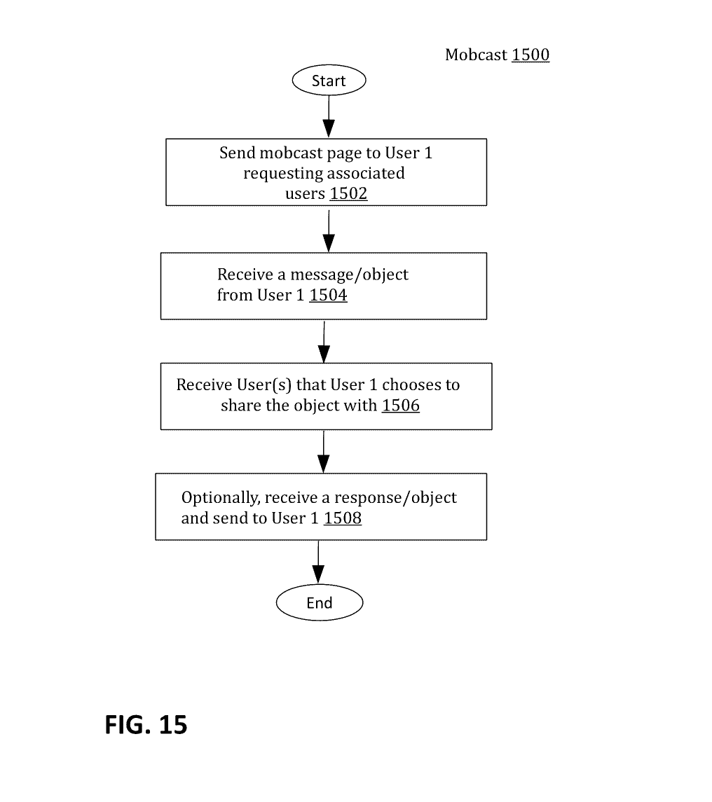

FIG. 15 shows a flowchart of an embodiment of method 1500 of implementing a mobcast in an embodiment of a method for establishing the event identification system. The mobcast may be implemented for any event or object that is applicable. For example, a mobcast may be set up or implemented when there is a “mob” of people attending an event (e.g., a sports event, a concert, a dance recital/program, a play, a movie, a party, etc.). In the embodiment in FIG. 15, the information received at the server was received from a smart watch via a smart phone and the results are sent from the server to the phone to the watch.

In step 1502, the server creates an event, such as a meeting where other users may post information about the event (e.g., a mobcast). Optionally user 1 selects associated users that are associated with the event. Optionally, the user can choose which users can receive the mobcast. The choice of users may be based on a relationship with the user, personal interests, marketing, type of job, sex, age, etc. The choice of users may also be based on who is known to be attending the event or comments may be accepted based on the location/GPS of the user (if the location of the user corresponds to the location of the event). Alternatively, no one ever chooses the members of the mob, the mob forms organically, by people attending the event.

In step 1504, the server receives a message/object from user 1. User 1 may post a message/object about the event in association with the object representing the event, which may be seen by other users. The object may be a recording of a session or talk that occurred at the event, a recording of an incident that occurred at the event, and/or other information about the event. In one embodiment, the message/object can be seen by any users that are within certain proximity of the event. In another embodiment, the message/object may be viewed by anyone regardless of proximity. In an embodiment, only those users within certain proximity of the event may post information about the event. The message/object may be a comment about the event, a picture, a video, an audio, etc.

In step 1506, optionally, the server may request information from user 1 choosing user(s) with whom to share the object. In an embodiment, the selection of the users can be based at least in part on the message of the user and/or the location of the other users. In step 1508, optionally, user 1 receives a response/object from the other users. In an embodiment, the other users may provide a user response, which may include voice messages, text messages, and/or picture messages. In response, the first user may receive an object that is based at least in part on the user response of the other users.

Steps 1504-1508 may be repeated by different users. As a result of multiple users posting information about the event, if enough users post information and comments about the event, someone that is not at the event can get a feel for what the event was like.

In an embodiment, each of the steps of method 1500 is a distinct step. In another embodiment, although depicted as distinct steps in FIG. 15, step 1502-1508 may not be distinct steps. In other embodiments, method 1500 may not have all of the above steps and/or may have other steps in addition to or instead of those listed above. The steps of method 1500 may be performed in another order. Subsets of the steps listed above as part of method 1500 may be used to form their own method.

FIG. 16 shows a representation of an example of device communication system 1600 in an embodiment of an event identification system. In other embodiments, 1600 may not have all of the elements or features listed and/or may have other elements or features instead of or in addition to those listed. Device communication system 1600 may include wearable device 1602, event stamp button 1603, network device 1604, proximity server 1606, and network 1608. In other embodiments, device communication system 1600 may not include all of the features listed above and/or may include additional features instead of, or in addition to, those listed above.

A method for using device communication system 1600 was explained with reference to FIG. 10. Device communication system 1600 allows a user to activate an event stamp from a wearable device, such as a watch, and then the event stamp information is sent via a smart phone or network device to a proximity server. The proximity server may look up information and/or return information in the mash guide, based on the event stamp information received (FIGS. 11 and 12, Meeting/greeting (FIG. 13), Send it Once (FIG. 14) and Mobcast (FIG. 15).

Wearable device 1602 may include event stamp button 1603. Event stamp button 1603 is an embodiment of the event stamp function discussed earlier in the specification, such as with respect to FIGS. 1 (106, 107, and 109). Wearable device 1602 may be communicatively coupled to proximity server 1606 via the network. Alternatively, wearable device 1602 is only communicatively coupled to a mobile phone and mobile phone communicates with the network. Watch may be communicatively coupled to a network device 1604 via a local wireless connection. Upon pressing an event stamp button 1603 on the wearable device 1602, the wearable device 1602 sends a signal to a network device 1604 (e.g., the smart phone 1604), which initiates the event stamp function, which in turn may be used to retrieve information from pages associated with the mash guide, meeting/greeting, send it once, and/or mobcast. Based on the response to the event stamp function, the wearable device 1602 may then be used to make a purchase, to upload a comment, and/or to find out more information.

Network device 1604 is discussed with reference to FIG. 17. Network device 1604 may be communicatively coupled to proximity server 1606, via the network. Network device 1604 may be communicatively coupled to wearable device 1602, via a local wireless connection. Network device 1604 may be used to activate the event stamp functions and send the results to wearable device 1602. Network device 1604 is discussed with reference to FIG. 1 (109).

Proximity server 1606 is a machine that contains the algorithm to carry out a proximity-based search and other functions based on the event stamp functions, mash guides, mobcasts, meeting/greeting, etc. Proximity server 1606 can be communicatively coupled to network device 1604 and/or wearable device 1602 via the network.

Network 1608 is in an embodiment of network 110, which was discussed with reference to FIG. 1.

FIG. 17 shows block diagram of an embodiment of the wearable device 1700. The wearable device 1700 may be a smart watch and may include Display 1702, input 1703, event stamp button 1704, receiver-transmitter 1705, antennae system 1706, communication system 1707, memory system 1708, processor system 1710, and clock 1712. In other embodiments, wearable device 1700 may include additional components and/or may not include all of the components listed above.

Wearable device 1700 may be an embodiment of wearable device 1602, which was discussed in conjunction with FIG. 16. Display 1702 may be a display for displaying information related to the functioning of the wearable device 1700. In an embodiment in which wearable device is a watch, display 1702, may display the time, when wearable device 1700 is not being used for other purposes. Optionally, wearable device 1702 may be capable of interfacing with the display of another device upon which the user may view information from the wearable device 1700.

Input system 1703 may include microphone, one or more physical buttons for inputting settings, one or more virtual buttons, a touch sensitive screen, and/or an interface for connecting to input systems of other systems, such as any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for example.

Event stamp button 1704 is a button that activates an event stamp function, which is a function that causes the recording of event stamp information, which may be identifying information. Event stamp button is discussed with reference to FIG. 1 (see 106) in more detail, for example.

Receiver-transmitter system 1705 receives and transmits messages from and to, respectively, a wireless network. Receiver-transmitter system 1704 may include a separate receiver and transmitter and/or may include a combined receiver and transmitter. Receiver-transmitter system 1704 receives and transmits phone messages. Optionally, receiver-transmitter system 1704 may also receive radio waves. Receiver-transmitter system 1704 may also be capable of receiving GPS signals for determining a current location. Receiver-transmitter system 1704 may be used for communicatively coupling to a web server or proximity server, such as website host 112 or proximity server 1606, that stores information, such as playlists of radio stations (that may be used for determining a song, program, or other broadcast segment), menus of restaurants, price lists, taxi locations, restaurant locations, theater location (movie, music or play), museum location information or other event stamp information based on event stamp information stored in order to identify the broadcast segment or other event.

Antenna system 1706 is attached to receiver-transmitter system 1705 and picks up and sends electromagnetic signals from/to the environment, which is sent to/received at receiver-transmitter system 1705.

Communication system 1707 carries signals between all of the components of wearable device 1700. For example, communication system 1707 communicatively couples receiver-transmitter system 1705, input system 1703, display 1702, and processor system 1710 (processor system 1710 is discussed in the next paragraphs).

Memory system 1708 may store the even stamp information. For example, memory system 1708 may store a time and location at which the event stamp button was pressed. Memory system 1708 may also store a picture taken by a camera system, which may have been taken in conjunction with pressing the event stamp button. Similarly, memory system 1708 may store a location where the timestamp was pressed, which may have been determined by processor system 1710 based on GPS signals or may be sent from a network appliance. Memory system 1708 may also store a part of the broadcast segment, which may be used to help identify the broadcast segment at a later time with the aid of a computer and/or a website. Processor system 1710 may be configured for automatically or manually locating a website and sending event stamp information to a server to perform a search based on the event stamp information. Processor system 1710 may be configured for accessing a proximity server, via a network appliance to access information associated with or add information to a mash guide, mobcast, meeting/greeting, or other activity in response to pressing an event stamp button. Processor system 1710 may also be configured for automatically making a purchase or posting a comment based on the results of a search performed based on event stamp information. Processor system 1710 may also process GPS signals to determine a location or request GPS information from a network appliance. Processor 1710 may be configured for reading profile information in a broadcast segment.

Clock 1712 may include all of the functions of a normal clock, such as display the current time and provide alarms at the user's choosing. Clock system 1712 may facilitate the operations of processor system 1710. Clock system 1712 may also be used for determining a time associated with an event stamp. For example, if a user presses on an event stamp button, processor system 1710 may read clock system 1712 and record the time in association with other identifying information that may be used included in the event stamp information. In an alternative embodiment, processor system may be replaced with a specialized circuit that is configured for recording event stamps, locating a website, sending the event stamp information to the appropriate host, receiving search results that are based on the event stamp information sent, initiating a purchase based on the event stamp information, and/or completing the purchase initialized.

FIGS. 18a and b show a representation of an embodiment of a mash guide 1800 used in the event identification system to display results, particularly in association with the mash guide (or proximity grid). Mash guide 1800 may be an embodiment of mash guide 1000. FIG. 18a shows the mash guide 1800. The mash guide 1800 may include categories header 1802 with each category 1802a-e; distance from user header 1804, with distance markers 1804a and 1804b, and object square 18a-n. FIG. 18b shows an example of the information shown in each object 1806m, which may be a grid card (or node) on mash guide 1800. In other embodiments, mash guide 1800 may not include all of the features listed above and/or may include additional features instead of, or in addition to, those listed above.

The list of categories of categories header 1802 (which is made up of the collection of category headers 1802a-e) may label one axis of a mesh of mash guide 1800 (mash guide 1800 may show the results of a search). The categories of categories header 1802 can be the guides discussed with reference to the mash guides. FIG. 18 provides an example and a mash guide, which may be the results of a location search in a city. The user may be in a neighborhood that the user is not familiar with and wants to find out about what types of entertainment or facilities are available within the neighborhood. The objects returned are presented in a mesh or grid. The categories of the example of FIG. 18 include eateries 1802a, movie theaters 1802b, museums 1802c, theaters 1802d, and hotels 1802e.

Distance-from-user-header 1804 indicates the distance from the user or location entered. In the column below, markers are given identifying the distance to the various establishments in the same row as the marker. Distance markers 1804a and 1804b indicate the distance to the establishments in the same row as the distance marker of interest. Distance-from-user-header 1804, with distance markers 1804a and 1804b, show the distance to the various facilities and establishments from the user's current position. In the example of FIG. 18, the results include a location search in a city. The objects returned are presented in a mesh, with the distances being laid out from the closest to the furthest indicating which objects in the categories are closest to the user and which are further from the user. In the example of FIG. 18, the distances are from 0 miles (1804a) and 1 mile (1804b). The user can choose the parameters of the distance to view establishments that are the chosen distance from the user.

Object squares 18a-n are the objects returned in the search. Each of object squares 18a-n represents a different object. In an embodiment, object squares 18a-n include pictures of the objects (eatery, movie theater, museum, hotel, etc.). Information may also be presented within the object square that is readable without selecting the object, such as opening and closing time, dates of operation, what is showing, show times, address, and telephone number. If the user selects the object (e.g., by touching or clicking on the object), the object may be presented in a larger format (more readable) than the object appears in the mesh, or may be presented with more information about the object.

FIG. 18b shows the enlarged object 1806m after being selected by the user. In the example of FIG. 18b, the enlarged object 1806m is for the Pantages theater and includes more information and/or links, such as the website (a link capable of being activated) names of shows (CATS), show times (Tonight “CATS” 8 pm), ticket prices, the address of the theater, the telephone number of the theater and/or other information allowing the user to purchase tickets and/or learn more about available shows.

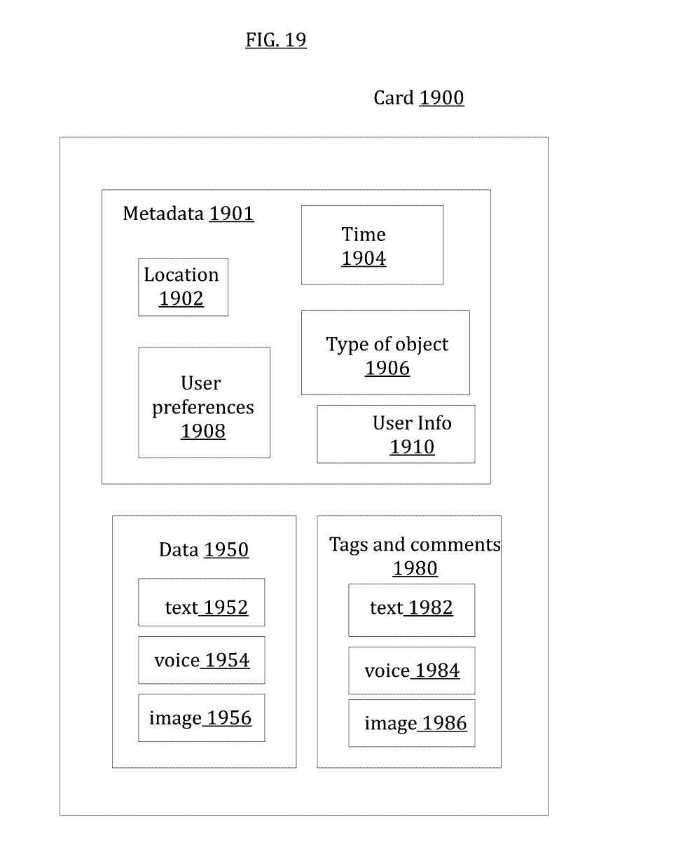

FIG. 19 shows a representation of an embodiment of the structure 1900 of a node of a mash guide. Structure 1900 may include metadata 1901, which may include location 1902, time 1904, type of object 1906, user preferences 1908, and user information 1910. Structure 1900 may also include data 1950, which may include text 1952, voice 1954, and image 1956. Structure 1900 may also include tags and comments 1980, which may include text 1982, voice 1984, and image 1986. In other embodiments, structure 1900 may not include all of the features listed above and/or may include additional features instead of, or in addition to, those listed above.

In an embodiment, structure 1900 may be the structure of a card, such as a geo card, a page for hosting a meeting, a page for hosting a mobcast, a geo tag, and/or a geo on-ramp, for example. However, the information in each node of the mash guide is organized into a unified format, so that the data and/or metadata can be searched through to determine the relevance of the data to a particular guide and/or search. The metadata of each object may include an indicator that indicates the type of data that the object contains. Having a uniform structure for the metadata facilitates allowing third parties to add their own nodes to the mash guide.

The information on the card may be divided into sections as follows:

Metadata|data|tags and comments.

The metadata associated with an event stamp may include,

Location|time|type of object|user information|user preferences.

The data and/or the tags and comments may further be divided into layers as follows,

Text|voice|images.

The metadata 1901 of each object may include an indicator that indicates the type of data that the object contains. The metadata 1901 may include the location, time, type of object, user preferences, and user information.

Location 1902 may include metadata indicating the location and/or where to find the location in structure 1900, which associated with the items of fixed location, such as historical landmarks or bill boards (the bill board advertiser and/or owner may provide the proximity server with information about the location and content of each billboard and ad)

The time 1904 may include metadata indicating the time and/or where to find the location in structure 1900, which be the time that the event or card is active. For example, the time may be the time that a store or restaurant is open, the time a show starts, the time a movie starts, or the time a meeting starts. Alternatively, the time may be the time that a coupon is active or a sale occurs. The time can be used when the user activates the mash guide and/or event stamp to identify whether the event should be included in the mash guide.

The type of object 1906 may include metadata indicating the type of object and/or where to find the type of object in structure 1900, which the category of the object, whether the object is a meeting, a play, a musical performance, a store, a theatre and/or play, etc. The type of object may be used to identify whether the object should be placed in a certain category in the mash guide.

User preferences 1908 may include metadata indicating the user preferences and/or where to find the user preferences in structure 1900. The user preferences and/or the metadata about the user preferences may include information about when the user wants the card to be displayed, how the user wants the card to be displayed, and what will be displayed.

User information 1910 can include information identifying the user. The user that is identified is the user that is associated with the event/card and/or creates the event card.

The metadata 1900 may include data related to special services (e.g., Fandango). For example, the metadata may include whether the event is associated with a particular application such as Fandango.

The data 1950 may include any data related to the event that is described on the card, such as the agenda for the event, people attending the event, people speaking at the event, and/or performers performing at the event, etc. The data 1950 may include text 1952. The text 1952 data can include any information about the event that the user might find helpful and that may be convenient to convey, via text. For example, the text data may include data about the operating hours, the beginning and end time of an event, an explanation of the event, the price, the location, more information about the performers, a website to go to for more information about the event, the venue and/or the performers, etc. (see for example, FIG. 18, the card numbered 1806m).

Voice 1954 information may be any or all of the information that is provided as text information and/or other information about the event. In other words, the text information may be converted to voice information and vice versa. The voice information may also be a preview or an example of the performance, movie, etc. of the event. With the voice layer, the seller can leave information that one can click and listen to. Any posting may have a geo card with voice component and/or a web address where a user may listen to the comments and tags that have been posted about the subject matter of the sign. For example, a sign advertising a house for sale may be associated with a voice recording that is returned when the user presses an event stamp button within a certain vicinity of the sign and/or that is returned as a block on a mash guide when a user is within a certain vicinity of the sign, and for example, the voice recording may give a more pictorial description of the house than the text description.

The image 1956 data may include any supplemental information about the event shown as an image. The image might show a theater, an ad for a movie or other performance, an image of a restaurant, an image of a monument, store, or museum. An exemplary image of the food or merchandise in a store or restaurant might be shown. The image 1956 might be a photo of a person involved in a meeting, a speaker, or the person throwing a party. The image 1956 might be the photo of a user.

The tags and comments 1980 can include any additional information provided by users. The additional information might be information that has changed during the course of the event, information about people at the event, information rating the event, food, merchandise, experience, etc. The tags and comments 1980 can be provided as text, voice or images. Regarding the voice layer, someone may be really interested in posting something, because he/she has a motivation. However, some users are hesitant to post anything, because of the time involved, unless the user is angry. Allowing users to post voice tags and voice messages can reduce the time needed to post a comment and/or tag and therefore may encourage more people to post comments and tags.

Geo tags or event stamps and messages including geo tags or event stamps sent by the user may include similar metadata as in metadata 1901 and/or a similar structure to structure 1900.

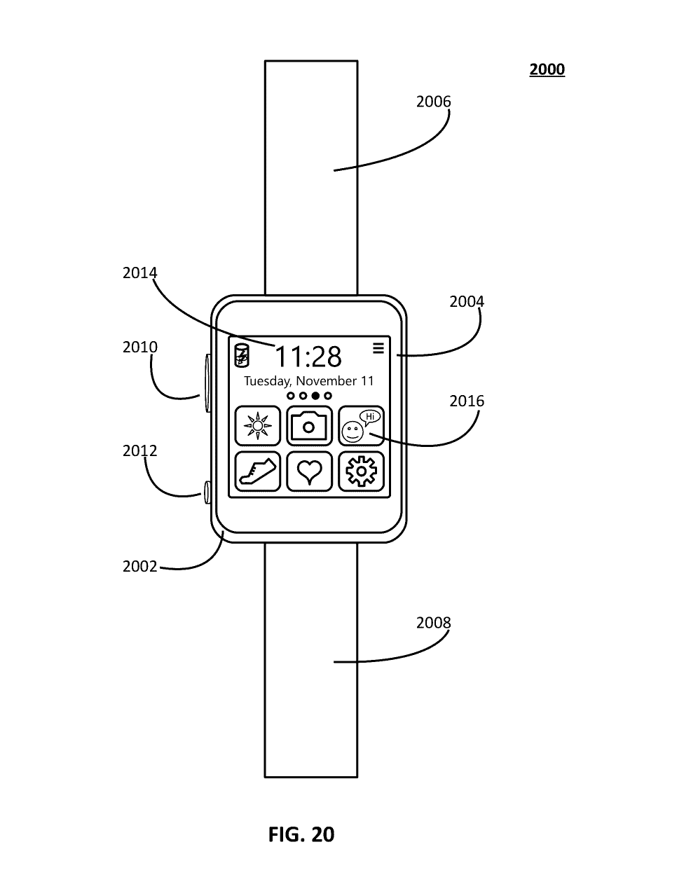

FIG. 20 shows a representation of an embodiment of a smartwatch 2000. Smartwatch 2000 may include case body 2002, bezel 2004, first strap 2006, second strap 2008, action button 2010, display screen 2012, apps 2014, and crown 2016. In other embodiments, smartwatch 2000 may include may not include all of the components and/or may include other components, in addition to, and/or instead of the components listed above.

Smartwatch 2000 may be an embodiment of the wearable device 1602 of FIG. 16. Case body 2002 is the enclosure for the components of smartwatch 2000, such as computing and processing elements. The case body 2002 may include a display screen 2012 that is surrounded around the screen's border by a bezel 2004. In an embodiment, the display screen 2012 may form the face of case body 2002, and the bezel 2004 may wrap around the edges of the display screen 2012.

First strap 2006 and second strap 2008 may connect to opposite sides of case body 2002, allowing a user to wear the smartwatch 2000. The straps 2006, 2008 may wrap around a portion of a wrist, arm, leg, chest, or other portion of a user's body to secure the case body 2002 to the user. In an embodiment, the ends of straps 2006, 2008 may have a fastening mechanism, such as buckle, clasp, buttons, magnetic fasteners, snaps, or Velcro strips, allowing the ends of the straps 2006, 2008 to connect together. In an embodiment, the case body 2002 may have lugs that connect to the ends of the straps 2006, 2008.

Action button 2010 is a button on smartphone 2000 that performs an action when pressed. In addition, action button 2010 may be an event stamp button, which, when pressed, may cause the smartwatch 2000 to create an event stamp and/or establish communications with smartphone for creating an event stamp. Action button 2010 may a physical or a virtual button. Optionally, the action button 2010 may automatically launch a search for an event matching the event stamp information, such as by opening a mash guide, and presenting entries in the mash guide based on the event stamp information. Opening the mash guide may involve locating a website where the mash guide information is stored and searching through the mash guide entries for entries relevant to the event stamp information. Optionally, there may be other buttons for turning on or off smartwatch 2000, setting the time, setting an alert, taking a photograph, and/or recording a video/audio.

Display screen 2012 is a display that shows graphics and texts to the user and may be used for viewing a mash guide and/or results of a search performed based on event stamp information. The display screen 2012 may be substantially any type of display screen that can provide a visual output for smartwatch 2000, such as liquid crystal display, light emitting diode display, or the like. In an embodiment, the display screen 2012 may be a touch sensitive display screen that is configured to receive a user input through the user's touch. The display screen 2012 may be a multi-touch display screen that receives user inputs through capacitive sensing elements. Display screen 2012 may display a virtual event stamp button, that activates an event stamp function. Display screen 2012 may be used for viewing search results, which may have been produced as a result of activating an event function; for viewing phone numbers being dialed; for viewing phone numbers stored; for displaying apps and/or other programs running on the smartwatch 2000; and optionally for viewing information related to an event corresponding to an event stamp created by smartwatch 2000 and/or a smartphone. Display screen 2012 may be responsive to swiping action produced by a user swiping a finger over display screen 2012 (e.g., to cause the page of the mash guide, of another website, or of an app) to switch to the next page.

Crown 2016 is optional and/or may be purely decorative, serving no function. Alternatively, crown 2016 may be a wheel and/or button that is rotatable and/or translatable relative to the housing. Optionally, the turning of the crown 2016 adjust the time. In an embodiment, crown 2016 as an action button having any combination of the functions described with respect to action button 2010, and crown 2016 may be provided in addition to or instead of action button 2010. In an embodiment, the user may configure the crown 2016 to activate the event stamp function when pressed. In another embodiment, when the crown 2016 is pressed a home screen may be displayed showing a mash guide and/or the main menu, for example.

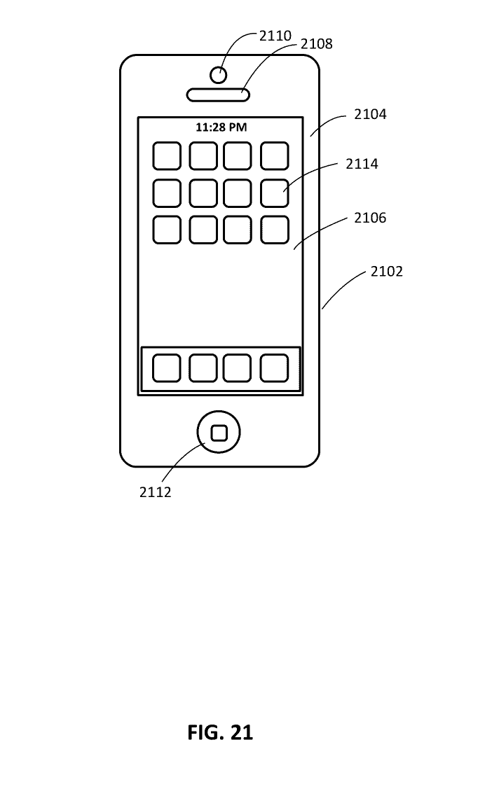

FIG. 21 shows a representation of an embodiment of the smartphone 2100.

Smartphone 2100 may include phone enclosure 2102, screen border 2104, touch sensitive display screen 2106, earpiece speaker 2108, camera lens 2110, button 2112, apps 2114. In other embodiments, smartphone 2100 may include may not include all of the components and/or may include other components, in addition to, and/or instead of the components listed above. Smartphone 2100 may be an embodiment of the mobile phone 109a of FIG. 1 or the network device 1604 of FIG. 16.

Phone enclosure 2102 encases the computing elements, camera, time keeping elements, processing elements and/or other hardware of the smartphone 2100. The phone enclosure 2102 may include a touch sensitive display screen 2106 that is at least partially surrounded by screen border 2104. In an embodiment, the touch sensitive display screen 2106 may form a face of the phone enclosure 2102 and the screen border 2104 may wrap around the edges of smartphone 2100.

Touch sensitive display screen 2106 may be any type of display screen that can provide a visual output, such as liquid crystal display or light emitting diode display, and can receive user input through capacitive sensing elements. In an embodiment, touch sensitive display screen 2106 is a multi-touch display screen. Touch sensitive display screen 2106 is for displaying search results (which may have been produced as a result of activating an event function), viewing phone numbers being dialed, viewing phone numbers stored, displaying apps (or programs running on the smartphone 2100), and optionally viewing information related to a radio station being listened to are things that may be shown on touch sensitive display screen 2106 and/or menu information,

Earpiece speaker 2108 outputs the audio from a website and/or during a phone call through the earpiece. Although not shown, the smartphone 2100 may also have a speakerphone speaker separate from the earpiece speaker 2108. The speakerphone speaker may output the audio for situation where music is being played, for example.

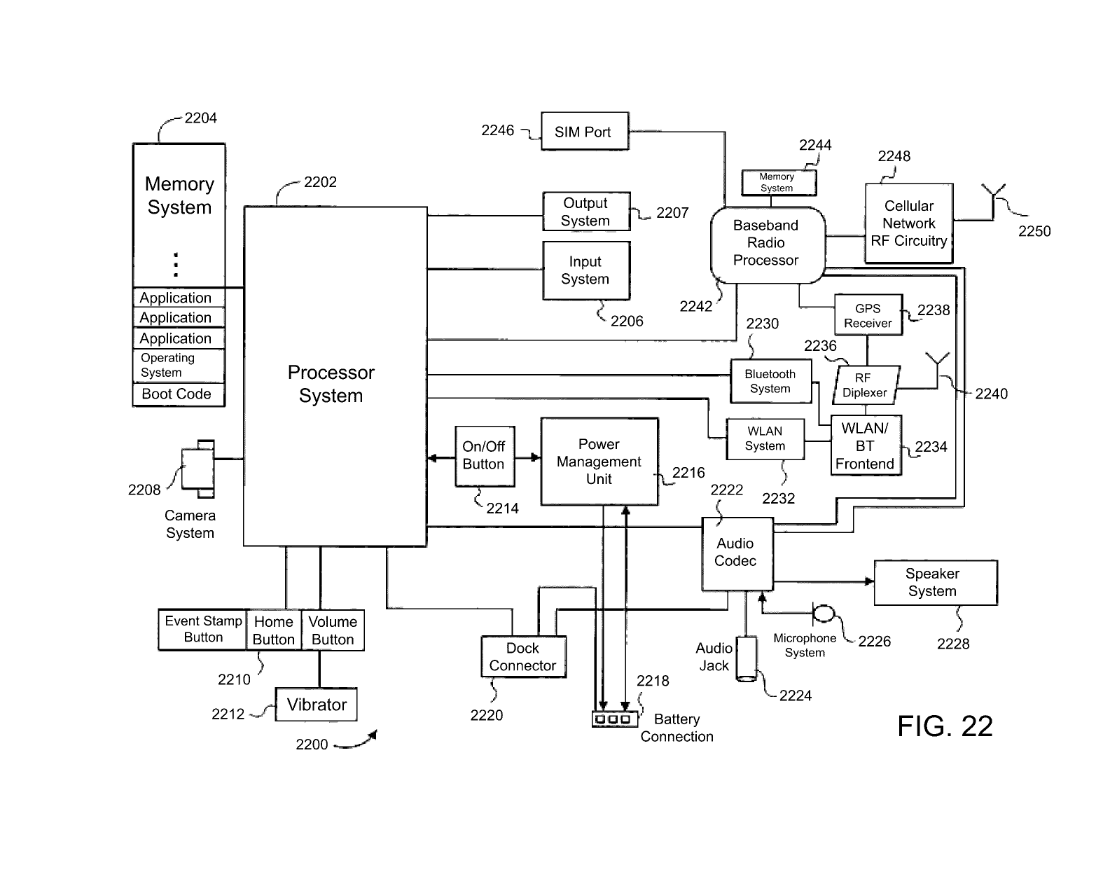

Camera lens 2110 may be similar to lens 402 and may be a lens for forming an image to be recorded and/or a view finder for a camera, such as camera system 2208 (FIG. 22).

Button 2112 is a button on smartphone 2100 may cause smartphone 2100 to automatically collect event stamp information and may optionally launch a search based on the event stamp information collected, such as by causing the mash guide to be opened and populated with information that is based on the event information collected. In an embodiment, the button 2112 may perform other actions (e.g., when pressed in combination with other functions) in addition to or instead of activating an event stamp function. For example, pressing and holding the button 2112 for three seconds may launch an application.

In an embodiment, the smartphone 2100 may have a button for presenting a home screen to the user, which could be the mash guide. In another embodiment, the smartphone 2100 may have a switch or button for turning smartphone 2100 on and/or off.

FIG. 22 shows a block diagram of an embodiment of a smartphone 2200. The smartphone 2200 may include processor system 2202, memory system 2204, input system 2206, output system 2207, camera system 2208, action buttons 2210, vibrator 2212, on/off button 2214, power management unit 2216, battery connection 2218, dock connection 2220, audio codec 2222, audio jack 2224, microphone system 2226, speaker system 2228, Bluetooth system 2230, WLAN system 2232, WLAN/Bluetooth frontend 2234, RF diplexer 2236, GPS receiver 2238, antenna 2240, baseband radio processor system 2242, memory system 2244, SIM port 2246, cellular network RF circuitry 2248, and antenna 2250. In other embodiments, smartphone 2200 may not include all of the components and/or may include other components, in addition to, and/or instead of the components listed above.

Smartphone 2200 may be an embodiment of the mobile phone 109a of FIG. 1, the network device 1604 of FIG. 16, and/or the smartphone representation of FIG. 21. Processor system 2202 may be configured to automatically or manually locate a website and send event stamp information to a server for determining an event associated with event stamp information stored on smartphone 2200 in response to pressing an event stamp button. Processor system 2202 may also be configured (e.g., hardwired) for automatically making a purchase based on event stamp information (for example, based on information identifying the broadcast segment). Processor system 2202 may also process GPS signals or other location identifying signals to determine a location. Processor system 2202 may implement machine instructions for initiating the event stamp function and retrieving information from pages associated with the mash guide, geo-cards, geo-ramps, meeting/greeting, send it once, and/or mobcast.

Memory system 2204 stores the boot code for starting the smartphone 2200, the operating system that runs on smartphone 2200, and any applications that runs on the operating system. Memory system 2204 may also store the identification information. For example, memory system 2204 may store a time associated with pressing an event stamp button and a radio or television station that processor system 2202 determined as being associated with a broadcast segment that was being played at the time the event stamp was pressed. Memory system 2204 may also store one or more machine instructions that facilitate and/or for interacting with a server that implements mash guide, geo-cards, geo-ramps, meeting/greeting, send it once, and/or mobcast. Memory system 2204 may also store a picture taken by camera system 2208, which may have been taken in conjunction with pressing the event stamp button. Similarly, memory system 2204 may store a location where the timestamp was pressed, which may have been determined by processor system 2202 based on GPS signals from GPS receiver 2238. Memory system 2204 may also store photos, video recordings, audio recordings (e.g., a part of the broadcast segment), other event information, which may be used to help identify events at a later time with the aid of a computer and/or a website. In an embodiment, event identification algorithm 324 of FIG. 3 may also be stored in memory system 2204.

Input system 2206 may include any of a variety of input mechanisms, such as keys, buttons, touch pads, virtual keypad on a touch screen, ports for optically or electronically downloading information from other machines (e.g., computers or other mobile phones). In an embodiment, the input system may include one or more buttons for identification information input similar to the input for identification information 328 of FIG. 3. The button may initiate an event stamp function, which may include the collection of event identifying information. Additionally, the button may cause a picture to be taken and stored in association with the time. Alternatively, the button may cause processor 2202 to collect GPS or other location information, which is then stored in association with the time. The button may also cause processor 2202 to access a database containing more information related to the identifying information stored. Input system 2206 may include a button that activates the event stamp function and causes event stamp information to be recorded in memory system 2204 and/or may cause other identification information to be collected and/or stored as part of the event stamp information. In an embodiment, the input system 2206 may be a touch sensitive display screen that responds to the touch and presses of the user on the screen.

Output system 2207 is for outputting menu information, search results (which may have been produced as a result of activating an event function), viewing phone numbers being dialed, viewing phone numbers stored, viewing television programs, and optionally viewing information related to a radio station being listened to, for example. Output system 2207 may be used for surfing a WAN, such as the Internet, sending and viewing text messages, and viewing web pages. For example, output system 2207 may be used for viewing candidates for a broadcast segment or other event information that corresponds to event stamp information stored. Output system 2207 may also be used to view the event stamp information being stored. Output system 2207 may include a port that can be communicatively coupled to a computer via which the identification information may be transferred to a computer so that the event information may be identified via a website on network 110. In an embodiment, the output system 2207 may be a touch sensitive display screen.

Camera system 2208 is for taking pictures. The user may choose to take any picture desired, upload the picture, and send the picture to a friend, for example. Camera system 2208 may also take a picture in response to activating the event stamp button, which may be a physical button on the smartphone or a virtual button that is pressed through the touch screen. The picture taken by camera system 2208 in response to activating the event stamp button may be stored in association with the time and other identifying information.

Action buttons 2210 are buttons on smartphone 2200 that perform an action when pressed. Action buttons 2210 may include an event stamp button, home/menu button, and a volume button, which controls the volume of the audio coming from the speaker system 2228, audio jack 2224, or dock connection 2220 (if the smartphone 2200 is connected to an external speaker through the dock). The event stamp button, when pressed, may cause the smartphone 2200 to locate a website and send event stamp information to a server for determining an identity of a broadcast segment associated with event stamp information stored on smartphone 2200, as described above.

Other buttons and functions on smartphone 2200 include a vibrator 2212, which is used to indicate whether a phone vibrates when receiving an incoming call and may be tied to the volume button, and an on/off button 2214, which allows the user to turn on the phone or reset the phone when pressed.

Power management unit 2216 monitors the power consumption by individual components of smartphone 2200 and may signal power management commands to one or more of the components as needed so as to conserve battery energy and control battery temperature. The power management unit 2216 may monitor the more power intensive components, which includes the baseband radio processor 2242, the processor system 2202, output system 2207, and the cellular network RF circuitry 2248.

Battery connection 2218 connects the smartphone battery to the power management unit 2216, providing power to the smartphone.

Dock connection 2220 allows for the smartphone 2200 to connect to an external device for the purpose of sending and receiving data. For example, the dock connection may connect to a data cable attached to a computer, so that the user may transfer music, pictures, and other information between the computer and the smartphone 2200. In addition, the dock connection 2200 may be connected with to an external power source (e.g., a cable connected to an electrical outlet, a power adapter, an external battery), charging the battery of smartphone 2200, via battery connection 2218.

Audio codec 2222 is an audio coder-decoder that acts as an interface to the analog input of the microphone system 2226 and the analog outputs of the receiver and speaker system 2228, by providing any and all analog amplifiers and other analog signal conditioning circuitry that is needed for conditioning the analog acoustic transducer signals. The audio codec 2222 may be a separate integrated circuit package.

In addition, audio codec 2222 may have an audio jack 2224 to plug wired headphones/earphones, for example, allowing the smartphone 2200 to output the audio through audio jack 2224. In such embodiment, the audio codec 2222 may send the audio through the audio jack 2224, instead of through the speaker system 2228. Alternatively, the audio codec 2222 may send the audio to external speakers connected through the dock connection 2220.

In one embodiment, the audio codec 2222 may operate in either media player mode or call mode. Through the programming from the processor system 2202 or control signals, audio codec 2222 can be configured into either mode. In media player mode, the smartphone 2200 operates as a digital media player, where the audio codec 2222 applies analog-to-digital and digital-to-analog conversion to the analog acoustic transducer signals to generate corresponding digital signals. The audio codec 2222 supplies the digitized microphone signal to the processor system 2202 and converts a digital audio signal from the processor system 2202 into analog form and then applies it to the receiver and/or speaker system 2228 for playback.

In call mode, the smartphone 2200 operates as a mobile telephone device, where the user can have real-time audio conversation with another remote user during a cellular telephone call. In this mode, the audio codec 2222 acts as an analog pass through with no digital conversion, so that the analog acoustic transducer signals are passed through, with perhaps some analog amplification or buffering, between the baseband radio processor system 2242 and the acoustic transducers.

Microphone system 2226 is for the user to speak into when making an audio recording, making a telephone call, asking a question, or calling out a voice command.

Speaker system 2228 may be used for listening to phone calls, radio stations, television programs, and/or web pages, for example. The speaker system 2228 may include an earpiece speaker and/or a speakerphone speaker.

Bluetooth system 2230 and WLAN system 2232 provide additional wireless communication channels for the smartphone 2200. Bluetooth system 2230 wirelessly connects the smartphone 2200 with other local devices, such as speakers, smartwatches, or other smartphones. WLAN system 2232 receives and transmits data and information from and to a wireless network, for example, by a TCP/IP link. Additionally, WLAN system 2232 may receive and transmit phone messages. The Bluetooth system 2230 and the WLAN system may share an antenna for short range wireless communications.

The RF diplexer 2236 has a pair of RF ports that are coupled to the antenna. One of the RF ports is used for GPS services, which the GPS receiver 2238 uses to obtain GPS data, so that the smartphone 2200 can indicate its location to the user and/or which may be included in the event stamp information. The other RF port of the RF diplexer 2236 is coupled to WLAN/Bluetooth frontend 2234, which combines the RF signals of Bluetooth and WLAN. RF diplexer 2236, the WLAN/BT frontend 2234 and baseband radio processor 2242 may receive radio waves through the antenna. The WLAN/BT frontend 2234 and a baseband radio processor may be used for communicatively coupling to a web server, such as website host 112, that stores information, such as the mash guide, playlists of radio stations (that may be used for determining a song, program, or other broadcast segment), menus of restaurants, price lists, taxi locations, or other event information based on event stamp information stored in order to identify the broadcast segment or another event.

The antenna 2240 is an antenna for short range wireless communications. Antenna 2240 connects to the RF diplexer 2236, which allows the Bluetooth channel and the WLAN channel to share the antenna.

The baseband radio processor system 2242 is a chip that manages all the radio functions, such as the information from the antenna 2250. Baseband radio processor system 2242 has a firmware and its own memory system 2244. The baseband processor system 2242 may also perform cellular baseband processing tasks including cellular protocol signaling, coding and decoding, and signaling with the external RF transceiver. Baseband radio processor system 2242 may be programmable and operate based on the firmware stored in memory system 2244. Baseband radio processor system 2242 may grant the user access to the cellular network based on the authentication of the user (a module that checks the user information and password) and the SIM card, which is inserted in the SIM port 2246 of the smartphone 2200. The SIM port 2246 reads the SIM card for information regarding the cellular network.

In an embodiment, the services for GPS, cellular network, Bluetooth link, and WLAN may be managed by programs through the processor system 2202 to communicate with the baseband radio processor system 2242, Bluetooth system 2230, and WLAN system 2232 through separate component buses. In another embodiment, there may also be separate component buses connecting the baseband radio processor system 2242 to the Bluetooth system 2230 and WLAN system 2232 to allow the Bluetooth system 2230 and WLAN system 2232 to use the audio processing engine in the baseband radio processor system 2242. For example, using the WLAN system 2232, the use of the audio processing engine could allow the user to conduct a wireless voice over IP call. As another example, using the Bluetooth system 2230, the user could conduct the call through a wireless headset.

The cellular network RF circuitry 2248 is a RF transceiver integrated circuit package. The cellular RF circuitry 2248 may have a frequency up-converter and a down converter. The frequency upconverter upconverts the uplink signal from the baseband radio processor system 2242 into the radiation band of the antenna 2250. The RF down-converter translates the downlink signal from the radiation band of antenna 2250 into a lower frequency suitable for input to the baseband radio processor system 2242. In an embodiment, the RF up conversion and down conversion may be direct, from and to baseband radio processor system 2242, rather than going through an intermediate frequency (IF).

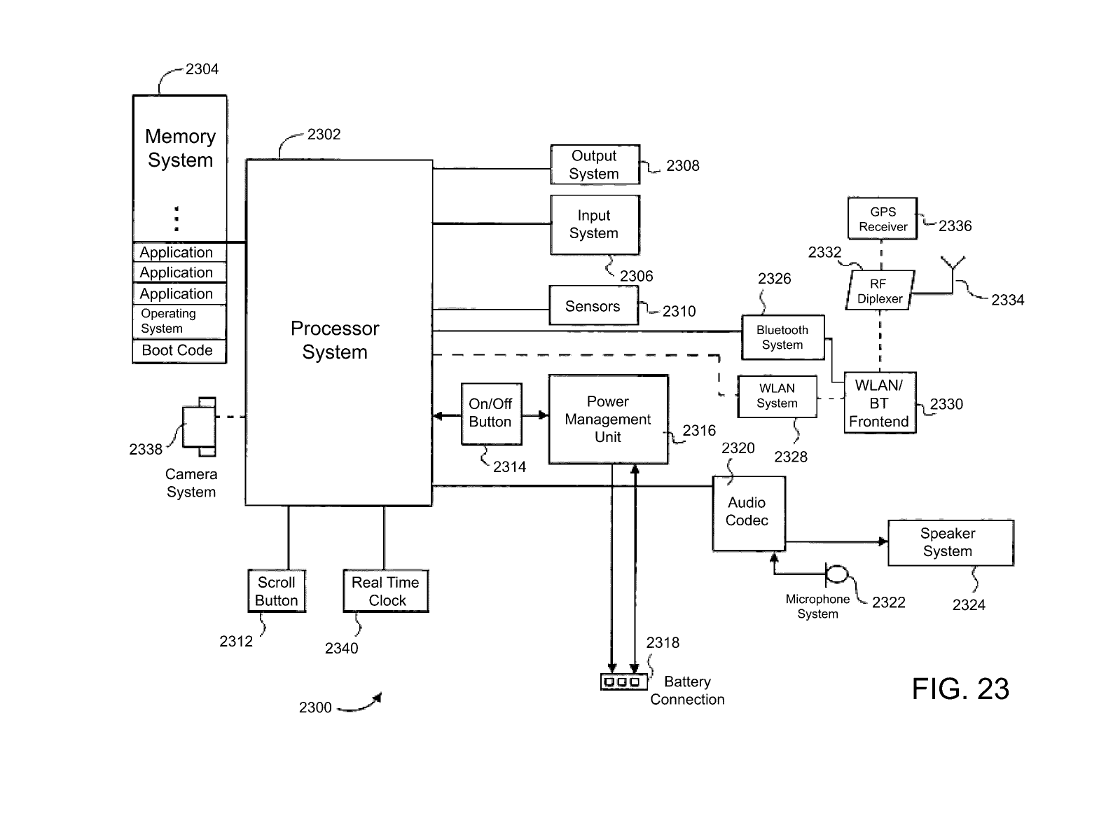

FIG. 23 shows a block diagram of an embodiment of a smartwatch 2300. The smartwatch 2300 may include processor system 2302, memory system 2304, input system 2306, output system 2308, sensors 2310, scroll button 2312, on/off button 2314, power management unit 2316, battery connection 2318, audio codec 2320, microphone system 2322, speaker system 2324, Bluetooth system 2326, WLAN system 2328, WLAN/Bluetooth frontend 2330, RF diplexer 2332, antenna 2334, GPS receiver 2336, camera system 2338, and real time clock 2340. In other embodiments, smartwatch 2300 may not include all of the components and/or may include other components, in addition to, and/or instead of the components listed above.

Smartwatch 2300 may be an embodiment of the smartwatch of FIG. 20. Processor system 2302 may be configured to automatically or manually locate a website and send event stamp information to a server identify an event associated with event stamp information stored on smartwatch 2300 in response to pressing an event stamp button. Processor system 2302 may also be configured for automatically making a purchase base on event stamp information (for example, based on information identifying the broadcast segment). Processor system 2302 may also process GPS signals to determine a location. Processor system 2302 may be configured for reading profile information in a broadcast segment.

Memory system 2304 stores the boot code for starting the smartwatch 2300, the operating system that runs on smartwatch 2300, and any applications that runs on the operating system. Memory system 2304 may also store the identification information. For example, memory system 2304 may store a time associated with pressing an event stamp button and a radio or television station that processor system 2302 determined as being associated with a broadcast segment that was being played at the time the event stamp was pressed. Memory system 2304 may also store a picture taken by camera system 2338, which may have been taken in conjunction with pressing the event stamp button. Similarly, memory system 2304 may store a location where the timestamp was pressed, which may have been determined by processor system 2302 based on GPS signals from GPS receiver 2336. Memory system 2304 may also store a part of the broadcast segment, which may be used to help identify the broadcast segment at a later time with the aid of a computer and/or a website. As explained above, storing a portion of a broadcast segment may facilitate automatically identifying the correct broadcast segment so that a purchase may also be automatically made without the user reviewing the item being purchased, because the likelihood of purchasing the wrong item is reasonably low. In an embodiment, event identification algorithm 324 of FIG. 3 may also be stored in memory system 2304.

Input system 2306 may include any of a variety of input mechanisms, such as keys, buttons, touch pads, virtual keypad on a touch screen, ports for optically or electronically downloading information from other machines (e.g., computers or other mobile phones). In an embodiment, the input system may include one or more buttons for identification information input similar to the input for identification information 328 of FIG. 3. The button may initiate an event stamp function, which may include the collection of event identifying information. Additionally, the button may cause a picture to be taken and stored in association with the time. Alternatively, the button may cause processor system 2302 to collect GPS or other location information, which is then stored in association with the time. The button may also cause processor system 2302 to access a database containing more information related to the identifying information stored. Input system 2306 may include a button that activates the event stamp function and causes event stamp information to be recorded in memory system 2304 and/or may cause other identification information to be collected and/or stored as part of the event stamp information. In an embodiment, the input system 2306 may be a touch sensitive display screen that responds to the touch and presses of the user on the screen.

Output system 2308 is for outputting menu information, search results (which may have been produced as a result of activating an event function), viewing phone numbers being dialed, viewing phone numbers stored, viewing apps, and optionally viewing information related to a radio station being listened to, for example. Output system 2308 may be used for surfing a WAN, such as the Internet, sending and viewing text messages, and viewing web pages. For example, output system 2308 may be used for viewing candidates for a broadcast segment or other event information that corresponds to event stamp information stored. Output system 2308 may also be used to view the event stamp information being stored. Output system 2308 may include a port that can be communicatively coupled to a computer via which the identification information may be transferred to a computer so that the event information may be identified via a website on network 110. In an embodiment, the output system 2308 may be a touch sensitive display screen.

Sensors 2310 are sensors on smartwatch 2300 that help the smartwatch 2300 collect information of the watch's surrounding. Sensors 2310 may include accelerometers, heart rate monitor, proximity sensor, temperature sensors, and gyroscope. Other sensors may be included for different applications, such as monitoring the user's blood glucose level.

Scroll button 2312 is a button on smartwatch 2300 that can be pressed (into the smartwatch) or turned (like how one would turn the knob on a watch). Depending whether scroll button 2312 is pressed or turned, the action performed is different and may depend on what is displayed on the touch screen. In an embodiment, the scroll button 2312 may be configured to be an event stamp button, which, when pressed, sends a signal to a paired smartphone (e.g., smartphone 2200), which initiates the event stamp function, which in turn may be used to retrieve information from pages associated with the mash guide, meeting/greeting, send it once, and/or mobcast. Based on the response to the event stamp function, the smartwatch 2300 may then be used to make a purchase, to upload a comment, and/or to find out more information. Alternatively, the pressing of the scroll button 2312 may cause the smartwatch 2300 to initiate the event stamp function and retrieve information regarding mash guide, meeting/greeting, send it once, and/or mobcast, as described above. Scroll button 2312 may be connected to crown 2016 of FIG. 20.

Power management unit 2316 monitors the power consumption by individual components of smartwatch 2300 and may signal power management commands to one or more of the components as needed so as to conserve battery energy and control battery temperature. The power management unit 2316 may monitor the more power intensive components, which includes the processor system 2302 and output system 2308.

Battery connection 2318 connects the smartphone battery to the power management unit 2316, providing power to the smartphone. Battery connection 2318 may also connect the battery to an induction coil that allows the battery to be charged wirelessly.

Audio codec 2320 is an audio coder-decoder that acts as an interface to the analog input of the microphone system 2322 and the analog outputs of the receiver and speaker system 2324, by providing any and all analog amplifiers and other analog signal conditioning circuitry that is needed for conditioning the analog acoustic transducer signals. The audio codec 2320 may be a separate integrated circuit package.

In one embodiment, the audio codec 2320 may operate in either media player mode or call mode. Through the programming from the processor system 2302 or control signals, audio codec 2320 can be configured into either mode. In media player mode, the smartwatch 2300 is operating as a digital media player, where the audio codec 2320 applies analog-to-digital and digital-to-analog conversion to the analog acoustic transducer signals to generate corresponding digital signals. The audio codec 2320 supplies the digitized microphone signal to the processor system 2302 and converts a digital audio signal from the processor system 2302 into analog form and then applies it to the receiver and/or speaker system 2324 for playback.

In call mode, the smartwatch 2300 is operating as a mobile telephone device, where the user can have real time audio conversation with another remote user during a cellular telephone call. In this mode, the audio codec 2320 acts as an analog pass through with no digital conversion, so that the analog acoustic transducer signals are passed through, with perhaps some analog amplification or buffering, between the baseband radio processor system 2302 and the acoustic transducers.

Microphone system 2322 is for the user to speak into when recording audio, making a telephone call, asking a question, or calling out a voice command.

Speaker system 2324 may be used for listening to phone calls, radio stations, television programs, and/or web pages, for example. The speaker system 2324 may include a speakerphone speaker.

Bluetooth system 2326 and WLAN system 2328, which is optional, provide additional wireless communication channels for the smartwatch 2300. Bluetooth system 2326 wirelessly connects the smartwatch 2300 with other local devices, such as speakers, smartwatches, or other smartphones. WLAN system 2328 receives and transmits data and information from and to a wireless network, for example, by a TCP/IP link. Additionally, WLAN system 2328 may receive and transmit phone messages. The Bluetooth system 2326 and the WLAN system may share an antenna 2334 for short range wireless communications.

The RF diplexer 2332 has a pair of RF ports that are coupled to the antenna 2334. One of the RF ports is used for GPS services, which the GPS receiver 2336 uses to obtain GPS data, so that the smartwatch 2300 can indicate its location to the user. The other RF port of the RF diplexer 2332 is coupled to WLAN/Bluetooth frontend 2330, which combines the RF signals of Bluetooth and WLAN. Through antenna 2334 and RF diplexer 2332, the WLAN/BT frontend 2330 and baseband radio processor may receive radio waves. The WLAN/BT frontend 2234 and baseband radio processor may be used for communicatively coupling to a web server, such as website host 112 of FIG. 1, that stores information, such as mash guides, playlists of radio stations (that may be used for determining a song, program, or other broadcast segment), menus of restaurants, price lists, taxi locations, or other event information based on event stamp information stored in order to identify the broadcast segment or another event.

Camera system 2338 is for taking pictures and is optional. The user may choose to take any picture desired, upload the picture, and send the picture to a friend, for example. Camera system 2338 may also take a picture in response to activating the event stamp button, which may be a physical button on the smartphone or a virtual button that is pressed through the touch screen. The picture taken by camera system 2338 in response to activating the event stamp button may be stored in association with the time and other identifying information.

Although not shown, the smartwatch 2300 may have a baseband radio processor system that manages all the radio functions and may be connected to an antenna and a separate memory system.

Real time clock 2340 is a computer clock that keeps track of the current time. Real time clock 2340 may be in the form of an integrated circuit. Real time clock 2340 may have an alternate source of power to continue to keep time while the primary source of power is off or unavailable. Alternatively, the smartwatch 2300, through Bluetooth system 2326 or WLAN system 2328, may collect the information for the current time from a nearby device through a wireless connection, or the smartwatch 2300, through the baseband radio processor, may get the time from a nearby radio tower.

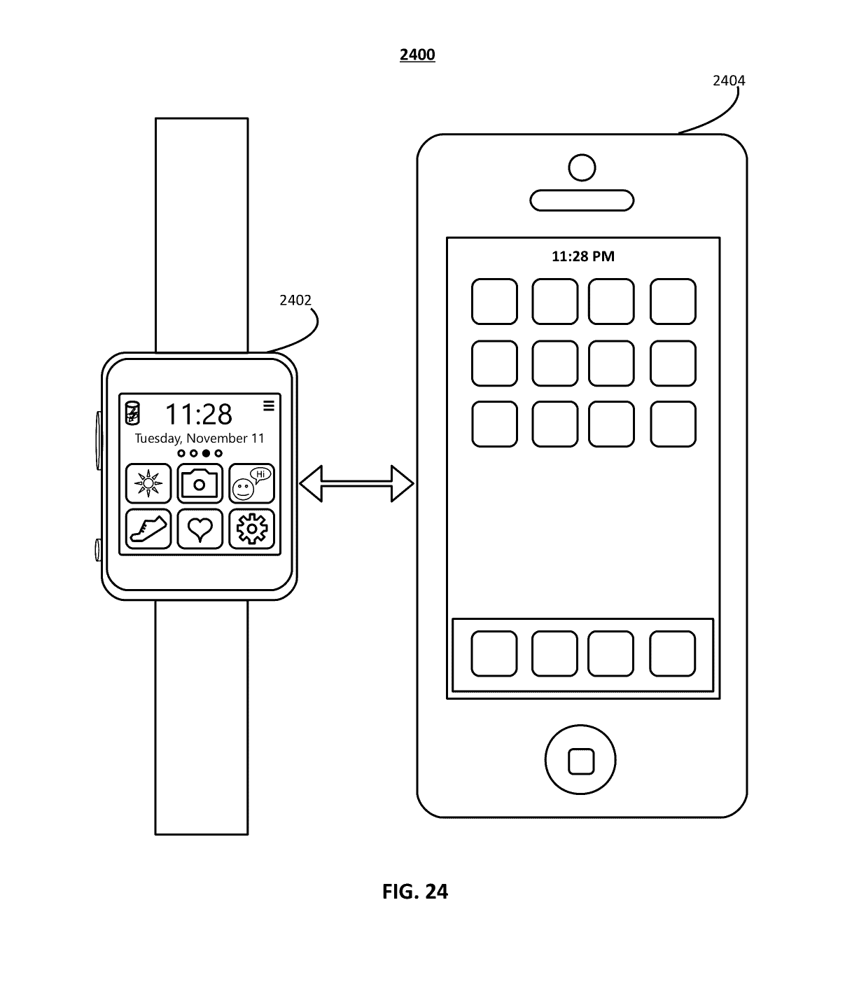

FIG. 24 shows a representation of an example of pairing between smartwatch 2402 and smartphone 2404 to be used in an event identification system and may be an embodiment of FIGS. 21-23.

### EXTENSIONS OR ALTERNATIVES

In general, each of the embodiments and each aspect of each embodiment disclosed in this specification may be used together in any combination or separately from one another. Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A method comprising:
receiving, at a server, a request for information from a device, the request including at least location information indicative of a location of the device that sent the request, the server having a processor system including at least one processor, the server also having a memory system;
determining, by the server, locations of interest, based on the request;
retrieving, by the processor system, from a database information related to the locations of interest;
sending, to the device, the information related to the locations of interest ranked according to a proximity of the locations of interest to the location of the device; and
receiving, at the server, a selection of information associated with one of the locations sent;
sending, by the server, the information about the location selected with a link for adding information.

2. The method of claim 1, the information including a comment.

3. The method of claim 1 further comprising receiving, at the server, a request to add content for the information to be added.

4. The method of claim 3 further comprising storing the content that was requested to be added, the storing of the content including at least storing the content in association with the information about the location selected as the information to be added.

5. The method of claim 4, further comprising deleting the content stored after a predetermined time.

6. The method of claim 1, the content the comment including an audio recording.

7. The method of claim 1, the content including text.

8. The method of claim 1, the content including one or more images.

9. The method of claim 1 further comprising
receiving, at the server, another request for information from another device;
determining, by the server, locations of interest, based on the request;
retrieving, by the processor system, from a database information related to the locations of interest;
sending, by the server, the information related to the locations of interest ranked according to a proximity of the locations of interest to the location of the device;
receiving, at the server, a selection of the information associated with one of the locations sent;
sending, by the server, the information about the location selected with the content for the comment as the comment.

10. The method of claim 1, further comprising
receiving, at the server, another request for information from another device;
determining, by the server, locations of interest, based on the request;
retrieving, by the processor system, from a database information related to the locations of interest;
sending, by the server, the information related to the locations of interest ranked according to a proximity of the locations of interest to the location of the device;
receiving, at the server, a selection of the information associated with one of the locations sent;
determining, by the server, whether the device that sent the selection is within a predetermined proximity to the one of the locations associated with the information selected;
when the device that sent the selection is not within the predetermined proximity, sending, by the server, the information about the location selected without the content for the comment as the comment.
